(19) United States
(12) Patent Application Publication
(10) Pub. No.: US 2013/0041683 A1
(43) Pub. Date: Feb. 14, 2013

(54) COMPUTER BASED SYSTEM FOR PREDICTING TREATMENT OUTCOMES

(71) Applicant: Jean-Pierre Boissel, Lyon (FR)

(72) Inventor: Jean-Pierre Boissel, Lyon (FR)

(73) Assignees: NOVACARE, LYON (FR); NOVADISCOVERY, LYON (FR)

(21) Appl. No.: 13/636,737

(22) PCT Filed: Apr. 5, 2011
(86) PCT No.: PCT/EP2011/001759

§ 371 Date: Nov. 2, 2012

Related U.S. Application Data
(60) Provisional application No. 61/321,555, filed on Apr. 7, 2010.

(51) Int. Cl. G06Q 50/22

(52) U.S. Cl. 705/2

(57) ABSTRACT

This invention relates to computer systems for conducting drug and biomarker discovery, drug development, and personalized medicine, and more generally managing healthcare, and in particular to a system and method for predicting the therapeutic value of a treatment to an individual. The treatment is associated with a function that describes, in a population of individuals, the benefit from a treatment, generally in terms of occurrence of a medical event under treatment, as a function of the risk (e.g., the occurrence of the medical event) without said treatment.

### FIELD OF THE INVENTION

This invention relates to computer systems for managing health care, and in particular to a system and method for predicting the therapeutic value of a treatment to a user. The system is particularly well suited to assist a user in making decisions based on the efficacy of a treatment. The system can be configured to display personalized treatment information to a patient and/or his physician, or to display information about the value of an existing or hypothetical treatment to, e.g., a healthcare payer or a drug developer.

### BACKGROUND

While numerous computer-based systems have been developed for cataloguing and displaying costs of treatment as observed in clinical practice, there have been few attempts to design systems capable of predicting outcomes.

One example for predicting treatment outcomes is the Archimedes Inc. system, e.g. WO2009/158585 (Archimedes Inc.). The system makes use of a complex biological model for a human including the modelling of physical organs and body function. The system then accepts inputs of patient characteristics and their outcomes, maps these onto the human biological model and derives, for each simulated individual, a benefit function. The model permits a user to generate and study larger populations of simulated individuals that replicate the population from which the input characteristics are derived (e.g. clients of a HMO). Such a system does not however appear to permit the simulation of treatments in populations where the drug has not yet been used in vivo. Additionally, the system require a complex biological model whose parameters are difficult to validate, and since each simulated individual is modelled separately, an extremely large number of mathematical functions. Another system is reported in US 2005/0131663 which shares common aspects of the approach of the Archimedes system in that it makes use of virtual individuals that are each represented by a complex biological model, and which seeks to match real patients with the closest representative among virtual individuals. The system is again highly complex and dependent on the accuracy of the biological model.

There is a need for improved systems for predicting treatment outcomes in new patients or in new populations as well as for drug candidates before in vivo administration.

### SUMMARY OF THE INVENTION

An outcome processing system of the invention generally comprises a processor to carry out the methods for predicting treatment outcomes, e.g. a system will generally comprises a set of inputs, a processor in communication with the inputs, and optionally a display, communication device or data storage device, in communication with the processor.

The set of inputs generate a set of data that characterizes a treatment, represented by T. The treatment may be a hypothetical treatment (e.g. the modulation of a biological target, a hypothetical chemical structure) or a real treatment. The treatment is associated with a function that describes, in a population of individuals, the benefit from a treatment, generally in terms of occurrence of a medical event under treatment, as a function of the risk (e.g. the occurrence of the medical event) without said treatment. The treatment is optionally associated with one or more variables (X). The variable (X) is a vector of characteristics of individuals other than the characteristics (Y) included in the risk without treatment (Rc), and where said variables (X) and (Y) may be environment, phenotype- or genotype-derived variable(s). Variable (X) can optionally also be referred to as a first variable(s) and variable (Y) as second variable(s).

The processor computes the benefit of treatment for a virtual population or for a patient of interest, using the function describing benefit of treatment as a function of risk (Rc) and variable (X) in the absence of said treatment. The processor can compute any one or more of a number of indicators of benefit from treatment in the population or individual, which can then be outputted. Optionally the benefit from treatment is displayed in alphanumeric or in graphic form, is stored or is communicated, e.g. to a database or further processor.

The optional display generates a display comprising any one or more of a number of indicators of benefit from treatment in the population or individual, including in alphanumeric or graphical form.

By associating each treatment (T) with an equation describing its benefit in a population together with variables that describe inter-patient variability, the set of treatments (T) can be evaluated in a simulated population that is different in number or in characteristics (e.g. variables (X) and/or (Y)) from the population in which the function was derived. The methodology does not require a separate function to describe a complex biological process in each individual as was the case in prior systems, and instead makes use of a benefit function that can be applied for a given treatment across individuals having different individual-specific characteristics. Consequently, a single benefit function can be applied to an entire population of individuals, and as single benefit function can also be used for each treatment or each treatment modality (e.g., a treatment regimen having a defined dose, schedule, etc.) thereby simplifying the system and eliminating potential sources of error.

The invention is useful, for example, to assess whether a treatment is appropriate for a population of interest, or how a treatment compares with another treatment, including but not limited to assessing whether a treatment is cost-effective in a population of interest. The invention is also useful in personalized medicine; a user can input the patient descriptors (variable(s)) and the aforementioned benefit function and variable(s) can be used to compute and display to the user the benefit that the patient would enjoy from treatment. Additionally, using such a function, optionally with a variable(s), a candidate treatment (T) can be evaluated in a simulated population without ever having been tested in a clinical situation at all, so long as at least the function of benefit as a function of risk and variable (X) is provided. The latter is particularly valuable for in silico drug discovery, e.g. for evaluating biological targets. The invention is also useful to identify and/or assess biomarkers or combinations of biomarkers, for example biomarkers of disease or biomarkers predictive of response to a treatment (e.g. a biomarker predictive of benefit from treatment (Rc−Rt).

Furthermore, the invention permits an output that is easy to assess and illustrates benefit of treatment for a population or individual. The output may be in a manner that permits a user to readily capture the underlying methodology visually by a graphical output (e.g. where a benefit is to be illustrated to a patient), or in a quantitative manner (e.g., where comparisons of treatments are needed for health economics or drug discovery).

In one embodiment, provided is a computer-implemented method comprising calculating by an outcome processing system a benefit of treatment (Rc−Rt) or the rate of outcome on treatment (Rt) for one or more individuals, wherein said calculating comprises computing the benefit of a treatment (T) that is associated with a function that describes, for a population, the benefit from treatment (Rc−Rt) as a function of the risk without treatment (Rc), preferably wherein said function is a function that describes the benefit from treatment (Rc−Rt) as a function of:
i) risk without treatment (Rc) depending on a first variable (Y), and
ii) a second variable (X), wherein the second variable (X) is a vector of characteristics of individuals other than the characteristics included in the risk without treatment (Rc) and the first variable (Y) is a vector of characteristics of individuals included in the risk without treatment (Rc), and where said variables (X) and (Y) may be environment, phenotype- or genotype-derived variable(s);

receiving patient descriptors describing said one or more individuals, wherein each individual is associated with risk (Rc) and a second variable (X); and

optionally, outputting an indicator of the benefit from treatment (Rc−Rt) or the rate of outcome on treatment (Rt) for said individual(s).

In one embodiment of any of the methods of the invention, including in personalized medicine, biomarker identification or evaluation methods, drug discovery, transposability and development monitoring methods, the method may comprise calculating a benefit of treatment for each of a plurality of treatments (T), wherein each treatment (T) is associated with a function (e.g. a distinct function, preferably single function, for each treatment) that describes, for a population, the benefit from treatment as a function of the risk without treatment (Rc) and second variable (X). When benefit from treatment for a plurality of treatments is computed, the system can then be used to compare treatments (e.g. rank treatments, identify suitable treatments), or more generally to output or display multiple treatments (e.g. as treatment options; for use in comparison). Such methods that integrate multiple treatments are particularly useful for physicians or personnel involved in drug discovery, drug development and healthcare economics.

In one embodiment of the methods of the invention, an individual(s) is a real human patient(s). In one embodiment of the methods of the invention, an individual(s) is a simulated individual(s).

In one embodiment of the methods of the invention said step of receiving patient descriptors comprises generating a simulated individual or simulated population of individuals.

In one embodiment of the methods of the invention, said individual(s) comprises a plurality of real human patients. In one embodiment of the methods of the invention, said individuals comprises a simulated population of individuals. Optionally said simulated population of individuals is a virtual realistic population. Preferably, the method comprises computing the benefit from treatment in each individual of the population. Preferably the output of the method provides the benefit from treatment in the population of individuals.

In one embodiment of the methods of the invention, the benefit from treatment is calculated using information or data that is input by a user, generated by the outcome processing system or received from a data source. In one embodiment, the data source is a medical records system. In one embodiment, said information comprises data from clinical use of treatment. In one embodiment, said information comprises an output from a physiopathological model of treatment. Optionally the method further comprises deriving from such information, said function that describes, for a population, the benefit from a treatment as a function of the risk without treatment. In one embodiment, said information comprises a function that describes, for a population, the benefit from a treatment as a function of the risk without treatment and other patient descriptors.

In one embodiment of the methods of the invention, the method further comprises displaying an indicator of the benefit from treatment (Rc−Rt) for said individual(s). In one embodiment the display is in graphical form.

In one embodiment of the methods of the invention, the method further comprises assessing whether a treatment is suited to a patient. In one embodiment of the methods of the invention, the method further comprises assessing variables for their effect on benefit from treatment for said individual(s), e.g. comparing variables or their effect on benefit from treatment or determining the effect of the variables on benefit from treatment. A variable that affects benefit from treatment is optionally determined to be a biomarker, e.g. a biomarker predictive of response to treatment (T). In one embodiment of the methods of the invention, the method further comprises assessing whether a treatment is suited for a population of interest. In one embodiment of the methods of the invention, the method further comprises comparing variables for their effect on benefit from treatment for said individual(s); optionally, said variable is a detectable biological or cellular constituent, and wherein a constituent determined to have an effect on benefit from treatment for said individual(s) is identified as a biomarker, e.g. a biomarker predictive of response to treatment (T). In one embodiment of the methods of the invention, the method further comprises a step of monitoring development, e.g. of a drug. Such steps of assessing or comparing may be carried out by the computer-implemented system or by a user

In one embodiment of any of the methods of the invention, the individual(s) comprises one or a plurality of real human patient(s). In one embodiment of any of the methods of the invention, the one or more individuals comprise a simulated individual or simulated population of individuals.

In one aspect of any of the embodiments herein, input data comprises data for a treatment that has been tested in clinical or non-clinical evaluations (e.g. in vitro assays, biochemical assays, in vivo assays in non-human animals).

The invention discloses methods useful in personalized medicine. In one embodiment the invention comprises calculating by an outcome processing system a benefit of treatment (Rc−Rt) for a patient, wherein said calculating comprises:

computing the benefit for a patient of a plurality of treatments (T) that are each associated with a function that describes, for a population, the benefit from treatment (Rc−Rt) as a function of the risk without treatment (Rc), preferably wherein said function is a function that describes the benefit from treatment (Rc−Rt) as a function of risk without treatment (Rc) depending on a first variable (Y) and a second variable (X), wherein the second variable (X) is a vector of characteristics of individuals other than the characteristics included in the risk without treatment (Rc), and where said variables (X) and (Y) may be environment-, phenotype- or genotype-derived variable(s);

receiving patient descriptors for said variables (X) and (Y) for a patient; and

outputting an indicator of the benefit from treatment (Rc—Rt) for a treatment(s) T for said patient.

In one embodiment, said step of receiving patient descriptors comprises receiving information inputted by a user, e.g. via an input device or input interface.

Optionally, outputting an indicator of the benefit from treatment comprises displaying whether said treatment is suitable for said patient. Optionally, said outputting comprises displaying one, e.g. from a plurality of treatments, or a plurality of treatments that are suitable for said patient, optionally ranked according to their predicted benefit for the patient. Optionally, said outputting may further comprise displaying in graphical form the benefit predicted for a population of individuals (e.g. a virtual realistic population) from said treatment, and indicating how the benefit for said patient compares with the benefit for said population; optionally the graphical form is a scatter plot in a graph having an axis Rt and an axis Rc; optionally the graphical form is a scatter plot in a graph having an axis Rc−Rt and an axis Rc.

In one aspect of any of the embodiments herein, input data comprises data for a treatment that is simulated. In one aspect of any of the embodiments herein, input data comprises data for a treatment that has been tested in clinical or non-clinical evaluations (e.g. in vitro assays, biochemical assays, in vivo assays in non-human animals).

In one aspect of any of the embodiments herein, the benefit from treatment is calculated using information that is inputted, generated or received from clinical use of treatment T and (ii) deriving from said data the function that describes, for a population, the benefit from treatment as a function of the risk without treatment T.

In one aspect of any of the embodiments herein, the benefit from treatment is calculated using information received from a physiopathological model and a model of treatment T, e.g., a Formal Therapeutic Model. Patient descriptors and/or the function that describes, for a population, the benefit from treatment as a function of the risk without treatment T can be derived from such information. The benefit from treatment is calculated using information or data that is input by a user, generated by the outcome processing system or received from a data source.

The invention also discloses specific processes useful in discovery and assessment of biomarkers, provided is a method comprising:

(a) carrying out a computer-implemented method comprising:

calculating by an outcome processing system a benefit of treatment (Rc−Rt) for an individual or population of individuals, wherein said calculating comprises computing the benefit of a treatment (T) that is associated with a function that describes, for a population, the benefit from treatment (Rc-Rt) as a function of the risk without treatment (Rc), preferably wherein said function is a function that describes the benefit from treatment (Rc−Rt) as a function of:
i) risk without treatment (Rc) depending on a first variable (Y), and
ii) a second variable (X), wherein the second variable (X) is a vector of characteristics of individuals other than the characteristics included in the risk without treatment (Rc) and the first variable (Y) is a vector of characteristics of individuals included in the risk without treatment (Rc), and where said variables (X) and (Y) may be environment, phenotype- or genotype-derived variable(s);

receiving patient descriptors describing said one or more individuals, wherein each individual is associated with risk (Rc) and a second variable (X); and

optionally, outputting an indicator of the benefit from treatment (Rc−Rt) for said individual(s); and

(b) assessing variables for their effect on benefit from treatment (Rc−Rt) for said individual or population of individuals.

Preferably, a population of individuals having different patient descriptors is received or generated, wherein substantially all combination of patient descriptors, and/or values thereof, are represented, and the step of assessing variables for their effect on benefit from treatment (Rc−Rt) comprises determining which parameters (e.g. patient descriptors, and/or values thereof) are associated with an increased benefit from treatment.

Optionally, a variable that affects the benefit from treatment for said population is determined to be a biomarker. In one aspect, step (b) of assessing variables is carried out by a user. In one aspect, (b) is carried out by a computer (e.g., the outcome processing system) and the method further comprises outputting one or more identifiers for a biomarker and optionally further outputting an indicator of benefit from treatment (Rc—Rt) associated with such biomarker.

In one aspect, the step of receiving patient descriptors describing said one or more individuals comprises receiving at least one of said patient descriptors from a physiopathological model. Preferably the patient descriptors received from the physiopathological model are represented by a component or an interrelationship between components of the physiopathological model. In one embodiment, one or more patient descriptors for the second variable (X) is received from a physiopathological model. In one embodiment, one or more patient descriptors, preferably all patient descriptors, for the second variable (X) and risk (Rc) are received from a physiopathological model.

In one embodiment, where the variable that affects the benefit from treatment is a second variable X, the biomarker is determined to be a biomarker indicative of response to the treatment (T). In one embodiment, where the variable that affects the benefit from treatment is a second variable Y, the biomarker is determined to be a biomarker indicative of disease without (or independent of) treatment (T). For example the biomarker may be indicative of disease state, progression, severity, etc.

Optionally, the method further comprises conducting an in vitro assay to assess the biomarker in a patient, e.g. a real human. For example, a biomarker may be determined to be the presence of or level of a particular cellular or biological constituent (e.g. the presence of a gene polymorphism or allele; the level of a protein in a tissue), and an in vitro assay designed to detect such constituent (e.g. in a biological sample from an individual) is conducted.

The invention also discloses specific processes useful in biological target discovery and more generally medicinal discovery, e.g., drug discovery. In one such embodiment, a treatment (T) is a simulated treatment or a treatment in development. In one embodiment, provided is a computer-implemented method comprising:

calculating by an outcome processing system a benefit of treatment (Rc−Rt) for a simulated population of individuals, wherein said calculating comprises computing the benefit of a treatment (T) associated with (i) a alteration of a component or an interrelationship between components of a physiopathological model, and (ii) a function that describes, for a population, the benefit from treatment (Rc−Rt) as a function of the risk without treatment (Rc), preferably wherein said function is a function that describes the benefit from treatment (R−Rt) as a function of risk without treatment (Rc) depending on a first variable (Y) and a second variable (X), wherein the second variable (X) is a vector of characteristics of individuals other than the characteristics included in the risk without treatment (Rc), and where said variables (X) and (Y) may be environment-, phenotype- or genotype-derived variable(s);

receiving patient descriptors for a simulated population of individuals, where each individual in the population is associated with a risk (Rc) and a second variable (X); and

outputting, an indicator of the benefit from treatment (Rc−Rt) in the simulated population.

In one embodiment, said step of receiving patient descriptors comprises generating a simulated individual or simulated population of individuals. Optionally, said simulated population of individuals is a virtual realistic population.

In one embodiment, the method further comprises receiving information specifying the component or interrelationship between components of the physiopathological model, the alteration of which is to define treatment (T). Information can be received, for example, from a user by an input device.

In one embodiment, the function that describes, for a population, the benefit from treatment (Rc−Rt) as a function of the risk without treatment (Rc) is obtained by (a) running a physiopathological model comprising an alteration of a component or an interrelationship between components of the physiopathological model that defines a treatment (T), wherein the physiopathological model generates a likelihood of an event of interest; and (b) deriving said function from said likelihood of an event of interest.

In one embodiment, said function that describes, for a population, the benefit from treatment (Rc−Rt) as a function of the risk without treatment (Rc) is obtained by (a) running a Formal Therapeutic Model that simulates a treatment (T) associated with one or more treatment descriptors, wherein the Formal Therapeutic Model generates a likelihood of an event of interest; and (b) deriving said function from said likelihood of an event of interest.

In one embodiment, further comprising receiving clinical data and using said data to modify said Formal Therapeutic Model; and optionally repeating said steps (a) and (b) using the modified Formal Therapeutic Model.

In any of the embodiments herein, the method may advantageously comprises providing a plurality of treatments T, wherein each treatment T within said plurality is associated with a benefit function. The methods may thus optionally also comprise (i) inputting, generating or receiving, and optionally storing, treatment information (e.g. from clinical use, from a physiopathological model) for each said plurality of treatments T and (ii) deriving from said information a function that describes, for a population, the benefit from treatment as a function of the risk without treatment.

In any of the embodiments herein, the benefit from treatment (Rc—Rt) can be expressed as the benefit from treatment (Rt), the benefit from treatment as derived from the rate of outcome of treatment (Rt).

In another embodiment, the invention provides a memory for storing data for access by an application program being executed on an outcome processing system, comprising a data structure stored in said memory, said data structure including information used by said application program, wherein the data structure is configured to comprise a plurality of data objects, each data object corresponding to one of a plurality of treatments (T), and wherein each treatment (T) is associated with (e.g., linked to) a function that describes, for a population, the benefit from treatment as a function of the risk without treatment, preferably wherein said function is a function that describes the benefit from treatment (Rc−Rt) as a function of risk without treatment (Rc) depending on a first variable (Y) and a second variable (X), wherein the second variable (X) is a vector of characteristics of individuals other than the characteristics included in the risk without treatment (Rc) and the first variable (Y) is a vector of characteristics of individuals included in the risk without treatment (Rc), and where said variables (X) and (Y) may be environment, phenotype- or genotype-derived variable(s).

In another embodiment, the invention provides memory for storing data for access by an application program being executed on an outcome processing system, comprising a data structure stored in said memory, said data structure including information used by said application program, wherein the data structure is configured to comprise a plurality of data objects, each data object corresponding to one of a plurality of treatments (T), and wherein each treatment (T) is associated with a benefit from treatment (Rc−Rt) in a particular population of individuals, wherein said benefit from treatment (Rc−Rt) is computed using a function that describes, for a population, the benefit from treatment as a function of the risk without treatment, preferably wherein said function is a function that describes the benefit from treatment (Rc−Rt) as a function of risk without treatment (Rc) depending on a first variable (Y) and a second variable (X), wherein the second variable (X) is a vector of characteristics of individuals other than the characteristics included in the risk without treatment (Rc) and the first variable (Y) is a vector of characteristics of individuals included in the risk without treatment (Rc), and where said variables (X) and (Y) may be environment, phenotype- or genotype-derived variable(s). Optionally, each treatment (T) is further associated with said particular population of individuals.

In one embodiment, such data structures can be useful to provide a user with treatment information. In one aspect the invention provides a computer-implemented method comprising receiving a query (e.g. from a user via an input device or input interface), identifying one or more treatments (T) that satisfies said query, accessing a memory for storing data of the invention, and outputting an indicator of benefit (Rc−Rt) for said treatment(s) (T), e.g. for an individual or population of individuals. A query may be any information that the system of the invention can use to identify one or more treatments; a query may comprise for example a selection or specification of one or a plurality of treatments (T), a selection or specification of a group of treatments (T) grouped according to any desired characteristic (e.g. treatment parameter, type of molecule, etc.), a selection or specification of a disease or desired medical outcome.

When providing input data in any of the embodiments herein, or any individual steps within any embodiment, the step of providing input data can comprise any suitable method, including, e.g. receiving input data, inputting input data using an input device or interface, storing and/or retrieving input data from a memory for storing data. Outputting data can likewise comprise any suitable method, including, e.g. storing, communicating, displaying, etc.

The invention also provides an apparatus for predicting the benefit from one or a plurality of treatments, said apparatus comprising a computer for executing computer instructions, wherein the computer comprises computer instructions for carrying out any of the methods described herein.

The invention also provides a computer-readable medium that stores a computer program for predicting the benefit from one or a plurality of treatments, wherein the computer program comprises instructions for carrying out any of the methods described herein.

### BRIEF DESCRIPTION OF THE FIGURES

FIG. 1 is a chart showing the multifunctional system of the invention.

FIG. 2 is a chart showing different processes of the invention that can be carried out by a multifunctional system.

FIG. 3 is a physiopathological model of acute stroke that outputs likelihood of an event of interest.

FIG. 4 is a physiopathological model of acute stroke that outputs likelihood of an event of interest; the model can be incorporated into a more complete model of acute stroke that incorporates other processes such as apoptosis.

FIG. 5 is a pharmacological model that is in a formal therapeutic model. Input is a treatment at dose D that gives an amount CuD at time t delivered to the body. The PK model transforms it in blood level (C(t)) through several sequential steps. In turn, the blood level is transformed during a change of a physiological parameter IO(t). If IO(t) is the support of the effect of the treatment on the disease, it is quoted as z. This variable affects the disease process represented in the physiopathological model. IO(t) or a similar parameter affected by the treatment is the entry into the side-effect model. IO(t) is a biomarker of treatment efficacy.

FIG. 6 is a stepwise Formal Therapeutic Model comprising a pharmacology model that outputs to a physiopathological model. Each step is modelled by one or a few equations based on our understanding of pharmacology and physiology.

FIG. 7 is a process for conducting a transposability study or biomarker evaluation study.

FIG. 8 is a process for conducting a transposability study or biomarker evaluation study.

FIG. 8b is is a process for conducting a transposability and/or biomarker study across multiple populations.

FIG. 9 is a process for evaluating biological targets.

FIG. 10 shows results from a physiopathological model of acute stroke; the alteration in the model is blockage of sodium channels and the output of the model is the effect on edema (expressed as the rADCw value) over time in minutes.

FIG. 11 shows the results from a physiopathological model of acute stroke where the dcourse of ischemia is modulated by altering a sodium channel (NaP).

FIG. 12 shows the effect of blocking sodium channels in humans and rodents, providing a potential explanation for drugs that are effective in rodents but not in humans.

FIG. 13 illustrates a method for monitoring development of a drug.

FIG. 14 shows the results of predicting angina attacks following treatment with a hypothetical cardiotonic drug using a formal therapeutic model; lines show the prediction as a function of dose while the bars show results from clinical trials from which data for the drug was taken.

FIG. 15 is a graphical display showing the benefit from treatment as determined by an Effect Model for a cardiotonic drug applied to a realistic virtual population.

FIGS. 16, 17 and 18 illustrate methods for predicting the benefit of a treatment for a patient.

FIG. 19 shows an exemplary display of the invention; a scatter plot graphed with an axis Rt and an axis Rc, as shown for benefit from treatment using ivrabradine, wherein plaque rupture is the event of interest.

FIG. 20 shows hardware embodiments.

### DETAILED DESCRIPTION OF THE INVENTION

### Definitions

“Treatment”, as used herein, refers to any intervention (e.g., surgical, administration of a drug, etc.) that has the potential to modify the course of a disease by altering the functioning of a living system with the aim of treating, curing or preventing the illness, including the alleviation or amelioration of one or more symptoms, diminishment of extent of disease, stabilized (i.e., not worsening) state of disease, preventing spread of disease, delay or slowing of disease progression, amelioration or palliation of the disease state, and remission (whether partial or total), whether detectable or undetectable.

“Transposability study”, as used herein, refers to the assessment of the transposability of a treatment efficacy and/or tolerability. Transposability means the operation by which a prediction of treatment efficacy and/or tolerability is extrapolated to a second population or individual from data obtained in first population(s) or individual(s) differing from the second population or individual of interest.

The term “biological target”, as used herein, refers to a biological constituent the alteration of which has the potential for modifying the functioning of a biological system of interest. Nonlimiting examples of biological targets include molecules such as DNA, RNA, proteins, glycoproteins, lipoproteins, sugars, fatty acids, enzymes; hormones, and chemically reactive molecules (e.g., H⁺, superoxides, ATP, and citric acid); ions; glycoproteins; macromolecules and molecular complexes; cells and portions of cells, such as subcellular organelles (e.g., mitochondria, nuclei, Golgi complexes, lysosomes, endoplasmic reticula, and ribosomes); and combinations thereof.

The term “target evaluation”, as used herein, refers to the assessment of the consequences on a physiopathological model output(s) of an alteration of a biological target.

The term “alteration”, as used herein with respect to a physiopathological model, refers to a modification of a parameter or component in a model of a biological system designed to represent a real-life change in the environment and/or therapy of a subject. Exemplary alteration include the presence of an existing or hypothesized drug that modulates (e.g., activates or inhibits) a function of a cellular or biological constituent (e.g. a biological target), and treatment regimens, mere passage of time (e.g., aging), exposure to environmental toxins, increased exercise and the like.

As used herein, the term “patient” refers to a real or simulated individual, preferably to a human. The term “simulated individual” refers to representations of a real individual in the systems, code, apparatuses and methods of the present invention.

As used herein, the term “treatment descriptor” refers to any information useful to describe a parameter of a treatment. Examples include dose of a drug, frequency of drug administration, formulation of a drug, combination therapy drugs, combination therapy doses, frequency of drug administration, duration of drug administration, metabolites, drug half/-life, renal drug metabolism, metabolic pathways or enzymes, subject diet regimen, subject exercise regimen, any recommended (e.g. by heath authorities) values where different from values used, etc. Some treatment descriptors may also be patient descriptors to the extent they are dependent on an individual, e.g, half life of a drug. Treatment descriptors can alternatively be pure treatment descriptors, e.g. the dose of a drug administered.

As used herein, the term “patient descriptor” refers to any information useful to describe a characteristic of a patient. Examples include variable(s) (Y) correlated with the occurrence of an outcome (event) of interest (they are called “risk factors”) which are integrated in risk without treatment (Rc), and variable(s) (X) correlated with the intensity of the benefit which are not integrated in Rc. A biomarker is an example of a patient descriptor. The term “cellular constituent” refers to a biological cell or a portion thereof. Non-limiting examples of cellular constituents include molecules such as DNA, RNA, proteins, lipoproteins, sugars, fatty acids, enzymes; hormones, and chemically reactive molecules (e.g., H+, superoxides, ATP, and citric acid); ions; glycoproteins; macromolecules and molecular complexes; cells and portions of cells, such as subcellular organelles (e.g., mitochondria, nuclei, Golgi complexes, lysosomes, endoplasmic reticula, and ribosomes); and combinations thereof.

The term “biological constituent” refers to a portion of a biological system. A biological system can include, for example, an individual cell, a collection of cells in vivo or in vitro, such as a cell culture, an organ, a tissue, a multi-cellular organism such as an individual human patient, a subset of cells of a multi-cellular organism, or a population of multi-cellular organisms such as a group of human patients or the general human population as a whole. A biological system can also include, for example, a multi-tissue system such as the nervous system, immune system, or cardiovascular system. A biological constituent that is part of a biological system can include, for example, an extra-cellular constituent, a cellular constituent, an intra-cellular constituent, or a combination of them. Examples of biological constituents include DNA; RNA; proteins, lipoproteins, sugars, fatty acids, enzymes; hormones, small organic molecules, macromolecules and molecular complexes, cells; organs; tissues; portions of cells, tissues, or organs; subcellular organelles such as mitochondria, nuclei, Golgi complexes, lysosomes, endoplasmic reticula, and ribosomes; chemically reactive molecules such as H+; superoxides; ATP; citric acid; protein albumin; ions; and combinations of them.

The term “function” with reference to a biological constituent refers to an interaction of the biological constituent with one or more additional biological constituents. Each biological constituent of a biological system can interact according to some biological mechanism with one or more additional biological constituents of the biological system. A biological mechanism by which biological constituents interact with one another can be known or unknown. A biological mechanism can involve, for example, a biological system's synthetic, regulatory, homeostatic, or control networks. For example, an interaction of one biological constituent with another can include, for example, the transformation, e.g. by synthesis or degradation, of one biological constituent into another, a direct physical interaction of the biological constituents, an indirect interaction of the biological constituents mediated through intermediate biological events, or some other mechanism or any integrated network (genetic network(s), mRNA network(s), gene regulatory network(s), protein network(s)). In some instances, an interaction of one biological constituent with another can include, for example, a regulatory modulation of one biological constituent by another, such as an inhibition or stimulation of a production rate, a level, or an activity of one biological constituent by another.

The term “biological process” refers to an interaction or a set of interactions between biological constituents of a biological system. In some instances, a biological process can refer to a set of biological constituents drawn from some aspect of a biological system together with a network of interactions between the biological constituents. Biological processes can include, for example, biochemical or molecular pathways and networked biological components (genetic network(s), mRNA network(s), gene regulatory network(s), protein network(s)). Biological processes can also include, for example, pathways that occur within or in contact with an environment of a cell, organ, tissue, or multi-cellular organism. Examples of biological processes include biochemical pathways in which molecules are broken down to provide cellular energy, biochemical pathways in which molecules are built up to provide cellular structure or energy stores, biochemical pathways in which proteins or nucleic acids are synthesized, activated or destroyed, and biochemical pathways in which protein or nucleic acid precursors are synthesized or destroyed. Biological constituents of such biochemical pathways include, for example, enzymes, synthetic intermediates, substrate precursors, and intermediate species.

The term “drug” refers to a compound of any degree of complexity that can affect a biological state, whether by known or unknown biological mechanisms, and whether or not used therapeutically. In some instances, a drug exerts its effects by interacting with a biological constituent, which can be referred to as the therapeutic target of the drug. A drug that stimulates a function of a therapeutic target can be referred to as an “activating drug” or an “agonist,” while a drug that inhibits a function of a therapeutic target can be referred to as an “inhibiting drug” or an “antagonist.” An effect of a drug can be a consequence of, for example, drug-mediated changes in the rate of transcription or degradation of one or more species of RNA, drug-mediated changes in the rate or extent of translational or post-translational processing of one or more polypeptides, drug-mediated changes in the rate or extent of degradation of one or more proteins, drug-mediated inhibition or stimulation of action or activity of one or more proteins, and so forth. Examples of drugs include typical protein-based, nucleic acid based or synthetic chemical (e.g. small molecules) of research or therapeutic or prophylactic interest; naturally-occurring factors such as endocrine, paracrine, or autocrine factors or factors interacting with cell receptors of any type; intracellular factors such as elements of intracellular signaling pathways; factors isolated from other natural sources such as plant-derived chemicals. Drugs can also include, for example, agents used in gene therapy like DNA and RNA. Also, antibodies, viruses, bacteria, and bioactive agents produced by bacteria and viruses (e.g., toxins, antigenic agents useful as vaccines) can be considered as drugs. For certain applications, a drug can include a composition including a set of drugs or a composition including a set of drugs and a set of excipients. The term “medicinal product” refers to any system, tool or compound that has the capacity to act on the body or that, like a drug, can affect a biological state; a medicinal product may act through any mode of action, including chemical, biochemical or physical (e.g. x-ray, positron) modes. A medicinal product, like a drug, is a treatment.

The term “biological state” refers to a condition associated with a biological system. In some instances, a biological state refers to a condition associated with the occurrence of a set of biological processes of a biological system. Each biological process of a biological system can interact according to some biological mechanism with one or more additional biological processes of the biological system. As the biological processes change relative to each other, a biological state typically also changes. A biological state typically depends on various biological mechanisms by which biological processes interact with one another. A biological state can include, for example, a condition of a concentration of a substance, a nutrient or hormone concentration, in a tissue, in plasma, interstitial fluid, intracellular fluid, or cerebrospinal fluid, e.g. any biomarker. For example, a biological state associated with edema is associated with flow of water into neurons and/or by the coefficient of apparent diffusion of water (the biomarker rADCw); biological states associated with hypoglycemia and hypoinsulinemia are characterized by conditions of low blood sugar and low blood insulin, respectively. These conditions can be imposed experimentally or can be inherently present in a particular biological system. As another example, a biological state of a neuron can include, for example, a condition in which the neuron is at rest, a condition in which the neuron is firing an action potential, a condition in which the neuron is releasing a neurotransmitter, or a combination of them. As a further example, biological states of a collection of plasma nutrients can include a condition in which a person awakens from an overnight fast, a condition just after a meal, and a condition between meals. As another example, biological state of a rheumatic joint can include significant cartilage degradation and hyperplasia of inflammatory cells.

A biological state can include a “disease state,” which refers to an abnormal or harmful condition associated with a biological system. A disease state is typically associated with an abnormal or harmful effect of a disease in a biological system. In some instances, a disease state refers to a condition associated with the occurrence of a set of biological processes of a biological system, where the set of biological processes play a role in an abnormal or harmful effect of a disease in the biological system. A disease state can be observed in, for example, a cell, an organ, a tissue, a multi-cellular organism, or a population of multi-cellular organisms. Examples of disease states include conditions associated with asthma, diabetes, obesity, infectious disease (e.g. viral, bacterial infection), cancer, stroke, cardiovascular disease (e.g. arteriosclerosis, coronary artery disease, heart valve disease, arrhythmia, heart failure, hypertension, orthostatic hypotension, shock, endocarditis, diseases of the aorta and its branches, disorders of the peripheral vascular system, and congenital heart disease) and inflammatory or autoimmune disorders (e.g. rheumatoid arthritis, multiple sclerosis).

The term “biomarker” refers to any detectable characteristic (e.g. physical characteristics) or molecule, other chemical species (e.g., an ion), or particle that is an indicator or predictor of a biological (e.g. disease) state or susceptibility to disease or to having a particular biological state, or that is an indicator or a predictor of treatment efficacy or safety. Exemplary biomarkers include proteins (e.g., antigens or antibodies), carbohydrates, cells, viruses, nucleic acids (e.g. a nucleotide present at a polymorphic site), and small organic molecules, or more generally any biological or cellular constituent. The biomarker may be a biomarker complex. Exemplary biomarkers include a patient descriptor (e.g., variables X and/or Y) that can be detected or measured, or a signal derived from a patient descriptor that can be detected or measured in vivo or in vitro. Exemplary biomarkers also include any disease parameters that can be measured in vitro or in vivo or signals derived from disease parameters that can be measured in vitro or in vivo; such biomarkers are typically indicative of a disease state or of disease progression.

The term “responder” refers to a patient who experiences a benefit from treatment above a given threshold (including between two thresholds). The thresholds may be defined according to any suitable manner or criteria.

“Effect Model”, as used herein, refers to a mathematical function that describes, for a population of individuals, the benefit from treatment as a function of the risk without treatment and one or more other characteristics of an individual (e.g. patient descriptors). The Effect Model may for example take the form of a function that describes the benefit from treatment (Rc−Rt) or the probability of an outcome under treatment (Rt) as a function of (i) risk without treatment (Rc) depending on a variable (Y), and (ii) a variable (X), wherein the variable (X) is a vector of characteristics of individuals other than the characteristics included in the risk without treatment (Rc), and where said variables (X) and (Y) may be environment-, phenotype- or genotype-derived variable(s).

“Formal Therapeutic Model”, as used herein, refers to a model that comprises a pharmacology model operably linked to a physiopathological model that integrates an event of interest as output and optionally a side-effect (e.g., toxicology) model that integrates side-effects and toxic-effects as an output.

The term “mechanistic model,” as used herein, refers to a computational model, for example a model having a set of differential equations, that describes the characteristics or behavior of a system, for example, a biological system. Mechanistic models can be causal models, which typically link two or more causally-related variables in a mathematical relationship that reflects the underlying mechanism(s), for example the biological mechanisms, affecting those variables.

The term “physiopathological model,” as used herein, refers to a model that includes one or more processes (e.g., biological processes) to represent the dynamics of healthy homeostasis and alterations from homeostasis, e.g., to represent disease, to represent a biological state, a disease state.

### 1.0 GENERAL OVERVIEW

### Components and Steps

The components and steps of an exemplary system of the invention are described in this section. As will be illustrated in Section 2.0 (Functional Overview), a system or method according to the invention need not incorporate all the components or steps described in this Section 1.0. Depending on the particular application desired, different components can be assembled to yield a system that achieves the particular purpose. Examples of different such systems making use of a subset of the components are provided in Section 2.0.

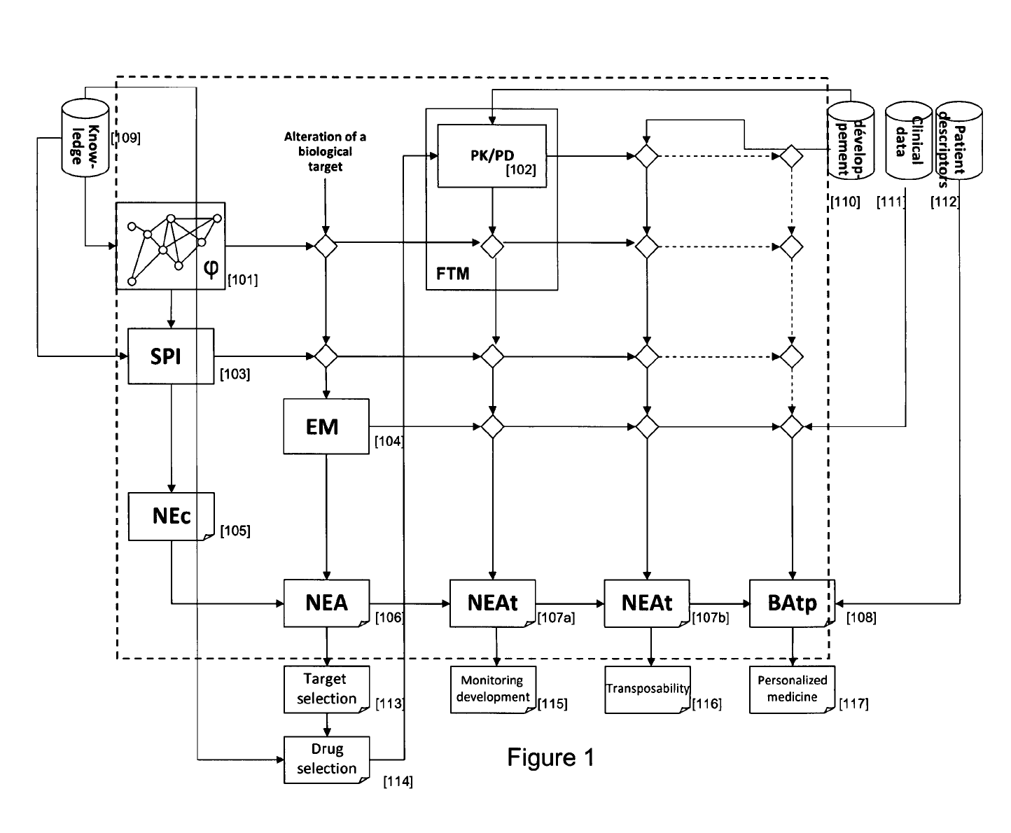

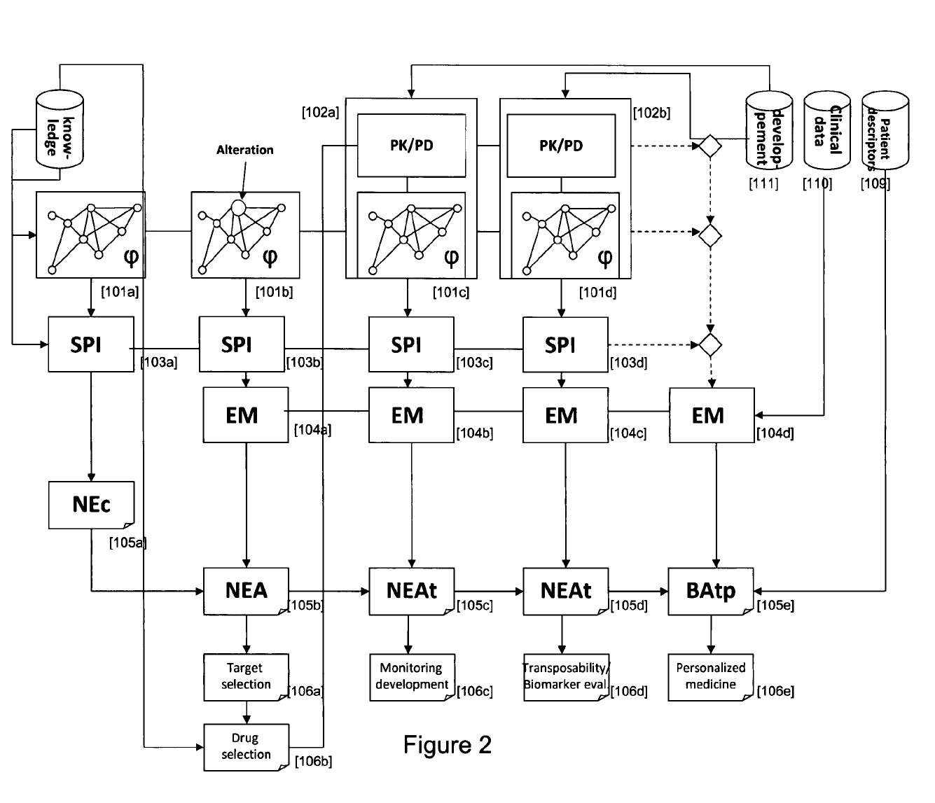

FIG. 1 provides an overview of a system and methodology that can carry out all the processes described herein, including methods for target and/or drug discovery, monitoring development, transposability studies, biomarker discovery and personalized medicine. Components are indicated within the dashed line outlining the core multifunctional system; the system comprises a physiopathological model (the network, block 101), a pharmacology model (PK/PD, block 102), a simulated population of individuals (SPI, block 103), an effect model (EM, block 104), a computation of the benefit to the population of individual(s) (NEc, NEA, NEAt, and BAtp in blocks —105 to 108 respectively). It will be appreciated that not all components are necessary, depending on the process that is to be carried out. Shown outside the core system are optional elements: databases (knowledge database (block 109), development database (block 110), clinical database (block 111) and patient descriptor database (block 112), downstream processes (target selection (block 113), ligand selection (block 114), monitoring development (block 115), transposability study (block 116) and personalized medicine (block 117). It will be appreciated that these optional elements can but need not be comprised within the core system individually or together. An overview of the different processes of the invention is shown in FIG. 2.

A method of the invention will minimally comprise (a) providing a treatment associated with an Effect Model, (b) providing inputs for an individual or population of individuals, (c) computing the benefit from treatment and (d) outputting an indicator of the benefit from treatment.

In one aspect the system and method comprises:

(a) providing one or a plurality of real or simulated treatments (T), wherein each treatment (T) is associated with an Effect Model function, e.g. by receiving the function together with a treatment identifier as an input or in a step of deriving the function from inputted information about a treatment, preferably where the function describes the benefit from treatment (Rc−Rt) or the rate of outcome of treatment (Rt) as a function of risk without treatment (Rc) depending on a variable (Y), and a variable (X), wherein the variable (X) is a vector of characteristics of individuals other than the characteristics included in the risk without treatment (Rc), and where said variables (X) and (Y) may be environment-, phenotype- or genotype-derived variable(s);

(b) providing patient descriptors for one or more individuals (e.g. a real patient, a simulated population of individuals), wherein each individual is associated with a risk (Rc) and a variable (X);

(c) computing the benefit from treatment (as a function of Rc−Rt) for one or more of said treatment(s) T said individual(s); and

(d) outputting, preferably displaying to a user, an indicator of the benefit from treatment (as a function of Rc−Rt) for said individual(s).

Such a system can be used as such without additional elements, such as described herein for certain personalized medicine applications. In personalized medicine applications, patient information is received, benefit from treatment is computed and an indicator of benefit from treatment is outputted. In certain biomarker identification or assessment methods, patient descriptors are evaluated for their effect on benefit from treatment, wherein the descriptors that affect benefit from treatment are identified as biomarkers (e.g. biomarkers of treatment efficacy). The system and method can comprise additional elements or steps depending on the use that is to be made. When the system is used in target evaluation processes (e.g. in drug screening, in evaluation of biological targets), monitoring development, transposability studies and certain personalized medicine applications the system will comprise an input for a simulated population of individuals wherein each individual is associated with a risk (Rc) and a variable (X).

When the system is used in target evaluation processes, monitoring development and certain transposability studies and certain personalized medicine applications, the system will comprise a physiopathological model. Furthermore, in drug screening applications of the target evaluation processes, in monitoring development and in certain transposability studies, the system will comprise a formal therapeutic model. When the system is used in methods of identifying or assessing biomarkers, the system may comprise a physiopathological model, optionally further a simulated population of individuals built with the distribution of all model parameters or variables.

In one embodiment, the Effect Model associated with a treatment may be inputted, generated or received, and optionally stored in the methods and system (e.g. by accessing a database of treatments associated with Effect Models). In another embodiment, the Effect Model associated with a treatment is derived by the method of system in step that comprises (i) inputting, generating or receiving, and optionally storing, information for treatment T and (ii) deriving from said information an Effect Model for the treatment.

The individual elements of the system and methods are described as follows.

### 1.1 Treatment Inputs and Benefit Function

A treatment (T) can be any suitable treatment. A treatment may be a real treatment or a simulated treatment. An example of a simulated treatment is an alteration of one or more biological constituents (e.g., an alteration of a biological process, an alteration, e.g. inhibition or stimulation, of a biological target) or biological systems. A real treatment will generally comprise a treatment (e.g., a treatment method, a drug) for which information from its clinical and/or non-clinical use is available.

In the method and system of the invention each treatment will be associated with a benefit function (the term “benefit function” is also referred to herein as the “Effect Model”) that describes, for a population, the benefit from treatment as a function of the risk without treatment and patient characteristics (X). An Effect Model is shown in blocks 104a to 104d in FIG. 2. A suitable Effect Model is a function that describes the benefit from treatment (Rc−Rt) as a function of risk without treatment (Rc) depending one or more variable(s) (Y) and variable(s) (X), wherein the variable(s) (X) is a vector of characteristics of individuals other than the characteristics included in the risk without treatment (Rc), and where said variables (X) and (Y) may be environment-, phenotype- or genotype-derived variable(s). The inputs to the method and system of the invention, for a treatment, may comprise treatment descriptors comprising information about a treatment and/or an Effect Model for a treatment. It will be appreciated that the Effect Model can be derived by the method and system of the invention based on inputted information for a treatment. Consequently, inputs for a treatment may comprise, in addition to typically a treatment identifier, information concerning the treatment (e.g. results from clinical use, etc.) without an associated Effect Model, such that the Effect Model is then generated by method or system of the invention and associated with the treatment. Methods for deriving an Effect Model from different types of information are further described herein. In another embodiment, the inputs for a treatment may comprise an Effect Model that has been previously derived from information concerning the treatment; in this embodiment the method and system of the invention need not further derive the Effect Model for the treatment.

Information relating to a treatment may comprise data and/or treatment descriptors. Information such as data may include any experimental results such as information from in vitro (e.g. functional assays, microarray data, etc.) or in vivo assays, including but not limited to the treatment's effect on the function of a biological or cellular constituent or biological system, its therapeutic target, pharmacological information, etc. Information may also comprise any information from clinical use, including but not limited to clinical trials or use in clinical practice, e.g. as may be the case for marketed treatments. The methods may therefore optionally further include in any embodiment a step of obtaining an experimental result for a treatment and optionally storing said results. The experimental data is then integrated as an input in the methods and system of the invention. Information about a treatment can in many cases be obtained from scientific publications, including by using search tools, such as MedLine, Chemical Abstracts, Biosis Previews, etc., that permit computer searching of large numbers of scientific journals or abstracts, such as Science, Nature, Proceedings of the National Academy of Sciences, etc. as well as any search engines that “read” and analyze publications to extract data. Sources of information also include any public databases, private databases, and proprietary data such as confidential data developed within and confined to a particular laboratory. Information for a treatment may alternatively or in addition comprise an output from a physiopathological model or a Formal Therapeutic Model. The methods may therefore optionally further include in any embodiment a step of modeling a treatment a physiopathological model or a Formal Therapeutic Model (i.e. running a model) and optionally storing said results.

Where information from clinical use, from a physiopathological model or a Formal Therapeutic Model is included, information will typically comprise patient descriptors for one or more patients treated with a treatment, together with the outcome (e.g., medical outcome, occurrence of event of interest) for the individual(s). Where information is from clinical use, the patients will preferably be real patients. Where the information is an output from a physiopathological model or a Formal Therapeutic Model, the patients will be simulated, preferably as a model of disease.

A simulated treatment will generally comprise a treatment for which information available is solely or primarily from simulations, without e.g., data from experimental or clinical experimentation. A simulated treatment may be represented as an alteration of a biological target of interest; the alteration may represent the therapeutic target of the simulated treatment or an indirect effect caused by the simulated treatment. The step of altering biological targets is discussed under the component “Physiopathological Model”. The physiopathological model yields treatment information that can be used to derive the Effect Model for the treatment.

Patient descriptors will preferably comprise: (a) variable(s) (Y) correlated with the occurrence of an outcome (event) of interest (they are called “risk factors”) which are integrated in risk without treatment (Rc), and/or (b) variable(s) (X) correlated with the intensity of the benefit which are not integrated in Rc.

Variable(s) (X) correlated with the intensity of the benefit may optionally interact with treatment descriptors (e.g. body weight, which modulates the distribution volume of a drug). Examples of variable(s) (X) correlated with the intensity of the benefit include body mass index, enzyme activities, blood pressure, one or a set of gene alleles, any level of a biological constituent at rest and/or after stimulation (e.g. by a meal, administration of drug or other modulator, etc), or any behavioural or environment component. Examples of variable(s) (Y) correlated with the occurrence of an outcome include blood cholesterol, blood pressure, age, gender, behavioural or environmental components,e.g. smoking or past smoking, physical exercise, etc.

In one embodiment, a patient descriptor is a biomarker. In such an embodiment, a biomarker may be a patient descriptor (e.g., X and/or Y) that can be detected or measured, or a signal derived from a patient descriptor that can be detected or measured in vivo or in vitro. Such biomarkers may be predictors of the size of the benefit given by the treatment when derived from X and Y, or predictors of disease (e.g., disease state, progression, severity, etc.) when derived from only Y. In one example, a patient descriptor is a biomarker identified according to the method of section 1.1.1 (Identification of new biomarkers of disease).

It will be appreciated that the methods and systems of the invention can be used to model any medicinal products and more generally any treatment. Examples of drugs that can embody treatments include, e.g., 5-alpha-reductase inhibitors, 5-aminosalicylates, 5HT3 receptor antagonists, adamantane antivirals, adrenal cortical steroids, adrenal corticosteroid inhibitors, adrenergic bronchodilators, agents for hypertensive emergencies, agents for pulmonary hypertension, aldosterone receptor antagonists, alkylating agents, alpha-adrenoreceptor antagonists, alpha-glucosidase inhibitors, alternative medicines, amebicides, aminoglycosides, aminopenicillins, aminosalicylates, amylin analogs, analgesic combinations, analgesics, androgens and anabolic steroids, angiotensin converting enzyme inhibitors, angiotensin II inhibitors, anorectal preparations, anorexiants, antacids, anthelmintics, anti-angiogenic ophthalmic agents, monoclonal antibodies, anti-infectives, antiadrenergic agents, centrally acting, antiadrenergic agents, peripherally acting, antiandrogens, antianginal agents, antiarrhythmic agents, antiasthmatic combinations, antibiotics/antineoplastics, anticholinergic antiemetics, anticholinergic antiparkinson agents, anticholinergic bronchodilators, anticholinergic chronotropic agents, anticholinergics/antispasmodics, anticoagulants, anticonvulsants, antidepressants, antidiabetic agents, antidiabetic combinations, antidiarrheals, antidiuretic hormones, antidotes, antiemetic/antivertigo agents, antifungals, antigonadotropic agents, antigout agents, antihistamines, antihyperlipidemic agents, antihyperlipidemic combinations, antihypertensive combinations, antihyperuricemic agents, antimalarial agents, antimalarial combinations, antimalarial quinolines, antimetabolites, antimigraine agents, antineoplastic detoxifying agents, antineoplastic interferons, antineoplastic monoclonal antibodies, antineoplastics, antiparkinson agents, antiplatelet agents, antipseudomonal penicillins, antipsoriatics, antipsychotics, antirheumatics, antiseptic and germicides, antithyroid agents, antitoxins and antivenins, antituberculosis agents, antituberculosis combinations, antitussives, antiviral agents, antiviral combinations, antiviral interferons, anxiolytics, sedatives, and hypnotics, aromatase inhibitors, atypical antipsychotics, azole antifungals, bacterial vaccines, barbiturate anticonvulsants, barbiturates, BCR-ABL tyrosine kinase inhibitors, benzodiazepine anticonvulsants, benzodiazepines, beta-adrenergic blocking agents, beta-lactamase inhibitors, bile acid sequestrants, biologicals, bisphosphonates, bone resorption inhibitors, bronchodilator combinations, bronchodilators, calcitonin, calcium channel blocking agents, carbamate anticonvulsants, carbapenems, carbonic anhydrase inhibitor anticonvulsants, carbonic anhydrase inhibitors, cardiac stressing agents, cardioselective beta blockers, cardiovascular agents, catecholamines, CD₂O monoclonal antibodies, CD33 monoclonal antibodies, CD52 monoclonal antibodies, CTLA4 antibodies, central nervous system agents, cephalosporins, cerumenolytics, chelating agents, chemokine receptor antagonist, chloride channel activators, cholesterol absorption inhibitors, cholinergic agonists, cholinergic muscle stimulants, cholinesterase inhibitors, CNS stimulants, coagulation modifiers, colony stimulating factors, contraceptives, corticotropin, coumarins and indandiones, cox-2 inhibitors, decongestants, dermatological agents, diagnostic radiopharmaceuticals, dibenzazepine anticonvulsants, digestive enzymes, dipeptidyl peptidase 4 inhibitors, diuretics, dopaminergic antiparkinsonism agents, drugs used in alcohol dependence, echinocandins, EGFR inhibitors, estrogen receptor antagonists, estrogens, expectorants, factor Xa inhibitors, fatty acid derivative anticonvulsants, fibric acid derivatives, first generation cephalosporins, fourth generation cephalosporins, functional bowel disorder agents, gallstone solubilizing agents, gamma-aminobutyric acid analogs, gamma-aminobutyric acid reuptake inhibitors, gamma-aminobutyric acid transaminase inhibitors, gastrointestinal agents, general anesthetics, genitourinary tract agents, GI stimulants, glucocorticoids, glucose elevating agents, glycopeptide antibiotics, glycoprotein platelet inhibitors, glycylcyclines, gonadotropin releasing hormones, gonadotropin-releasing hormone antagonists, gonadotropins, group I, H, III, IV or V antiarrhythmics, growth hormone receptor blockers, growth hormones, H. pylori eradication agents, H2 antagonists, hematopoietic stem cell mobilizer, heparin antagonists, heparins, HER2 inhibitors, herbal products, histone deacetylase inhibitors, hormone replacement therapy, hormones, hormones/antineoplastics, hydantoin anticonvulsants, illicit (street) drugs, immune globulins, immunologic agents, immunosuppressive agents, impotence agents, in vivo diagnostic biologicals, incretin mimetics, inhaled anti-infectives, inhaled corticosteroids, inotropic agents, insulin, insulin-like growth factor, integrase strand transfer inhibitor, interferons, intravenous nutritional products, iodinated contrast media, ionic iodinated contrast media, iron products, ketolides, laxatives, leprostatics, leukotriene modifiers, lincomycin derivatives, lipoglycopeptides, local injectable anesthetics, loop diuretics, lung surfactants, lymphatic staining agents, lysosomal enzymes, macrolide derivatives, macrolides, magnetic resonance imaging contrast media, mast cell stabilizers, medical gas, meglitinides, metabolic agents, methylxanthines, mineralocorticoids, minerals and electrolytes, miscellaneous agents, miscellaneous analgesics, miscellaneous antibiotics, miscellaneous anticonvulsants, miscellaneous antidepressants, miscellaneous antidiabetic agents, miscellaneous antiemetics, miscellaneous antifungals, miscellaneous antihyperlipidemic agents, miscellaneous antimalarials, miscellaneous antineoplastics, miscellaneous antiparkinson agents, miscellaneous antipsychotic agents, miscellaneous antituberculosis agents, miscellaneous antivirals, miscellaneous anxiolytics, sedatives and hypnotics, miscellaneous biologicals, miscellaneous bone resorption inhibitors, miscellaneous cardiovascular agents, miscellaneous central nervous system agents, miscellaneous coagulation modifiers, miscellaneous diuretics, miscellaneous genitourinary tract agents, miscellaneous GI agents, miscellaneous hormones, miscellaneous metabolic agents, miscellaneous ophthalmic agents, miscellaneous otic agents, miscellaneous respiratory agents, miscellaneous sex hormones, miscellaneous topical agents, miscellaneous uncategorized agents, miscellaneous vaginal agents, mitotic inhibitors, monoamine oxidase inhibitors, monoclonal antibodies, mouth and throat products, mTOR inhibitors, mTOR kinase inhibitors, mucolytics, multikinase inhibitors, muscle relaxants, mydriatics, narcotic analgesic combinations, narcotic analgesics, nasal anti-infectives, nasal antihistamines and decongestants, nasal lubricants and irrigations, nasal preparations, nasal steroids, natural penicillins, neuraminidase inhibitors, neuromuscular blocking agents, next generation cephalosporins, nicotinic acid derivatives, nitrates, NNRTIs, non-cardioselective beta blockers, non-iodinated contrast media, non-ionic iodinated contrast media, non-sulfonylureas, nonsteroidal anti-inflammatory agents, norepinephrine reuptake inhibitors, norepinephrine-dopamine reuptake inhibitors, nucleoside reverse transcriptase inhibitors (NRTIs), nutraceutical products, nutritional products, ophthalmic anesthetics, ophthalmic anti-infectives, ophthalmic anti-inflammatory agents, ophthalmic antihistamines and decongestants, ophthalmic diagnostic agents, ophthalmic glaucoma agents, ophthalmic lubricants and irrigations, ophthalmic preparations, ophthalmic steroids, ophthalmic steroids with anti-infectives, ophthalmic surgical agents, oral nutritional supplements, otic anesthetics, otic anti-infectives, otic preparations, otic steroids, otic steroids with anti-infectives, oxazolidinedione anticonvulsants, parathyroid hormone and analogs, penicillinase resistant penicillins, penicillins, peripheral opioid receptor antagonists, peripheral vasodilators, peripherally acting antiobesity agents, phenothiazine antiemetics, phenothiazine antipsychotics, phenylpiperazine antidepressants, plasma expanders, platelet aggregation inhibitors, platelet-stimulating agents, polyenes, potassium-sparing diuretics, probiotics, progesterone receptor modulators, progestins, prolactin inhibitors, prostaglandin D2 antagonists, protease inhibitors, proton pump inhibitors, psoralens, psychotherapeutic agents, psychotherapeutic combinations, purine nucleosides, pyrrolidine anticonvulsants, quinolones, radiocontrast agents, radiologic adjuncts, radiologic agents, radiologic conjugating agents, radiopharmaceuticals, RANK ligand inhibitors, recombinant human erythropoietins, renin inhibitors, respiratory agents, respiratory inhalant products, rifamycin derivatives, salicylates, sclerosing agents, second generation cephalosporins, selective estrogen receptor modulators, selective serotonin reuptake inhibitors, serotonin-norepinephrine reuptake inhibitors, serotoninergic neuroenteric modulators, sex hormone combinations, sex hormones, skeletal muscle relaxant combinations, skeletal muscle relaxants, smoking cessation agents, somatostatin and somatostatin analogs, spermicides, statins, sterile irrigating solutions, streptomyces derivatives, succinimide anticonvulsants, sulfonamides, sulfonylureas, synthetic ovulation stimulants, tetracyclic antidepressants, tetracyclines, therapeutic radiopharmaceuticals, thiazide diuretics, thiazolidinediones, thioxanthenes, third generation cephalosporins, thrombin inhibitors, thrombolytics, thyroid drugs, tocolytic agents, topical acne agents, topical agents, topical anesthetics, topical anti-infectives, topical antibiotics, topical antifungals, topical antihistamines, topical antipsoriatics, topical antivirals, topical astringents, topical debriding agents, topical depigmenting agents, topical emollients, topical keratolytics, topical steroids, topical steroids with anti-infectives, toxoids, triazine anticonvulsants, tricyclic antidepressants, trifunctional monoclonal antibodies, tumor necrosis factor (TNF) inhibitors, tyrosine kinase inhibitors, ultrasound contrast media, upper respiratory combinations, urea anticonvulsants, urinary anti-infectives, urinary antispasmodics, urinary pH modifiers, uterotonic agents, vaccine, vaccine combinations, vaginal anti-infectives, vaginal preparations, vasodilators, vasopressin antagonists, vasopressors, VEGFNEGFR inhibitors, viral vaccines, viscosupplementation agents, vitamin and mineral combinations and vitamins.

### 1.1.1 Identification of New Biomarkers of Disease (X, Y)

In certain embodiments, an optional step is provided to identify biomarkers for use in the systems and methods further described herein. In other embodiments, the methods to identify biomarkers can be used separately of any of the systems and methods described herein. Biomarkers may be predictors of disease (e.g., disease state, progression, severity, etc.) when derived from X, Y. While many such biomarkers may be known in the art, together with their correlation with disease and thus risk without treatment (Rc), it may be useful to identify new biomarkers that are not known to be correlated with the disease state of interest.

In one aspect, provided herein is a method to identify such biomarkers that can subsequently be used as variables X in the methods of the invention. The biomarkers and methods for their identification are therefore particularly well adapted for use in the broader methods of the invention that make use of patient descriptors (particularly the descriptors X).

The method makes use of a physiopathological model, as described in section 1.2., in order to assess correlations between components of the physiopathological model and disease state. The physiopathological model comprises components and/or interrelationships between components, which components or interrelationships represent patient descriptors (particularly the descriptors X, and also descriptors Y), and these descriptors are therefore candidate biomarkers. A physiopathological model is run for combinations of different components within the vector (Y) for risk factors and other descriptors X, or for combination of different values for a plurality of components within the vectors (Y, X) for risk factors and other disease related components X. Running the physiopathological model will compute the risk (likelihood of occurrence) of an event of interest for each combination of values of components, and will produce a set of output information from such computation. The event of interest can be any suitable parameter, such as an indicator of disease state, progression, severity, etc. The results can then be assessed using statistical methods to identify those biomarkers correlated with disease state of interest. Biomarkers will in this case be components of the physiopathological model; preferably these biomarkers will further correspond to patient descriptors that can be detected or measured in vivo or in vitro.

Thus, in one aspect, the invention provides a method for identifying a biomarker of disease, the method comprising: (a) running a physiopathological model comprising one or a plurality of components or interrelationship between components of the physiopathological model, the components or interrelationships representing candidate biomarkers, and wherein the physiopathological model generates a likelihood of an event of interest for each candidate biomarker or combination of biomarkers (or values associated with each candidate biomarker); and (b) identifying a biomarker or combination of biomarkers correlated with an increased or decreased likelihood of an event of interest, wherein said correlated biomarker or combination of biomarkers is determined to be a biomarker of disease (e.g. of a disease state, progression, severity). Optionally, the method further comprises calculating by an outcome processing system of the invention a benefit of treatment, wherein said biomarker is included within the vector of characteristics of individuals included in the risk without treatment (Rc) (variable (Y)).

### 1.1.2 Benefit Function

Information for a treatment (e.g., data, treatment descriptors) may be inputted together with or without the Effect Model for the particular treatment. In one embodiment, inputs comprise an Effect Model; in such a case information for the treatment in addition to the Effect Model may be minimal, e.g. an identifier for the treatment is all that is required minimally in addition to the Effect Model. In another embodiment, information for a treatment is inputted and the Effect Model is obtained by deriving the Effect Model from the information for each treatment. In the latter embodiment, information for the treatment will typically comprise clinical data, outputs from a physiopathological model or a Formal Therapeutic Model. The information for a treatment may be provided by any suitable method, e.g. inputting via an input device or by receiving an input from a database. Optionally, the system of the invention comprises a database comprising one or a plurality of treatments and information for each treatment, wherein such information comprises an Effect Model and/or information relating to a treatment's therapeutic target, in vitro, in vivo experimental results or results from clinical use. Preferably information will include variables (e.g., X, Y); for example results from clinical use will include, for the patients treated with a treatment T, the outcome (e.g. occurrence of an event of interest) and patient descriptors (X) and (Y) describing the patient characteristics, where patient descriptors (X) and (Y) are environment-, phenotype- or genotype-derived variable(s).

The Effect Model expresses the benefit from treatment in terms of occurrence of events of interest. The expected effect of a treatment is typically a decrease of the risk or occurrence of an adverse or unwanted event(s) of interest (e.g., mortality and/or morbidity, susceptibility thereto, or any parameter that is indicative thereof), as for example may be caused by a disease. In the example of angina pectoris one may want to decrease the probability of occurrence of chest pain. In this example the Effect Model is used where Rc is the frequency of this clinical event (chest pain) in individuals if they do not receive the treatment T. In the same but treated subjects the frequency becomes Rt over the same period of time. The relation between these two frequencies depends on treatment, disease, and therapeutic objective, i.e., the “event” of interest (typically a clinical criterion) chosen for efficacy, e.g. chest pain, sudden death, myocardial infarction in the case of cardiovascular disease.

An event of interest may be any desired detectable event, including but not limited to any clinically observable phenomena or any detectable measure (e.g. a biomarker) or underlying biological mechanism which gives rise to a clinically-observable process. The event may be as simple as the occurrence or not of a clinical event (e.g. stroke, death, etc.) or the occurrence of any quantitative or qualitative threshold (e.g. tumor growth, progression or regression, tumor volume, new tumor formation, levels of a biomarker or levels of biological constituent, optionally in a tissue or in circulation, levels of rADCw, gene expressions, levels of hormones, quality of life scale scores, etc.).

The form of the relation between Rt and Rc is represented by the following equation:

Rt=f(Rc,T,x),

where T indicates that it is treatment dependent and X is a vector of characteristics of individuals correlated with Rt other than those relevant to Rc. X may be phenotype or genotype-derived variables. Some may be altered by the individuals' environment. From this relation, one derives Rc−Rt=g(Rc, T, X). This function gives the absolute benefit, that is, the gain by T expected for a patient (Rc, X).

The methods used to derive, for a treatment T, the Effect Model based on information for a treatment will depend on the information provided for a treatment. Generally, the Effect Model can be derived by applying one or more regression methods to the data available including, but not limited to, generalized linear and nonlinear regressions, logistic and Poisson regressions, supervised machine learning algorithms (e.g., neural networks, support vector machines), and other methods (response surface modeling, multivariate adaptive regression splines).

1. Deriving the Effect Model from Clinical Data

In one embodiment, exemplified by a certain transposability study methods or personalized medicine methods, a treatment is associated with information arising from the clinical use of the treatment. In this embodiment, the effects of the treatment on treated individuals (e.g. in terms of occurrence of an event of interest) can be compared to untreated individuals; data from clinical trials (e.g. patient descriptors and medical outcome for each individual) are provided, and regression techniques are applied so as to estimate the Effect Model of the treatment, a function giving the benefit Rc−Rt=f(Rc, X) for each individual of a population.

2. Deriving the Effect Model from a Physiopathological Model

In one embodiment, exemplified by a target evaluation method, a treatment effect is modeled through use of a physiopathological model. In this case information for a treatment typically includes information about the likelihood of occurrence of an event of interest. Examples include altering a biological target in a physiopathological model, the alteration representing a treatment that would cause such an alteration. In this embodiment, where a biological target is to be evaluated, the effects of the unaltered physiopathological model (e.g. in terms of occurrence of an event of interest) representing a first biological state (e.g. a disease state) can be compared to the effects of the altered physiopathological model comprising the alteration, preferably in each case of a real or virtual population of individuals, taking into account a variable(s). Regression techniques can then be applied to the 2-dimensional set of data for the risk without treatment (Rc) and benefit from treatment (Rt) so as to estimate the Effect Model of the treatment, a function giving the benefit Rc−Rt=f(Rc, X) for each individual. In simplified cases, the Effect Model can be obtained by mathematically solving the set of equations describing the physiopathological model. The resulting benefit will thereby describe the benefit predicted from altering the biological target, permitting the physiological role and therapeutic potential of a biological target to be evaluated.

3. Deriving the Effect Model from a Formal Therapeutic Model

In another embodiment, exemplified by a development monitoring method, information is inputted for a treatment for which pharmacological information is available or simulated. In this embodiment, pharmacological information is inputted and a treatment is modeled in a Formal Therapeutic Model comprising a pharmacology model and a pathophysiology model, and a variable(s). The physiopathological model outcome (e.g. in terms of occurrence of an event of interest) in the absence of treatment can be compared to the effects of the physiopathological model as modified by the treatment; regression techniques can then be applied to the 2-dimensional set of data for the risk without treatment (Rc) and benefit from treatment (Rt) so as to estimate the Effect Model of the treatment, a function giving the benefit Rc−Rt=f(Rc, X) for each individual of a population.

It will be appreciated that optionally, at any step in using a method or system comprising a Formal Therapeutic Model, a step of providing clinical data and using said data to modify the Formal Therapeutic Model can be carried out. Such step will have the effect of verifying and improving the accuracy of the Formal Therapeutic Model by comparing results as to benefit from the Formal Therapeutic Model results obtained from clinical data. Such a step can involve comparing the Effect Model computed from the Formal Therapeutic Model to the Effect Model derived from clinical data. The comparison takes into account both the formulae and the included variables. Any discrepancy can be explored. The Effect Model computed from the Formal Therapeutic Model will typically be presumed to be closer to reality than the Effect Model computed from clinical data. The comparison focuses on variables that are included in the Effect Model derived from clinical data and not in the Formal Therapeutic Model derived Effect Model, or vice-versa. These variables are then included in the latter and integrated or maintained in the Formal Therapeutic Model if the precision of the individual or population benefit is improved and/or if it has a strong biological relevance.

### 1.2 Physiopathological Model

In certain embodiments such as certain methods for target evaluation, monitoring development, transposability studies and personalized medicine, a physiopathological model is used.

A physiopathological model will preferably account for all or a due selected part of the available knowledge on the biological mechanism which gives rise to disease and will integrates a clinically-observable outcome as an output. A physiopathological model can be a model comprising a set of logical forms with or without various mathematical, logical, numerical and/or computerized instruments representing the logical forms used to describe the dynamic behavior of a disease state. A physiopathological model is preferably a disease model. The processes represented in a physiopathological model may include any clinically observable phenomena or an underlying biological mechanism which gives rise to a clinically-observable process, whether or not the biological mechanism itself may be easily measurable in a clinical setting. Non-limiting examples of processes include any biological process; the binding of a drug to a receptor (including, e.g., the binding constant); the catalysis of a particular chemical reaction, e.g., an enzymatic reaction (including, e.g., the rate of such a reaction); the synthesis or degradation of a cellular constituent, such as a molecule or molecular complex (including, e.g., the rate of such synthesis or degradation); the modification of a cellular constituent, such as the phosphorylation or glycosylation of a protein (including, e.g., the rate of such phosphorylation or glycosylation); the proliferation, activation, movement or migration, or death of cells; the flow of any molecule (e.g., ions, water, any chemically reactive molecule, proteins, etc.) and the like.

Blocks 101a to 101d of FIG. 2 represent a physiopathological model representing a biological system, including a network of qualitative and/or quantitative interactions connecting biological and cellular constituents that describe a biological process, tissue, organs and/or body components. The physiopathological model is associated with individual parameters and/or variables and the risk factors. The risk factors (Y) are summarized in Rc, the risk of an outcome of interest (e.g. the frequency of a undesirable health incident). Further to Y, the individual parameters/variables are represented by X, wherein X is a vector of inter-individual variability. X therefore represents characteristics of individuals other than those included in Rc, and where X, as Y, may be environment-, phenotype- or genotype-derived variable(s).

A physiopathological model typically comprises a mechanistic model. A physiopathological model can alternatively or in addition comprise an empirical model and/or a phenomenological model. Examples of physiopathological models include models that describe biological processes as well as phenomenological models that describe interactions between biological systems without describing underlying biological processes.

It will be appreciated that the physiopathological model may but need not simulate an entire human being or system involving multiple organs, but may simulate at least one physiological process such as a step or several steps involved in a disease process. Depending on the application, the physiopathological model may for example simulate one or more groups of cells, tissues, one or more organs, etc., so long as such simulation allows the risk of an event to be predicted.

Biological processes represented in the physiopathological model can include, for example, signaling and control pathways. Biological constituents of such pathways include, for example, primary or intermediate signaling molecules as well as proteins participating in signaling or control cascades that usually characterize these pathways. For signaling pathways, binding of a signaling molecule to a receptor can directly influence the amount of intermediate signaling molecules and can indirectly influence the degree of phosphorylation (or other modification) of pathway proteins. Binding of signaling molecules can influence activities of cellular proteins by, for example, affecting the transcriptional behavior of a cell. These cellular proteins are often important effectors of cellular events initiated by a signal. Control pathways, such as those controlling the timing and occurrence of cell cycles, share some similarities with signaling pathways. Here, multiple and often ongoing cellular events are temporally coordinated, often with feedback control, to achieve an outcome, such as, for example, cell division with chromosome segregation. This temporal coordination is a consequence of the functioning of control pathways, which are often mediated by mutual influences of proteins on each other's degree of modification or activation (e.g., phosphorylation). Other control pathways can include pathways that can seek to maintain optimal levels of cellular metabolites in the face of a changing environment.

A physiopathological model may be a mathematical model that represents a set of biological processes of a physiological system using a set of mathematical relations. For example, the model can represent a first biological process using a first mathematical relation and a second biological process using a second mathematical relation. A mathematical relation typically includes one or more variables, the behavior (e.g., time evolution) of which can be simulated by the model. More particularly, mathematical relations of the model can define interactions among variables, where the variables can represent levels or activities of various biological constituents of the physiological system as well as levels or activities of combinations or aggregate representations of the various biological constituents. A model typically includes a set of parameters that affect the behavior of the variables included in the model. For example, the parameters represent initial values of variables, half-lives of variables, rate constants, conversion ratios, and exponents. These variables typically admit a range of values, due to variability in experimental systems. Specific values are chosen to give constituent and system behaviors consistent with known constraints. Thus, the behavior of a variable in the model changes over time. The computer model includes the set of parameters in the mathematical relations. In one implementation, the parameters are used to represent intrinsic characteristics (e.g., genetic factors) as well as external characteristics (e.g., environmental factors) for a biological system. Mathematical relations used in a model can include, for example, ordinary differential equations, partial differential equations, stochastic differential equations, differential algebraic equations, difference equations, cellular automata, coupled maps, equations of networks of Boolean, fuzzy logical networks, or a combination of them.

Running the physiopathological model will compute the risk (likelihood of occurrence) of an event of interest and will produce a set of output information from such computation. The physiopathological model will preferably associate with the risk the variables (X) and (Y) describing the model parameters that are patient descriptors, optionally wherein one or more of the variables are biomarkers, used in the physiopathological model, where variables (X) and (Y) are environment-, phenotype- or genotype-derived variable(s). The output information can then be used, e.g., to derive an Effect Model for a given alteration of a biological target.

In some embodiments such as biological target evaluation methods, a step of selecting a biological target of interest can be carried out, as indicated above block 101b of FIG. 2. This step may comprise inputting, e.g. receiving, inputting via an input device or otherwise specifying, one or more alteration(s) of the biological network, the alteration(s) represented as a potential treatment T. The alterations to be evaluated are thus specified such that the therapeutic benefit of altering a biological target is then computed.

A preferred physiopathological model in based on a discursive model, as further described as follows.

1. Constructing Models: Discursive Models

In one aspect, a discursive model is used. The discursive model is a step before building the computational model, which is, for example, a model having a set of differential equations. Such a model has the advantage of being suited to integrate various levels of interactions, including biological processes at the level of biological components and processes at the tissue and/or organ level. By integrating processes at the tissue and organ level, the physiopathological model can be used to predict the risk of a clinical event of interest. Discursive physiopathological models can thus take into account a disease process, i.e. it integrates upper levels, including physiology. Diseases encompass several layered organisational levels of complex phenomenon, from genes to population. Time scales vary from nanoseconds to several decades, with for the former scale chemical interactions and evolution to clinical events for the later. In chronic diseases, such as cancer or atherosclerosis, the sequence of events at the molecule, cell, tissue and target organ levels takes decades to achieve in death or myocardial infarction. In view of rapidly emerging scientific information, models will therefore be conceived flexible enough in order to integrate any new relevant knowledge.

Overall, modelling diseases develop along three axes: the phenomenon or sub-systems axis, the time axis, the integration axis. The first step in constructing a discursive physiopathological model is to determine what to model and how to arrive at a precise formulation of the objective(s), required in turn to fix choices that arise during the construction process. Further steps vary according to every research topics. Generally however, constructing a model will comprise the main steps that are shown in Table 1, although the steps need not be carried out in the order shown.

TABLE 1

| Step | Description |
|---|---|
| 1 | Setting the objective |
| 2 | Making up and organising the multidisciplinary team |
| 3 | Organising connections with in vitro and in vivo |
| | expert groups |
| 4 | Selecting the knowledge management tool(s) |
| 5 | Collecting the data |
| 6 | Writing the discursive model |
| 7 | Sub-setting the discursive model |
| 8 | Choosing a phenomenological approach or a |
| | mechanistic one (or both) |
| 9 | Finding the mathematical solutions |
| 10 | Modelling the sub-sets of the discursive model |
| | (sub-modelling) |
| 11 | Arranging the computational tools |
| 12 | Writing the numerical solutions |
| 13 | Integrating the sub-models |
| 14 | Exploring the model robustness |
| 15 | Reducing the model |
| 16 | Validating the model |
| 17 | Using the model: “in silico” experiments |

Generally, i) modelling of biological processes can be piecewise, with for each piece or sub-model clearly identified input and output and biomarkers that could be used to validate the overall model; ii) each piece can be numerically solved at a different level of complexity from the others; iii) at anytime in the progress of the modelling process, a sub-model can be replaced by a more detailed one (the “plug-in” principle).

Systems physiopathology requires collecting and analyzing all the available evidence and data, before selecting those relevant for the model. Their uncertainty and strength of evidence are weighted and recorded. Building a model in physiopathology relies on a “basis of knowledge”, which comprises elements of evidence that are considered as both sufficiently sound and that are important in a model. The type of evidence incorporated into a model may range from in vitro experimental results in basic biology, including structural biology, to epidemiology, randomised clinical trials and clinical investigation and imaging data. Experimental data is collected from scientific literature, together with the experimental conditions, the type of cells and species; data are then compared and erroneous data excluded. Because of the diversity of experimental and observational settings, values of a given parameter may vary over a range, and records are scored by variability and strength of evidence. Data will typically be stored in databases that incorporate quantitative, qualitative and structural information together with a scoring describing their evidentiary strength.

2. Splitting the Discursive Model in Sub-Models

The discursive model is typically a text and/or chart that brings together all the components of the disease and their interactions that are though relevant enough to the objective of the modelling process. It is the basis for the later steps of Table 1. Components and their connections will show up in the final mathematical model. It is presented as a text, summarised by a chart and several series of rules. The discursive model comes in a variety of embedded forms: at the molecular level, at the cellular level, etc.

In mathematical modelling steps, a large amount of heterogeneous knowledge and data is typically integrated. A solution consists in splitting the discursive model by identifying independent sub-systems. These are characterized by their ability to be studied and modelled independently as sub-models, while respecting the global system dynamic. For example, in modelling acute stroke, apoptosis is described as an entire process by itself. Independence of a subsystem can be described using a set of exemplary rules: i) the underlying biological phenomenon has a recognised specific functional status; ii) there are well characterised signals connecting with other subsystems (input/output of the sub-system); iii) it encompasses at least a biomarker which is measurable in vitro or in vivo (for the sake of validation of simulation results). For example, apoptosis can be viewed as a subsystem with relatively simple input/output signals e.g. calcium concentration, energy stores as inputs, and energy consumption and eventually cell death as output.

3. Chronology and Organizational Levels

Subsystems have two other characteristics of interest: a chronological component and an organizational level. The molecular level is the lower level, whereas the population level is the higher level. As critical pieces of the whole discursive model, subsystems can be organized along two dimensions, the time and organizational axes. Both axes are descriptors of the sequence of events, i.e. chronology and causal relationship. As an example, multiscale mathematical models of cancer growth or vascular event have been recently proposed. Ribba, B. et al, (2006) J Theor Biol. 243:532-541 and Dronne, M. A. et al., (2007) Brain Res; 1138:231-42, the disclosures of which are incorporated herein by reference.

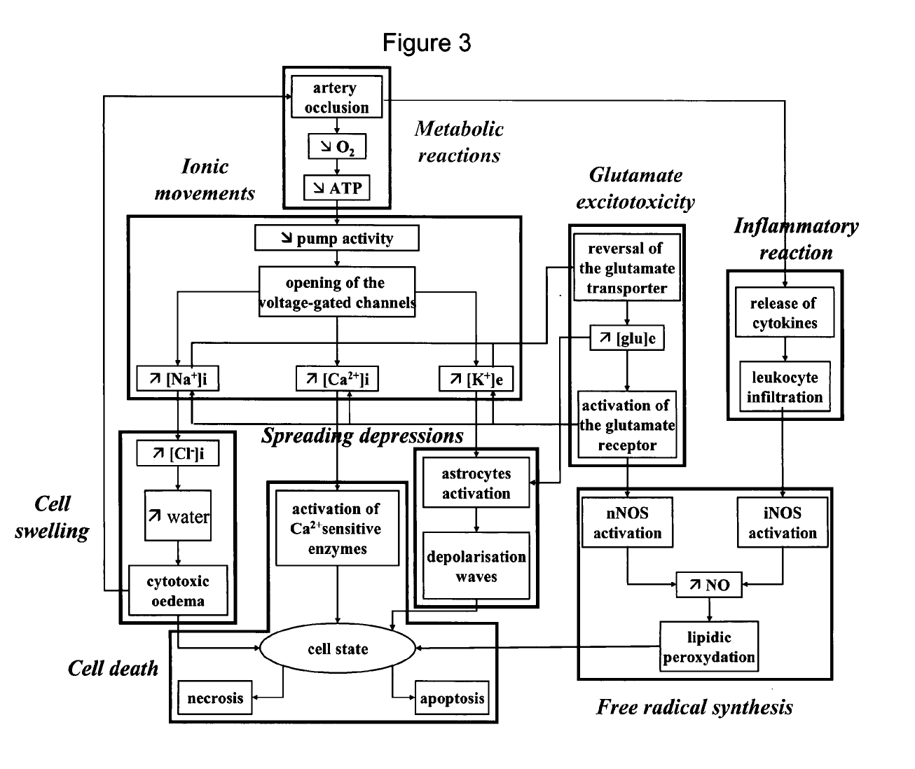

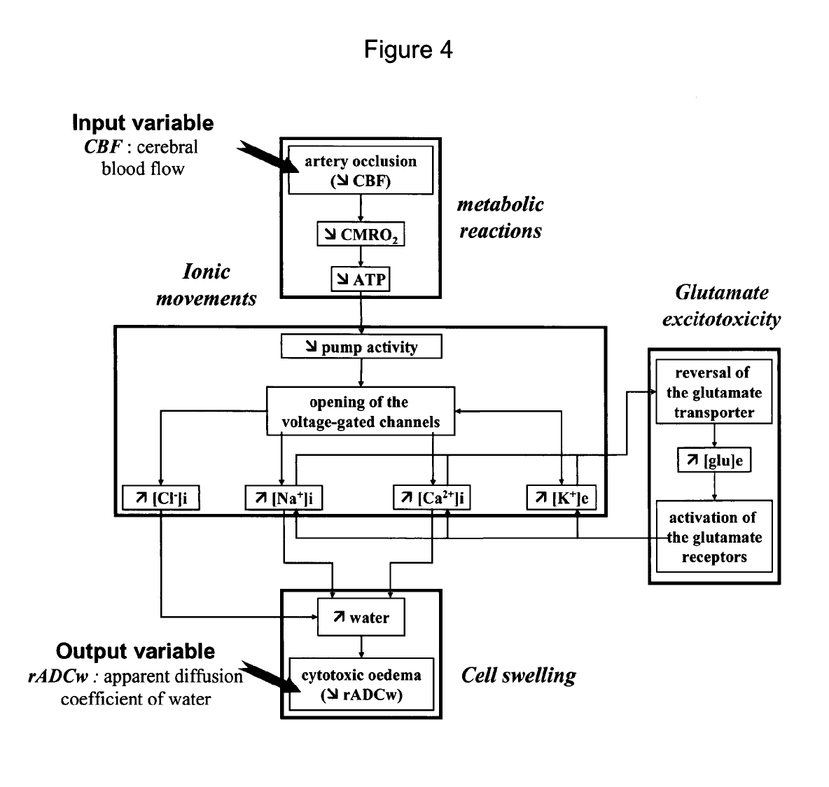

An example of acute stroke is provided herein (see e.g., FIGS. 3 and 4. In this model, cells die first by necrosis, caused by a cellular edema, resulting of abnormal ion exchanges because of energy deprivation. Then cells of the penumbra area may die through a completed apoptotic process. However, apoptosis occurs later, and can last several days. These examples show that subsystems can be linked by causal relations and can have different chronology. Cell and tissue mechanical properties are increasingly recognized as regulating factors of many biological processes ranging from gene transcription to tissue remodelling. Cell elasticity is a key parameter for mechanical signal transduction, while extracellular matrix stiffness regulates cell adhesion and migration. Environmental mechanical forces are known to affect many cellular functions, such as cell growth, proliferation, protein synthesis, and gene expression. Thus, mathematical modelling at the tissue level will preferably integrate different sub-systems at different organizational levels that account for e.g. cell proliferation, genetic expression protein synthesis. Modelling will in some embodiments integrate, e.g., cell proliferation regulated at a molecular and genetic levels, as well as macroscopic changes of tissue compression and deformation.

4. Parameter Valuation

A model is typically a series of equations and/or a series of rules characterized by algebraic or logical functions and parameters. The choice of functions depends on the connections or interactions between system components or entities. Parameter values determine the spatial and temporal behaviour of the model. Parameter selection and valuation generally follows any of three different methods or combinations thereof: i) the parameter values are drawn from the literature, i.e. the experimental data they were derived from are not accessible; ii) the parameters are adjusted on a set of experimental data using a statistical method (e.g. maximum likelihood) that allows fitting the model to the data, and/or iii) the parameter values are made to allow the model to meet general biochemical, physiological or physico-chemica rules or expected behaviour.

One may begin with an experimental set of parameter values for every parameter in the model and move on to a “reasonable” set. The experimental or observed set is directly drawn from the literature. It includes values that have been observed in similar experimental settings, as close as possible to the one the model is embedded in. Parameters may be considered to be “reasonable” if the model shows physiologically relevant responses to stimuli, correct rest state, and if the parameter values remain within plausible ranges. The values need not be “real” values but rather can be assigned within a plausible range according to qualitative dynamic and resting properties of the model. These properties arise from pre-specified rules included in the discursive model and drawn from the knowledge basis. Hence the basis of knowledge will contain not only experimental data but also a qualitative description of the global behaviour.

The reasonable set can be assessed either using probabilistic methods or using deterministic methods. Probabilistic methods consist of choosing at random a set of parameters and checking whether it leads to correct macroscopic behaviour, i.e. whether it meet a series of rules that represent the qualitative knowledge. With the deterministic methods, we first build a “distance” which measures the difference between the computed result and the desired one, and we then try to minimise the distance. With respect to ion channel model example of FIG. 3, the bases of rules are: i) There exists a stable rest equilibrium potential; ii) a short (1 ms) strong enough imposed current leads to an action potential. These two rules can be translated into mathematical statements and can be easily verified by an automatic procedure. If the tested set meets the rules, it is stored. At the end of a run, a few thousand parameter sets have been tested, leading to a few dozen suitable sets, which can then be explored in more details by adding more stringent criteria to the rules, e.g.: i) an action potential is created for short duration external stimuli; below, there should be no action potential, above, the cell is depolarized; ii) for long lasting external stimuli, either multiple action potentials are created or repetitive firing occurs. Unknown value parameters are managed the same way, i.e. their values is the ones that make the model to meet the rules describing the behaviour of the biological systems of interest.

5. Model Types

Various model types may be suitable. A phenomenological model is reduced to a representation of the envelope of the phenomenon of interest. For instance, apoptosis in acute stroke in the model of FIG. 3 can be modelled by any mathematical equation which increases along time up to a maximum, then levels off and eventually goes down to baseline after a couple of days. The main advantage of phenomenological models is their simplicity. Mechanistic models on the other hand aim at incorporating as many known details of the system as possible. In embodiments such as evaluating biological targets described herein, mechanistic models are preferred. The choice between the two alternatives typically depends on: i) the objective of the modelling process; ii) the availability of information regarding the system; iii) the chosen strategy. The plug-in principle makes possible to use a phenomenological model for a sub-system while the other sub-systems are modelled mechanistically. If the need of detailing a sub-system arises later, the phenomenological sub-model is replaced by a mechanistic one with the same entries and outputs.

### 1.3 Formal Therapeutic Model

In certain embodiments of the invention such as certain methods for target evaluation, monitoring development, transposability studies and personalized medicine, a Formal Therapeutic Model is used.

A Formal Therapeutic Model comprises a physiopathological model and a pharmacology model. A Formal Therapeutic Model can be constructed by assembling a pharmacokinetic (PK) model, a pharmacodynamics (PD) model and the physiopathological model. In methods of monitoring development (block 106c of FIG. 2), PK and PD data associated provided as inputs to the Formal Therapeutic Model can be obtained from experimentation using the treatment whose development is to be monitored (e.g., block 111 of FIG. 2).

In methods of evaluating transposability of clinical results (block 106d of FIG. 2), PK and PD data provided as inputs to the Formal Therapeutic Model can be obtained from scientific or medical literature, e.g. as observed from prior studies using the treatment and stored in a database (block 111 of FIG. 2).

The pharmacology model example shown in block 102a and 102b of FIG. 2 comprises a stepwise computation that describes the effect of the drug on a physiopathological system (e.g. the physiopathological model), and is carried out by one or a few equations based on general scientific knowledge of pharmacology and physiology. The pharmacology model can comprise a first pharmacokinetic sub-model that computes the drug level in the relevant tissue (Ct) and a second pharmacodynamic sub-model that uses the Ct as input and describes the effect of the drug on one or more components (e.g. biological targets) of a physiopathological model. The pharmacodynamic sub-model may optionally take into account additional factors that may alter the effect of the drug on the disease mechanism and/or side effects; the model may optionally take into account one or a plurality of biomarkers (IO) indicative of the alteration of a biological system(s) caused by a drug. The final function(s) describing the effect of the drug on the disease mechanism and/or side effects is referred to as z. Running the formal therapeutic model will compute the likelihood of an event of interest and will produce a set of output information from such computation. The output information can then be used, e.g., to derive an Effect Model for a given alteration of a biological target.

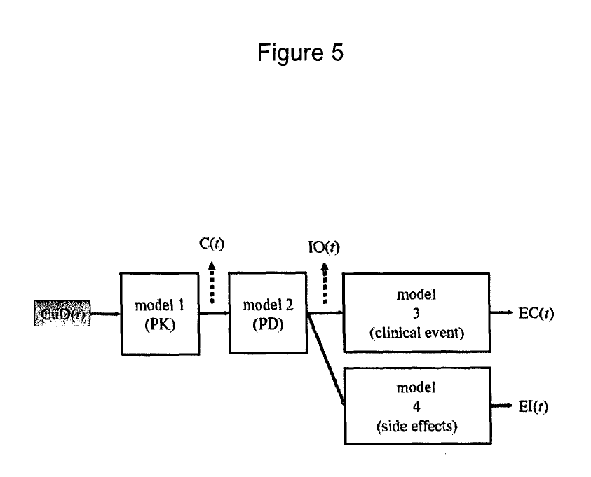

In an exemplary PK and PD sub-models of the Formal Therapeutic Model shown in FIG. 5, activities of a drug or any kind of treatment in the body can be split into four subsystems that can each be modelled separately. The unique system entry (input) is the drug administration with amount per dosing, timing of dosing, and cumulative amount. The outputs are the expected clinical effect and the side-effect(s). Between each subsystem one or more markers of drug activities in the body exist and are accessible to determination: the drug level in relevant fluid (C(t)) and an intermediary marker (biomarker) (IO(t) in FIG. 5). IO may be derived from the biological signal that mediates the drug's effect on the disease mechanism and/or in the mechanism of side-effects. However, in real medical practice IO is more often only correlated with a clinical outcome. Nevertheless, in the modelling process of FIG. 5, it is assumed that IO describes the drug's effect on the mechanism of the disease, that is, it is the signal that mediates the drug's mode of action. In such a case, and as given below, IO(t) is called z. Each subsystem can be modelled with a phenomenological approach or a mechanistic approach. The compartment modelling is an example of the former for the pharmacokinetic (PK) subsystem.

The Formal Therapeutic Model thus links “in silico” drug administration at a given dose to the end product (effect on clinical outcome), allows the amount of drug, the drug concentration in biological fluids, mostly the blood, and biomarker(s) of pharmacological activity and clinical effect following drug administration to be integrated in a single global model and computed.

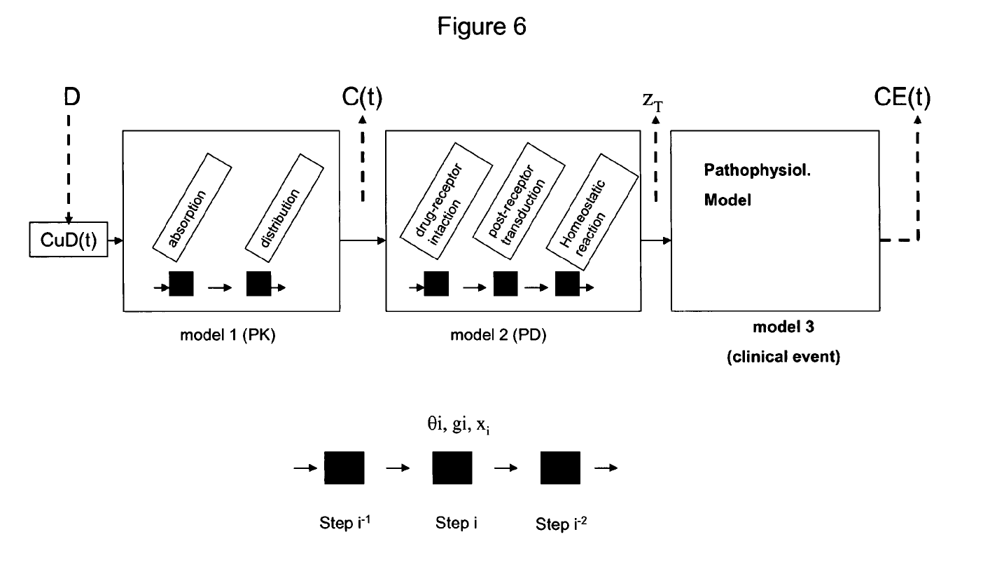

Each Formal Therapeutic Model can therefore be a cascade of sub-models addressing each step of the process that carries a drug's potential activity to an intermediate or final (e.g. clinical) detectable effect (FIG. 6). The sequence of steps and their contents can follow the Vengt-Pedersen scheme (Veng-Pedersen P and Modi NB (1992) J Pharm Sci; 81:925-34). In turn, each step can be broken-down into substeps. Each step i, or substep ij, is defined by an input, an output, a mathematical sub-model, which links the output to the input, scale parameter(s) θi, and a single polymorphism, which is expressed by Xᵢ. If a step is composed of substeps, there are as many X as substeps; they are noted as Xᵢⱼ, where j stands for the sub-step. The output of step i-1 is the input of step i. Hence in this simplified illustration the process is linear in the step domain (i.e., between the steps), although it is not linear within the steps. Optionally a more realistic model can be used that comprises feedback processes between two or more consecutive steps such that the overall process is no longer linear. As an example of how the steps can be structured, the case of drug distribution (step i-2) is detailed. The input from the previous step (absorption) is the amount of the drug that reaches the systemic circulation, A. Output is the average drug level in blood between two dosings, C_{avg}. The corresponding numerical sub-model is given by a classical pharmacokinetic equation:

$$Cavg = \frac{A}{T . ( 1 - {e}^{- {θ}_{22} {X}_{2}^{- 1}} ) . {θ}_{21}}$$

where T is the dosing interval, θ₂₁ and θ₂₂ are two model parameters, the latter being the maximum clearance. The patient variable is X₂, the age. The last step gives the modified value of z.

### 1.4 Simulated Population of Individuals

In certain embodiments of the invention such as certain methods for target evaluation, monitoring development, transposability studies and personalized medicine, a simulated population of individuals is used.

A simulated population of individuals, shown in blocks 103a to 103d of FIG. 2, is a virtual population, e.g. a group or collection of virtual individuals. A simulated population of individuals may or may not represent the population characteristics of a population of real subjects, such as a clinical population of interest. A simulated population of individuals can thus be referred to as a virtual realistic population where the population is built to represent a realistic sample of a population of interest. Such sample may represent, for example, a group of people in a particular region or country, that are covered by health payer, that are candidates for a particular treatment, that are in a particular age bracket, that have or are susceptible to a particular disease and/or that have a specified physiology and/or medical history, etc.

The virtual realistic population will thus typically have statistical properties or behaviors (e.g., mean, median, variance, dynamics, etc.) that approximate the statistical properties or behavior of a sample population of real subjects. Each individual in the population is associated with patient descriptors comprising individual parameter(s) and/or variable(s) (X) and one or more risk factor(s) (Y), the latter summarized in Rc, the risk of an event or outcome (e.g. the frequency of a undesirable health incident), wherein parameter(s)/variable(s) X is a vector of characteristics of individuals other than those included in Rc, and where X and Y may be environment-, phenotype- or genotype-derived variable(s). Variables can include, e.g., age, gender, race, any measurable or detectable variables, biomarker(s)), medical history-related information, symptoms, severity of disease, previous or concurrent treatments, etc. Examples of variables in cardiovascular disease include values for classical risk factors such as systolic (SBP) and diastolic blood pressure (DBP), total (TC) and high density lipoprotein cholesterol (HDL-C), diabetes (DM), smoking status, weight, height and serum creatinine. Patient descriptors in virtual populations can also come from model variables and parameters and may have only indirect biological relevance or reality. All patient descriptors in a virtual population are potential biomarkers.

A virtual realistic population can be constructed using data from representative observational studies and statistics from demographics information sources using the following general methodology used to generate the following population for a cardiovascular disease study. The number of virtual subjects was fixed to reproduce the structure in age and sex of French subjects between, e.g., 35 and 64 years, known from the “Institut National de la Statistique et des Etudes Economiques” (INSEE), France. Each subject of the virtual population was represented by a variable whose dimensions are individual—related features, such as age, gender, and other classical cardiovascular risk factors: systolic (SBP) and diastolic blood pressure (DBP), total (TC) and high density lipoprotein cholesterol (HDL-C), diabetes (DM), smoking status, weight, height and serum creatinine. Inputs for simulations were data summarized as means, standard deviations and quantiles, classified by sex and age categories, together with the covariance matrix of each class. The data collected related to the baseline characteristics of individuals not receiving anti-diabetics, cholesterol-lowering, or antihypertensive treatment. These characteristics are not independent; for instance, it is well known that blood pressure is related to diabetes and total cholesterol, within a same age category. After examining normality of raw variables and applying mathematical operations to convert them into a normal distribution when necessary, the covariates were take to follow a Multivariate Normal Distribution (MND). Algorithms based on the MND were used to generate SBP, DBP, TC, HDL-C, blood glucose, serum creatinine, weight and height. A uniform distribution was used to assign a random age to each virtual subject in the desired interval.

Additionally, where variables are not available from observations studies for the population to be represented such variables can be estimated from scientific data (e.g. publications). For example, in the foregoing example, left ventricular hypertrophy, useful as a cardiovascular risk factor in risk equations, is defined by tall R waves on ECG associated with abnormalities of repolarisation. Instead of taking the value from observation studies in the target population (here French), the information was taken from the INDANA database. The probability of having an ECG-LVH was expressed as a function of SBP, sex and age using a logistic regression, and the resulting equation was used to estimate the individual LVH probabilities in the simulated subjects. Diabetic subjects were those having random blood glucose levels of 1.26 g/l or above. Since smoking status did not present significant correlations with other covariates than age and sex; it was simulated by using a binomial distribution, where the probability of being smoker was represented by the smoking status prevalence in the original subjects of the same class. These variables, LVH, diabetes and smoking status were then dichotomised. In order for the covariate values to be biologically plausible, the simulated individuals with extreme covariates values beyond the limits of the real distributions are excluded.

Simulated populations of individuals can also be built to include totally sham individuals or partially sham individuals. In such a case, patient desciptors X and Y are defined by the model variables and parameters, the distribution and the covariance of which are built using all available knowledge on model constituent variability. In a totally sham individuals, a virtual individual is or is not characterised by variables that have not been or cannot be measured in real individuals. In partially sham individuals, each individual is characterised by a mix of sham and measured variables, among them possibly biomarkers, the distribution of which are obtained from real individuals. Sham variables from the set of variables and parameter in the physiopathological model can also be potential biomarkers.

Once a virtual realistic population is constructed, the consistency of the simulated individuals can be tested at a population level. For example, in the foregoing example, the predicted cardiovascular mortality rates in the virtual realistic population was compared to the ones declared in French statistics. The 10-year risk of fatal cardiovascular disease (CVD) was computed of each simulated individual. The 10-year predicted mortality rates were computed as the mean risk in each age-sex class by 100000 people. The life table method was used to extrapolate the latest available mortality rates from national statistics in order to obtain the 10-year estimated French mortality rates.

### 1.5 Patient Descriptors for Real Individuals

In personalized medicine embodiments of the invention, a patient descriptor(s) for a real individual is inputted, represented in Block 109 of FIG. 2. Patient descriptor(s) can comprise any individual parameters and/or variables describing an individual. The individual parameters and/or variables will typically include one or more risk factor(s) (Y) and parameters/variables being represented by X, where X and Y may be environment-, phenotype- or genotype-derived variable(s). Variables can include, e.g., age, gender, race, any measurable or detectable variables (e.g. biomarker(s)), medical history-related information, symptoms, severity of disease, previous or concurrent treatments, etc. Examples of variables in cardiovascular disease include values for classical risk factors such as systolic (SBP) and diastolic blood pressure (DBP), total (TC) and high density lipoprotein cholesterol (HDL-C), diabetes (DM), smoking status, weight, height and serum creatinine.

### 1.6 Optional Data Storage Components

The system of the invention can optionally comprise any number of data storage components. While inputs can be received from a data storage device and/or database external to the system, or otherwise received by use of a communication device from any other suitable source, or be inputted on an input device, it will be appreciated that data storage device and/or databases comprising input information can also form part of the system of the invention. Data storage device and/or databases may comprise, e.g., knowledge database containing information from scientific experimentation or publications, development database containing information from scientific experimentation on a drug (e.g. PK or PD data), clinical databases containing data from clinical use of a treatment, and/or patient descriptor database containing information about a patient (e.g. variables (X, Y), any other information). In one embodiment, the system includes a data storage device and/or database that comprises a plurality of treatments (T) wherein each treatment (T) is associated with an Effect Model.

1.7 Computing the Benefit from Treatment

Depending on the use made of the invention, different methods will be employed to compute the benefit from treatment using the aforementioned treatment inputs, inputs for an individual or population of individuals and Effect Model. Computing the benefit from treatment as a function of risk and X without treatment involves applying the Effect Model to an individual or simulated population of individuals. Depending on the particular application, computing the benefit from treatment may comprise but need not require summing the number of events. For example, the benefit from treatment can be outputted by indicating the probability (Rt) of presence or absence of occurrence of an event of interest for an individual or each individual in a population. In another example, e.g., when the benefit from treatment is to be displayed to a user in a personalized medicine method, the display may comprise a graphical output such as a graph having on one axis Rt and on another axis Rc. In other embodiments, the number of events averted by a treatment is summed up and outputted as a figure; such figures can be useful for purposes of comparison, such as in comparing benefit of alterations of different biological targets, comparing benefits of different treatment regimens for a drug.

1. Computing the BAtp

In personalized medicine embodiments, the method comprises a step of computing the benefit awaited from treatment (BAtp) for an individual patient shown in block 105e of FIG. 2 by applying the Effect Model to the inputted patient information. From the effect model one derives the function Rc−Rt which gives the expected benefit for an individual patient with treatment T, with Rc=f(Y) and Rt=g(Rc, X), Y and X being the patient descriptors bearing on the either one of the two or both processes, risk of event associated with the disease and intensity of the efficacy of the treatment. Thus Rc−Rt=h(Y, X). The effect model function is derived from clinical data (block 110 of FIG. 2) or is known from the application of the Formal Therapeutic Model of treatment T to the population from which the patient is drawn or its virtual realistic population (PVR), as shown by dashed lines above block 104d in FIG. 2. The values of patient descriptors Y and X are inputted in the function which in turn gives BAtp=Rc−Rt.

2. Computing the NEc

In certain embodiments of the invention such as certain methods for target evaluation or monitoring treatment where an unaltered physiopathological model is used, the method can comprise a step of computing the number of control events of interest observed in a simulated population of individuals that is not treated with the treatment, referred to as the number of events control (NEc). Block 105a of FIG. 2 shows the NEc. The step of computing the NEc is used from an unaltered physiopathological model. The corresponding number of events is obtained by summing up all through the virtual population the probability of occurrence of the event computed by applying the physiopathological model to each individual of the population.

The NEc is computed by applying the physiopathological model to each individual of a simulated population of individuals to compute the individual risk of an undesirable health event (Rc), summing up through all the individuals of the population and optionally extending to the parent population, in order to obtain the number of events caused by the disease of interest in the population. By sampling another virtual population made taking into account patient descriptor distributions, a confidence interval for the NEc is obtained. Any other method that accounts for model variability and parameter variability can be used similarly to compute the NEc confidence intervals.

3. Computing the NEA

In certain embodiments of the invention such as certain methods for target evaluation, the method can comprise a step of computing the number of events averted due to the alteration of a biological target(s) or other component of interest in a physiopathological model (NEA). Block 105b of FIG. 2 shows the NEA.

The NEA is computed in FIG. 2 by applying the effect model associated with the alteration of a target or a combination of targets, which can be derived from the physiopathological model as described above, to the simulated population of individuals or another simulated population of individuals with appropriate pattern, summing up through all the individuals of the population and optionally extending to the parent population in order to obtain the predicted number of averted events given the alteration of the biological target(s). The step thus permits computation of the number of averted events caused by the altered disease process (caused by the alteration of the biological target) of interest in the population. By sampling another virtual population made taking into account patient descriptor distributions, a confidence interval for the NEA is obtained. Any other method that accounts for model variability and parameter variability can be used similarly to compute the NEA confidence intervals.

4. Computing the NEAt

In certain embodiments of the invention such as certain methods for monitoring development or transposability studies, the method can comprise a step of computing the number of averted events due to the treatment of interest (NEAt). Block 105c and 105d of FIG. 2 shows the NEAt.

The NEAt is computed by applying the Effect Model associated with the treatment (e.g. drug in development), to the simulated population of individuals, summing up through all the individuals of the population to obtain the number of averted events expected from the treatment. In embodiments such as certain methods for monitoring development or transposability studies, the effect model is derived from the Formal Therapeutic Model as described above. In other embodiments such as transposability studies where clinical information is available for a treatment, the Effect Model is derived or updated from clinical data, as described above. The benefit from treatment as a function of the risk without treatment for a population or for an individual can then be outputted in any suitable manner and in any suitable form, including but not limited to outputting or transmitting to a data storage device, processor or display device. By sampling another virtual population made taking into account patient descriptor distributions, a confidence interval for the NEAt is obtained. Any other method that accounts for model variability and parameter variability can be used similarly to compute the NEAt confidence intervals.

### 1.8 Processes for Using the Treatment Benefit Predictions

The benefit from treatment as a function of the risk without treatment and variables (X) computed in the preceding section can be used in a variety of optional additional methods. The benefit from treatment computed in the preceding section can be outputted and used in the additional methods by a user, for example by communicating the benefit from treatment to a further system for carrying out an additional method. In other embodiments, any of the additional methods can form part of the system and carried out as further steps of the methods of the invention.

1. Target Evaluation Methods

Block 106a of FIG. 2 shows target evaluation methods. Target evaluation methods may comprise selecting a biological target or the combination of targets (or other component of a physiopathological model), the alteration of which leads to a benefit, generally where the number of events with the alteration is substantially smaller than without the alteration. In one example, a plurality of biological targets are evaluated; in such an embodiment, benefit is computed for a plurality of biological targets, and a biological target from said plurality is selected if its alteration gives rise to a benefit that is greater than the benefit from the alteration of another biological target of said plurality.

In one embodiment, target evaluation methods may comprise comparing the number of events for an alteration of a biological target or combination of targets (or other component of a physiopathological model) to the number of events using a known (e.g. marketed) treatment. Optionally, the method further comprises selecting a biological target the alteration of which gives rise to a benefit that is greater than the benefit from the known treatment.

In one embodiment, the method may comprise selecting a biological target or a combination of biological targets or other components which maximizes the number of averted events or which otherwise provides a benefit (additional averted events), optionally over a known treatment or drug target.

The methods can further comprise a step of drug selection, shown in Block 106b of FIG. 2. In this step, a drug, e.g., that mimics or causes, directly or indirectly, the alteration of the biological target or the combination of targets (or other component of a physiopathological model), is assessed. Such drugs may be known in scientific knowledge (e.g. literature), from experiments or from computer-implemented drug discovery or drug design methods. Optionally, the drug is a ligand of the aforementioned biological target(s). The step comprises selecting a drug having potential to alter the biological target or the combination of targets. The method may further comprise inputting pharmacology information for the selected drug into a formal therapeutic model; optionally the method further comprises monitoring development of the drug in a development monitoring method of the invention.

2. Development Monitoring Methods

Block 106c of FIG. 2 shows development monitoring methods. Monitoring development may be used at any or each step of the treatment development process by inputting results arising from the development of a treatment to the Formal Therapeutic Model such that the prediction of benefit for the treatment T can be assessed. Advantageously the prediction of benefit according to the invention can be repeated as results arise and are integrated into the model, and the prediction of benefit is thus updated. The methods are useful in optimizing decisions as to whether to proceed with development by updating the number of averted events given the cumulated evidence on treatment T. In another aspect, information obtained using the methods (e.g. influence of patient descriptors (e.g. biomarkers), disease parameters or treatment descriptors) on the benefit from treatment) can be used to design new experiments that investigate treatment effects, thereby reduce uncertainty as given by the confidence interval concerning the number of averted events.

3. Transposability Study Methods

Block 106d of FIG. 2 represents transposability study methods and biomarker evaluation methods. Exploring transposability of clinical trial results for treatment T, e.g. prior to marketing or testing of treatment T, involves assessing the population descriptors (patients' descriptors, e.g. variables Y and X) to determine and/or identify descriptors that can alter the Effect Model and/or the number of averted events. The assessment will typically also take into account the amount of alteration of the Effect Model and/or the number of averted events due to a given descriptor or a combination of descriptors. The methods can also be used to assess the benefit from a treatment T in a population different in characteristics or number from a first population for which information for a treatment T was used as an input.

4. Biomarker Evaluation Methods

Block 106d of FIG. 2 also represents biomarker identification and evaluation methods. Identifying or evaluating biomarkers for a treatment T involves assessing the population descriptors (patients' descriptors, e.g. variables Y and X) to determine and/or identify descriptors that determine the value or Rc and/or descriptors that for treatment T can alter the Effect Model and/or the number of averted events. The assessment will typically also take into account the amount of alteration of the Effect Model and/or the number of averted events due to a given descriptor or a combination of descriptors. The methods can thus be used to assess the influence of, or to identify, biomarkers that impact the benefit from a treatment T in a population that is the same or that differs in characteristics or number from a first population for which information for a treatment T was used as an input. The methods can also be used to assess the influence of or to identify biomarker predictive of disease (e.g. disease state, disease progression, etc.).

5. Personalized Medicine Methods

Block 106e of FIG. 2 shows personalized medicine methods based on the computation of BAtp, the predicted benefit with treatment (T) for an individual. BAtp is preferably provided together with its confidence interval. Personalizing medicine comprises predicting the benefit from one or preferably a plurality of available treatments based on treatment descriptors (e.g. dose, dosing-interval, galenic formulation, etc.) and patients' descriptors, i.e. variables X and risk factors Y. Preferably, the methods will indicate which one or more treatments are suitable for a patient. Advantageously, the methods will comprise ranking the treatments according to their predicted benefit, optionally further as a function of their cost and/or a risk of severe unwanted effects; benefits are optionally computed by integrating patient's X values and risk factor values into a Formal Therapeutic Model; a threshold for relevant benefit can optionally be computed by constraining the total population expenses, using the Effect Model generated from a Formal Therapeutic Model and the realistic virtual population.

In one embodiment, a personalized medicine method comprises predicting the benefit from a plurality of available treatments based on patient descriptors, i.e. variables X and risk factors, and selecting the treatment as suitable for a patient according to the predicted benefit as a function of cost (e.g. for a selected acceptable cost) and a similar risk of severe unwanted effects. Benefits are computed by integrating patient's X values and risk factor values into the Effect Models; a threshold for relevant benefit can be computed by constraining the total population expenses, using the Effect Model computed from clinical trial data or generated by the Formal Therapeutic Model and the realistic virtual population;

In one embodiment, a personalized medicine method comprises predicting the benefit from a plurality of available treatments based on patient descriptors, i.e. variables X and risk factors, and selecting a treatment as suitable for the patient according to the predicted benefit, optionally taking into account risk of severe unwanted effects; benefits are computed by integrating patient's X values and risk factor values into the Effect Models.

### 2.0 OUTPUT AND DISPLAYS

### 2.1 Example Output Approaches

The benefit from treatment as a function of the risk without treatment and variable X computed in the section titled “Computing the Benefit from Treatment” can then be outputted in any suitable manner and in any suitable form, including but not limited to outputting to a further computer system or to a display device.

Different forms of outputs and displays can correspond to different output requirements. For example, a healthcare payer may request output that includes the cost for not treating a patient and/or the cost saved by treating a patient. A healthcare payer may request output that compares benefits of different treatments, that shows thresholds S for which patients to treat given a constraint such as budget per treatment or disease. A healthcare payer or a pharmaceuticals developer may request output that includes and/or evaluates benefits of treatment in a simulated population of interest, or compares populations of interest. A researcher or pharmaceuticals developer who is evaluating biological targets for future targeting with a drug may request output that includes a ranked or unranked list of alterations, together with the NEA for each alteration or a biological or therapeutic target.

In one example, a ranked or unranked list of treatments can be returned, together with their number of events averted for each treatment in a population of individuals and optionally its confidence interval. In a second approach, a ranking method may be used. For example, treatments can be ranked according to the NEA or the cost per averted event or the size of the target population (i.e. the number of individuals above the threshold for a given budget). When applied to target or drug discovery methods, the output can include a ranked list of biological targets according to their NEA for example.

The receiver of the output, such as a physician, laboratory staff, researcher, drug developer or healthcare payer, may define the ranking method. The receiver then has an opportunity to determine a threshold point on the list that determines which individuals in the simulated population of individuals do or do not receive the treatment.

The output may be of any suitable type. Typically, alphanumeric outputs permits, e.g. number of events averted and/or a cost figure based on the number of events averted to be provided to a user, or an indication about whether or not to treat a patient. One example is shown in Table 2 herein, comparing treatments for hyperlipidemia in a realistic French population, displaying NSE, unit cost, relative risk, risk threshold, etc., for several statin drugs. The risk threshold S thus defines the population that has received each treatment in the population.

In one embodiment, patient descriptors used as inputs describe each of a plurality of individuals using the individual's age, gender, race, biomarkers, medications, and previous history. For each individual the methodology is used to compute outcomes (e.g. reduction in chance of a myocardial infarction), cost difference as a result of treatment, cost of treatment (e.g. the drug, tests, and visits), and cost of not treating (MIs, strokes, etc.). A ranking can be used to treat individuals who will receive the most improved outcomes per monetary unit spent. In an embodiment, individuals who receive the most improved outcomes per dollar spent are treated. Examples of medical interventions are, but are not limited to, blood pressure, glucose control, smoking, weight loss, blood test, and case management (e.g., for congestive heart failure.)

Examples of other approaches include displaying and/ranking according to a variable X, e.g. a prominent biomarker or patient descriptor, or a treatment descriptor that has an effect on the number of events averted.

Optionally, a simulated individual corresponding to an average (sham) patient is generated by averaging by any means patient descriptors through the virtual realistic population or a population of interest so as to illustrate patient descriptors associated with the size of the benefit where all the individuals of the population received the treatment.

Optionally, a user can run a simulation for a patient for a plurality of treatments T and in a graphical form display the benefit that the patient will receive for each of said plurality of treatments, compared to the outcome the patient will receive if not treated with any drug (or with a reference treatment). Such a display will illustrate the benefit that would be achieved for the patient for each treatment.

### 2.2 Example Graphical Display

In one embodiment, the benefit of a therapy for a population of interest can be presented as a graphical output. A user can run a simulation in a simulated population of individuals for a treatment T and show the benefit that would be achieved for this population by applying the methodology. Optionally, one or more individual patients can be represented and identified within the population so as to illustrate the benefit a patient will receive as compared to the population.

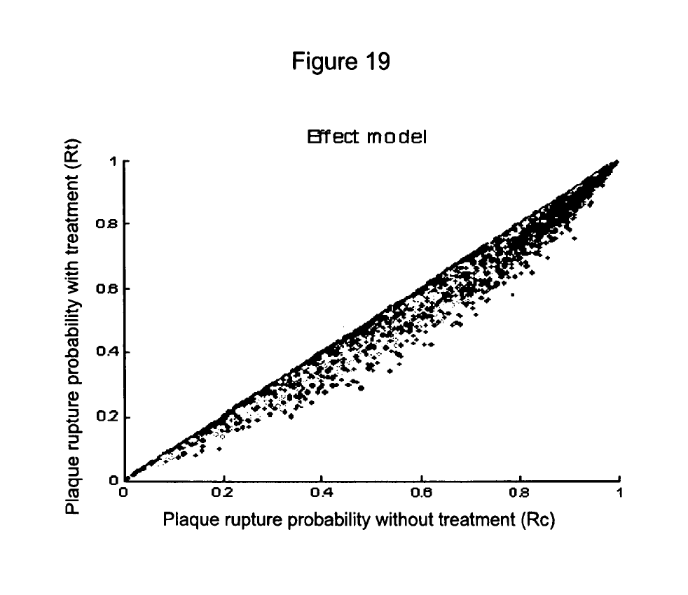

In one example, the benefit of the treatment in the population or for an individual patient is displayed as a scatter plot in a graph having an axis Rt and an axis Rc, as shown in FIG. 19 for benefit from treatment using ivrabradine. Graphical presentation of results in this manner is particularly effective because the two axes illustrate the quantitative effect of the treatment. The graphical display is also useful in personalized medicine for a physician and/or patient to illustrate where the patient falls within the population, e.g., whether the patient is within the group that has a higher benefit from treatment, or whether the patient is below the threshold S.

### 3.0 FUNCTIONAL OVERVIEW

### 3.1 Exploration of Transposability 1

The invention can be used to explore transposability of clinical results (e.g. clinical trials, from standard clinical practice) for a treatment T to a different patient population, e.g. prior to marketing treatment T in a population of individuals.

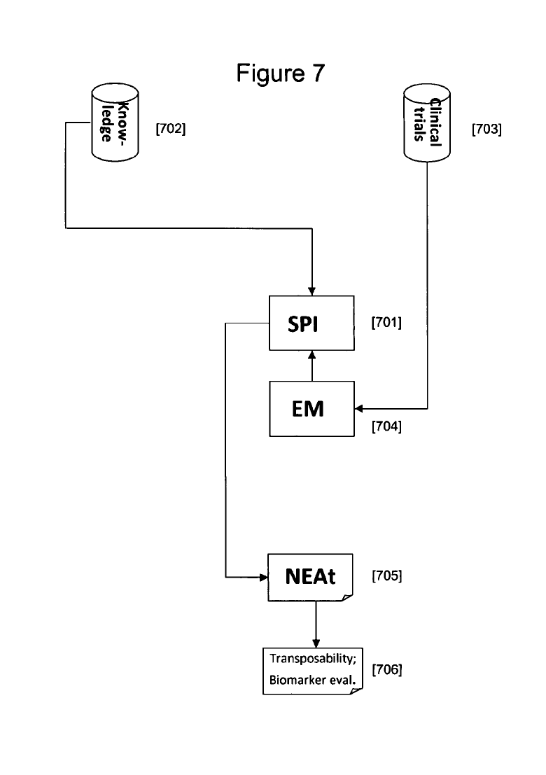

FIG. 7 illustrates such a method of assessing transposability according to the invention. In this embodiment, transposability of clinical results is assessed across a population of individuals. An Effect Model is generated that describes the benefit from treatment (Rc−Rt) with treatment (T) as a function of risk Rc (e.g., risk of occurrence of a health incident) and a variable (X). The benefit of treatment as a function of risk in a simulated population of individuals of interest is then computed, yielding a number of events averted (NEAt) for the population.

The benefit of treatment in the simulated population can then be outputted and for example displayed. The information can be used to evaluate the contribution of population descriptors (patients' parameters and variables X) on the effect model and/or the number of averted events. For example, a user can modify the population descriptors of the simulated population, recompute the NEAt, and assess whether the modification has an effect on the NEAt. In one embodiment, the system can be configured to compute and/or display the NEAt in multiple simulated populations of individuals such that the most appropriate simulated population of individuals can be identified by a user, or computed by the system and displayed.

This configuration also has the advantage that by transposing the benefit from treatment to a population of interest (e.g., the population within a national healthcare system, the population covered by a healthcare payer), the user can take into account the total resources (e.g. financial, quantities of medicinal product) available for treatment of the population, or more typically of the particular health condition within the population, or for the particular treatment within the particular population. The user can also take into account risk of severe side effects, for example. By dividing the resources among the population, the user can assess the threshold where the treatment loses its incremental benefit. The user can therefore set a threshold level of benefit (computed using individuals' parameter and variables X and risk factors) where treatment is no longer beneficial, e.g. compared to an alternative such as no treatment or an alternative treatment.

Block 701 represents a step of providing or generating a simulated population of individuals. The simulated population of individuals will be used in connection with the function generated in block 704 and it will be appreciated that block 701 can be placed either before or after block 704. Each individual in the population is associated with individual descriptors (X) and the risk factor(s) Y. The descriptors (X) and the risk factor(s) Y can be specified according to any manner in order to represent a population in which the treatment is to be assessed. Typically, the individual parameters (X) and the risk factor(s) Y are obtained from data available from prior studies 702 (e.g. from the scientific and medical literature, as may be provided by databases, etc.) about characteristics of a population of interest and are included in the Effect Model 704.

At block 704, clinical results are received and stored from a database of clinical results 703 and a function(s) is generated that describes the risk of an outcome of interest (e.g. the frequency of an undesirable health incident) as a function of individual parameters (X) and variables and risk factors (Y), for individuals in a population. The function is generated by using the clinical results received from 703 and comparing individuals who were or were not under treatment, and deriving a function that describes the number of occurrences of an event as a function of Rc and X. The resulting function estimates the effect model of the potential treatment, a function giving the benefit Rc−Rt=f(Rc, X) for each individual of a population.

At block 705, the number of occurrences of events averted in the simulated population of block 701 treated with the drug (NEAt) is summed up by applying, to the simulated population of individuals 701, the function generated in block 704 that describes the risk of an outcome of interest when an individual is treated with the drug, as a function of individual parameters (X) and variables and risk factors (Y), and summing up the number of events. The result is expressed as the number of occurrences of events in the simulated population (NEAt), computed using the formula NEAt=Σ(Rci−Rti).

An indicator of the benefit from treatment with the drug is displayed. Displaying to a user an indicator can comprise displaying the NEAt. An example of a display format is shown in Table 2.

Block 706 represents the optional further uses of the information to evaluate the contribution of population descriptors (patients' parameters and variables X and Y) on the effect model and/or the number of averted events. For example, a user can modify the population descriptors of the simulated population, recompute the NEAt, and assess whether the modification has an effect on the NEAt.

In one embodiment, the system can be configured to compute and/or display the NEAt in multiple simulated populations of individuals, e.g., such that most appropriate simulated population of individuals can be identified by a user, or computed by the system and displayed.

### Predicting the Number of Occurrences (Deaths) Averted by Statins in France

A simplified example of a transposability study was carried out as follows. The efficacy of different statins in preventing death was predicted in a population of simulated individuals using an effect model derived from clinical data obtained in patients from the U.S.A., Asia, U.K. and other countries. Few French patients were included. The goal of the study was to better identify the target population in France for statin treatment and to compare the efficiency of different statins.

A meta-analysis of 91 clinical trials identified in scientific literature relating to different statins was conducted. An Effect Model-based function was generated for each statin by regression that describes the benefit from treatment (Rt) with the drug as a function of risk factors Y aggregated in risk Rc (e.g., risk of mortality).

The benefit of treatment with the drug as a function of risk in a simulated population of individuals of interest was then computed using the effect model. The simulated population of individuals was constructed using parameters corresponding to the French population. The French virtual realistic population integrates known disease epidemiology for France and correlations between variables so as to provide a realistic representation of the French population as epidemiological information evolves. The number of events averted (NEA) for the population was computed using the formula:

$$NEE = {\int }_{s}^{1} g ( R c , x ) f ( Rc ) d Rc$$

where f(Rc) is the distribution of risk in the French population (in this case the simulated population that represents it), and s is the threshold above which resources (the healthcare budget for all statin drugs) are sufficient for individuals to be treated.

Based on the cost of each statin, and by applying an external constraint, in this case the financial resources attributed or attributable for cardiovascular prevention, the efficiency of the various statins can be ranked so as to identify the target population of individuals corresponding to each statin.

Results are shown in Table 2 below. The period of time considered for the study was one year. The healthcare budget for statins was 100 million euros per year. RR is the relative risk which summarises the effect model for the statins, which in this case was found to be a linear multiplicative model. The threshold s is defined by an iterative calculation such that the total cost of treatment corresponds to the healthcare budget. The cost per averted event (death) is also shown. Consequently, the efficacy of the statins can be assessed by taking into account the NEA and the cost saved per averted event.

TABLE 2

| | | | | | | Size of |
|---|---|---|---|---|---|---|
| | | | Risk | | Cost per | the tar- |
| | Unit | | thresh- | | averted | get pop- |
| Drug | cost [symbol] | RR | old “s” | NEA | event | ulation |
| statin K | 3 55.04 | 0.88 | 0.00505 | 262 +/− 12 | 382 245 | 282 076 |
| statin Y | 4 84.37 | 0.88 | 0.00568 | 214 +/− 12 | 465 036 | 205 458 |
| statin G | 159.07 | 0.72 | 0.00378 | 753 +/− 5 | 111 720 | 528 855 |
| statin M | 357.03 | 0.98 | 0.00506 | 33 +/− 21 | 3 034 993 | 280 522 |

### 3.2 Evaluation of Biomarkers 1

The invention can be used to identify and/or evaluate biomarkers, e.g. biomarkers of disease, e.g. biomarkers indicative of disease state, disease progression, etc., and/or biomarkers of treatment, e.g. biomarkers indicative of benefit from a treatment (T).

The system and method of evaluating or identifying biomarkers, in one embodiment, follows the general configuration shown in FIG. 7 discussed herein in the context of a method of assessing transposability.

Generally, biomarkers are evaluated by assessing the contribution of population descriptors (patients' parameters and variables) on the Effect Model and/or the number of averted events. Variables which modify the Effect Model and/or number of averted events may be designated as biomarkers, such as biomarkers of disease or biomarkers of benefit from treatment.

For example, the system and method generally comprise:

(a) providing one or a plurality of real or simulated treatments (T), wherein each treatment (T) is associated with an Effect Model function, e.g. by receiving the function together with a treatment identifier as an input or in a step of deriving the function from inputted information about a treatment, preferably where the function describes the benefit from treatment (Rc−Rt) as a function of risk without treatment (Rc) depending on a variable (Y), and a variable (X), wherein the variable (X) is a vector of characteristics of individuals other than the characteristics included in the risk without treatment (Rc), and where said variables (X) and (Y) may be environment-, phenotype- or genotype-derived variable(s);

(b) providing patient descriptors for one or more individuals (e.g. a simulated population of individuals), wherein each individual is associated with a risk (Rc) and a variable (X); and

(c) computing the benefit from treatment (Rc−Rt) for one or more of said treatment(s) T said individual(s).

The system may then output (e.g., displaying to a user) an indicator of the benefit from treatment (Rc−Rt) for said individual(s). The user can then assess variables for their effect on benefit from treatment (Rc−Rt) for one or more individuals. A variable associated with an indicator of the benefit from treatment can be designated a biomarker.

The computer-implemented system can alternatively be configured to assess biomarkers directly. In this configuration, the system may assess variables for their effect on benefit from treatment (Rc−Rt) for one or more individuals, and output an identifier corresponding to one or more variables, optionally together with an indicator of their effect on benefit from treatment, or according to any predefined criteria (e.g. a minimum effect, an effect relative to a threshold of benefit from treatment). A variable associated with an indicator of the benefit from treatment can be designated a biomarker.

Preferably, assessing variables for their effect on benefit from treatment (Rc−Rt) will comprises generating a population of individuals having different patient descriptors, wherein substantially all combination of descriptors and/or values thereof are represented, and determining which parameters are associated with an increased benefit from treatment.

In one embodiment, where the variable that affects the benefit from treatment is a second variable X, the biomarker is determined to be a biomarker indicative of response to the treatment (T).

In one embodiment, where the variable that affects the benefit from treatment is a second variable Y, the biomarker is determined to be a biomarker indicative of disease without (or independent of) treatment (T). For example the biomarker may be indicative of disease state, progression, severity, etc.

Optionally, the method further comprises conducting an assay to detect a biomarker in a biological sample from a patient, e.g. a real human. Such detecting step can be used to obtain data on values observed for the biomarker and integrated into the system and methods of the invention as patient descriptors. In another aspect, the detecting step can be to assess patients receiving the treatment (T). For example, a biomarker may be determined to be the presence of or level of a particular cellular or biological constituent (e.g. the presence of a gene polymorphism or allele; the level of a protein in a tissue), and an in vitro assay designed to detect such biological constituent is conducted in a biological sample obtained from a real patient.

As shown in FIG. 7, an Effect Model is generated that describes the benefit from treatment (Rc−Rt) with treatment (T) as a function of risk Rc (e.g., risk of occurrence of a health incident) and a variable (X). The benefit of treatment as a function of risk in a simulated population of individuals of interest is computed, yielding a number of events averted (NEAt) for the population. The benefit of treatment in the simulated population can then be outputted and for example displayed. The information can be used to assess variables by evaluating the contribution of population descriptors (patients' parameters and variables X) on the effect model and/or the number of averted events. The user can advantageously modify the population descriptors of the simulated (or real) population (or select only certain populations or members of a population having particular descriptors), recompute the NEAt, and assess whether the modification has an effect on the NEAt. For example, population descriptors that are included in variable X that result in an increase in NEAt for the population can be identified as biomarkers associated with a positive response to treatment (T). Those descriptors that are correlated with an effect on NEAt can be designated as biomarkers. When the biomarker is associated with variables Y, the biomarkers may be designated as a biomarker that is predictive of disease (e.g., disease state, progression, severity, etc.). When the biomarker is associated with variables X, the biomarkers may be designated as a biomarker that is predictive of response to treatment (T) (e.g., indicative of disease state following treatment, progression under treatment, severity or amelioration of symptoms or any other disease parameter under treatment, etc.). However, since Rc−Rt and the number of averted events NEAt is correlated with Rc, the biomarkers from Y are also predictive of patients that will be a responder to treatment.

Advantageously, such biomarker associated with variables X may be designated as a biomarker that is predictive of a patient that will be a responder to treatment (T). Optionally, the methods comprise determining or providing a threshold value of benefit from treatment (Rc−Rt), and assessing variables for their effect on the threshold of benefit from treatment (Rc−Rt) for said population. When the biomarker is associated with variables X, the biomarkers may be designated as a biomarker that is predictive of response to treatment (T). When the biomarker is associated with variables Y, the biomarkers may be designated as a biomarker that is predictive of response to treatment (T) and of disease state.

In one embodiment, the system can be configured to compute and/or display the benefit of treatment or NEAt in simulated populations of individuals such that the descriptors having significant effects on benefit of treatment can be identified by a user, or computed by the system and displayed. In one embodiment, such descriptors (i.e. biomarkers) are associated with an identifier (e.g. name of the gene or protein, etc.) and the identifier is outputted, preferably displayed.

Block 701 represents a step of providing or generating a simulated population of individuals. The simulated population of individuals will be used in connection with the function generated in block 704 and it will be appreciated that block 701 can be placed either before or after block 704. Each individual in the population is associated with individual descriptors (X) and the risk factor(s) Y. The descriptors (X) and the risk factor(s) Y can be specified according to any manner in order to represent a population in which the treatment is to be assessed. Typically, the individual parameters (X) and the risk factor(s) Y are obtained from data available from prior studies 702 (e.g. from the scientific and medical literature, as may be provided by databases, etc.) about characteristics of a population of interest and are included in the Effect Model 704.

At block 704, clinical results are received and stored from a database of clinical results 703 and a function(s) is generated that describes the risk of an outcome of interest (e.g. the frequency of an undesirable health incident) as a function of individual parameters (X) and variables and risk factors (Y), for individuals in a population. The function is generated by using the clinical results received from 703a and comparing individuals who were or were not under treatment, and deriving a function that describes the number of occurrences of an event as a function of Rc and X. The resulting function estimates the effect model of the potential treatment, a function giving the benefit Rc−Rt=f(Rc, X) for each individual of a population.

At block 705, the number of occurrences of events averted in the simulated population of block 701 treated with the drug (NEAt) is summed up by applying, to the simulated population of individuals 701, the function generated in block 704 that describes the risk of an outcome of interest when an individual is treated with the drug, as a function of individual parameters (X) and variables and risk factors (Y), and summing up the number of events. The result is expressed as the number of occurrences of events in the simulated population (NEAt), computed using the formula NEAt=Σ(Rci−Rti).

Block 706 represents evaluating the contribution of population descriptors (patients' parameters and variables X and Y) on the Effect Model and/or the number of averted events. For example, a user can modify the population descriptors of the simulated, recompute the NEAt, and assess whether the modification has an effect on the NEAt. In one embodiment, the system of the invention automatically modifies population descriptors and recomputes the benefit from treatment and outputs, preferably displays, an identifier for descriptors whose modification affects the benefit from treatment. The patient descriptors that impact on the NEAt can therefore be identified as biomarkers. Measurement of a biomarker can be of use in selecting a target population to be treated with the treatment (T), such as for example in a clinical trial.

### 3.3 Use of Physiopathological Models in Exploration of Transposability and Evaluation of Biomarkers

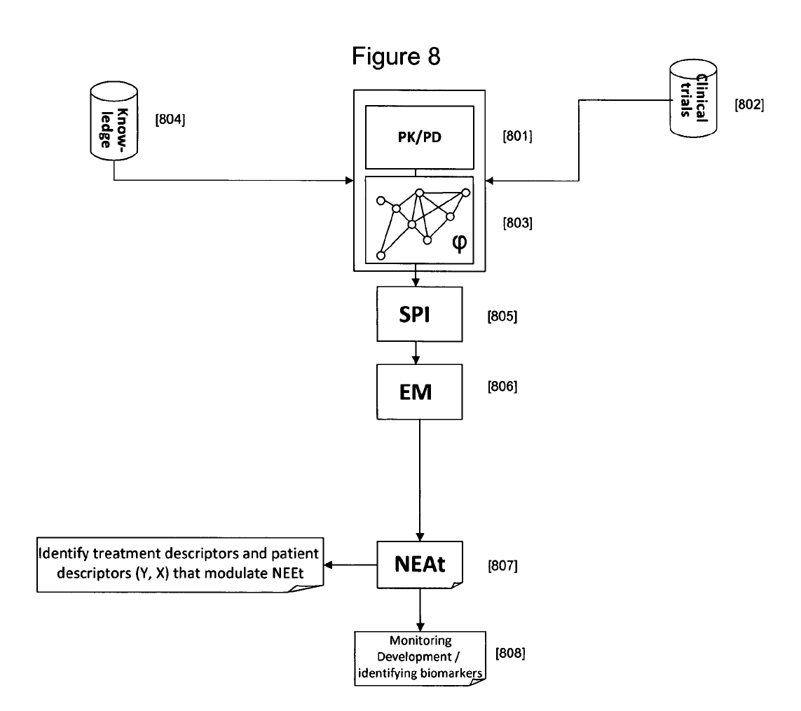

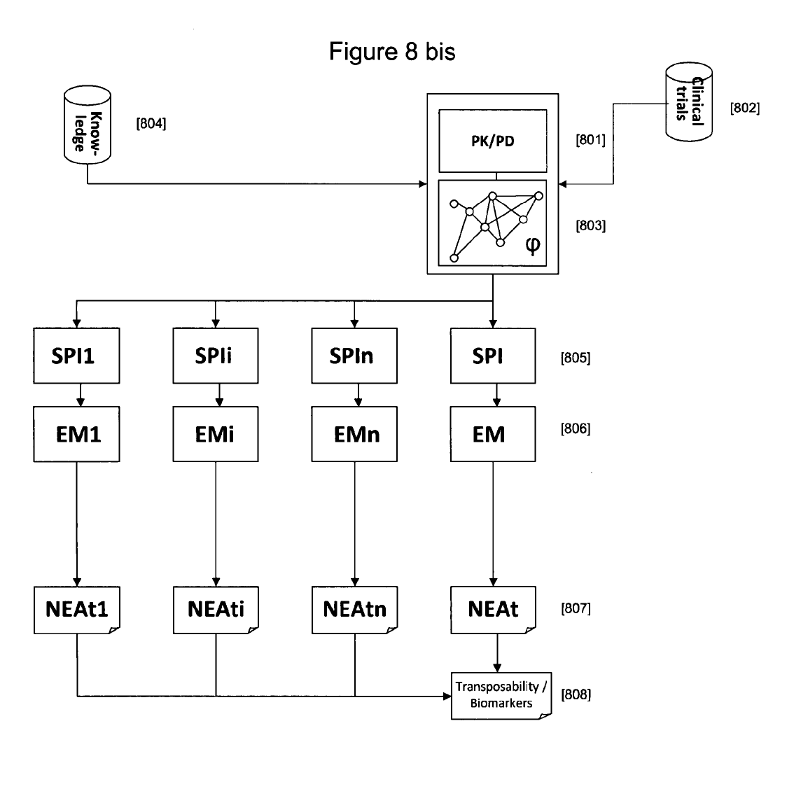

The invention can also be used to explore transposability of clinical results (e.g. clinical trials, from standard clinical practice) for a treatment T to a different patient population, e.g. prior to marketing treatment T in one population of individuals (FIG. 8) or in several populations (FIG. 8bis). The method can also be used to simulate a clinical trial. The method is useful to predict the benefit of treatment T in a target population, e.g. to determine whether the treatment is beneficial compared to no treatment or alternative treatments, to determine whether the treatment is cost effective, etc. The method can also be used to identify patient variables (descriptors) that can be used as biomarkers, as detailed in part (b).

(a) Transposability and Simulation of Trials

FIG. 8 illustrates a first method of assessing transposability according to the invention. In this embodiment of assessing transposability of clinical trial results across populations of individuals, results of trials run during preclinical and clinical development for a treatment of interest and a physiopathological model are used as inputs in a simulation of the in vivo pharmacology of the drug and the drug's effect on the physiopathological model (the formal therapeutic model), to arrive at a function that describes the drug's effect on an endpoint (e.g. number of occurrences of an event). It will be appreciated that in certain embodiments, either the clinical trial results or physiopathological model can be used as the sole source of the inputs separately, or may both serve as sources of inputs. The function describes the benefit from treatment with the drug as a function of risk Rc (e.g., risk of occurrence of a health incident) and a variable (X). The benefit of treatment with the drug as a function of patient descriptors in the virtual population is then computed for a simulated population of individuals of interest, yielding a number of events averted (NEAt) for the population. Outputs from simulations give the treatment and patient descriptors that modulate NEAt.

The benefit of treatment can then be displayed. The information can be used to evaluate the contribution of population descriptors (patients' parameters and variables X) on the Effect Model and/or the number of averted events. For example, a user can modify the individual descriptors of the simulated population, recompute the NEAt, and assess whether the modification has an effect on the NEAt.

In one embodiment, the system can be configured to compute and/or display the NEAt in multiple simulated populations of individuals such that the most appropriate simulated population of individuals can be identified by a user, or computed by the system and displayed (see FIG. 8 bis).

Inputs from available evidence on the drug, including drug exposure in animal models and humans 802, e.g. experimental results from a drug candidate, a drug that has been tested in a clinical trial, a marketed treatment, are received, stored and provided to a pharmacology model 801. Inputs will typically comprise information describing the drug administration with amount per dosing, timing of dosing, and cumulative amount, as well as pharmacokinetic and pharmacodynamic information for the drug observed in clinical use.

The pharmacology model 801 comprises a stepwise computation that describes the effect of a drug on a physiopathological system (e.g. the physiopathological model) as shown in FIG. 5. The final function(s) describing the effect of the drug on the disease mechanism and/or side effects is referred to as z, and is inputted to block 803.

Block 803 represents a step of providing or generating a physiopathological model, which itself has received data from a source of scientific information, and has typically been generated using experimental results such as from scientific publications stored in a database (block 804). The outputs from pharmacological model are processed in the physiopathological model, resulting in a Formal Therapeutic Model. The physiopathological model typically describes a disease mechanism. The physiopathological model is associated with and therefore provides individual parameters and/or variables and the risk factors. The risk factors are summarized in Rc, the risk of an outcome of interest (e.g. the frequency of a undesirable health incident). The individual parameters/variables are represented by Y and X, wherein Y and X are vectors of inter-individual variability. X therefore represents characteristics of individuals other than those included in Rc, and where X may be environment-, phenotype- or genotype-derived variable(s) whereas Y represent characteristics of individuals that are included in Rc and where Y, likewise, may be environment-, phenotype- or genotype-derived variable(s). The Formal Therapeutic Model will compute the likelihood that an event of interest will occur in an individual(s) having different factors Rc and X, where a simulated individual is treated with the drug.

Block 805 represents a step of providing or generating a simulated population of individuals. The simulated population of individuals will be used in connection with the function generated in block 806; consequently it will be appreciated that block 805 may be placed either before or after block 806. Each individual in the population is associated with individual parameters (X) and the risk factor(s) Rc. The parameters (X) and the risk factor(s) Rc are obtained from the physiopathological model 803.

Block 806 represents a step of generating a function(s) that describes the risk of an outcome of interest (e.g. the frequency of an undesirable health incident) as a function of individual parameters (X) and variables and risk factors (Y), for individuals in a population. The function is generated by using the outputs of the physiopathological model 803 and comparing the effects of the physiopathological model when the drug is not administered to the effects of the altered physiopathological model when the drug is administered in order to estimate the Effect Model of the potential treatment, a function giving the benefit Rc−Rt=f(Rc, X) for each individual of a population.

At block 807, the number of occurrences of events averted in the simulated population of block 805 treated with the drug (NEAt) is obtained by applying, to the simulated population of individuals 805, the function generated in block 806 that describes the risk of an outcome of interest when an individual is treated with the drug, as a function of individual parameters (X) and variables and risk factors (Y), and summing up. The result is expressed as the number of occurrences of events in the simulated population (NEAt). The NEAt can be computed using the formula NEAt=Σ(Rci−Rti). At block 808, an indicator of the benefit from treatment with the drug is outputted or displayed, e.g., displaying the NEAt.

The information can be used to evaluate the contribution of population descriptors (patients' parameters, including variables X) on the Effect Model and/or the number of averted events. For example, a user can modify the population descriptors of the simulated population, recompute the NEAt, and assess whether the modification has an effect on the NEAt. The patient descriptors that impact on the NEAt can therefore be identified as biomarkers, the measurement of which will help in selecting the target population.

(b) Biomarkers

FIG. 8 also provides a general process that can be used in methods of identifying and assessing biomarkers. As in part (a), results of trials run during preclinical and/or clinical development for a treatment of interest and a physiopathological model are used as inputs in a simulation of the in vivo pharmacology of the drug and the drug's effect on the physiopathological model (the formal therapeutic model), to arrive at a function that describes the drug's effect on an endpoint. The function describes the benefit from treatment with the drug as a function of risk Rc (e.g., risk of occurrence of a health incident) and a variable (X). The physiopathological model comprises components and/or interrelationships between components, which components or interrelationships represent patient descriptors (particularly the descriptors used as variables X and Y), and these descriptors are therefore candidate biomarkers. As the physiopathological model provides such descriptors, a simulated population of individuals is generated from the physiopathological model. The individuals in the population have different patient descriptors, and substantially all combinations of descriptors (e.g. with different values for a particular descriptor) are represented. The benefit of treatment with the drug as a function of patient descriptors in the virtual population is then computed for a simulated population of individuals of interest, yielding a benefit from treatment for each individual and/or number of events averted (NEAt) for the population. The system or a user can then identify parameters are associated with an increased benefit from treatment for an individual or a population (including a subpopulation).

The method can be carried out substantially as shown in blocks 801 to 804, as described in part (a). At block 805a simulated population of individuals is provided or generated from the physiopathological model. The physiopathological model (block 803) is applied to the simulated population of individuals, where the parameters of the physiopathological model are designated as variables X and Y. The individuals in the population have different patient descriptors, and substantially all combinations of descriptors (e.g. with different values for a particular descriptor) are represented. Block 806 is carried out substantially as in part (a).

At block 807, the a value Rc provides the outcome for each individual in the simulated population of block 805, obtained by applying, to the simulated population of individuals 805, the function generated in block 806 that describes the risk of an outcome of interest when an individual is treated with the drug, as a function of individual parameters (X) and variables and risk factors (Y). The patient descriptors that impact the Rc can be ranked and are identified as biomarkers. Biomarkers can then be used in any method where biomarkers are useful in research, medicinal product discovery, development for example in the measurement of which will help in selecting the target population, or more generally in predictive medicine.

### 3.4 Target Evaluation Methods

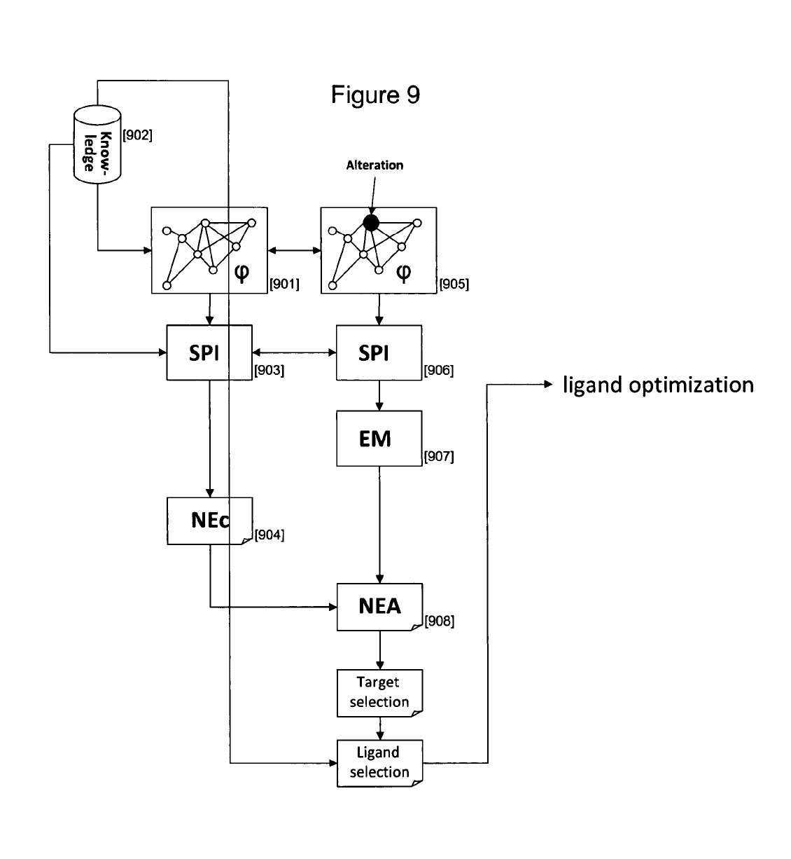

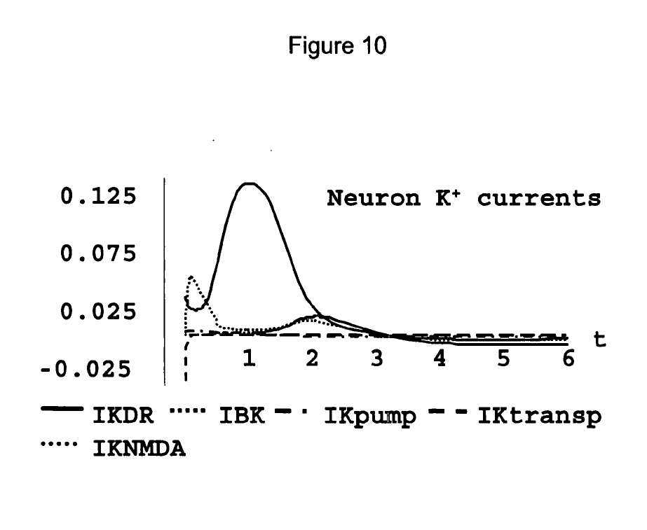

FIG. 9 illustrates a method of evaluating biological targets according to the invention. This method is also adapted to virtual drug screening in that each alteration of a target or any combination of targets can be considered as a drug, and for each drug the model can optionally further incorporate PK and PD parameters and models. In this embodiment, the invention makes use of inputs from a physiopathological model. The drug screening method involves carrying out two main simulations. In a first step, the physiopathological model provides information on risk Rc (e.g., risk of occurrence of a health incident) in a simulated biological system (e.g. a simulated individual, tissue, etc.) and on a variable (Y) that modulates Rc, and the number of events (e.g., number of occurrences of a health incident) is then determined in a simulated population of individuals. In a second step, the physiopathological model provides the benefit as a function of risk and a variable (X) when a biological target (e.g. a biological constituent) or phenomenological component of the disease model is modulated in a simulated biological system. The benefit as a function of risk and variable (X) in the virtual population is then computed for the alteration of the biological target, yielding a number of events for the population. Computing of the benefit of altering a biological target can be repeated for any number of biological targets in the physiopathological model. The benefit can be expressed for example as number of health events averted when the biological target is modulated, such that the targets can be compared for their ability to reduce the number of events, thus identifying targets having the greatest potential medical benefit.

At block 901, inputs are provided from a physiopathological model, in this case a simulated biological system, which itself has received or been generated using experimental results such as from scientific publications stored in a database (block 902). The simulated biological system is associated with patient descriptors (Y), the risk factors that describe the risk of an outcome of interest (e.g. the frequency of a undesirable health incident) and, possibly, some or all descriptors (X).

The physiopathological model will in a first step be used to establish the base risk in the simulated population in the absence of the alteration of a biological target in the physiopathological network which is to be evaluated. Consequently, the physiopathological model will typically be configured to provide inputs for a setting that will be representative of the true population to be treated. For example, the inputs may be representative of individuals that are not undergoing any therapy. In another embodiment, the inputs may be representative of individuals that are undergoing a standard therapy to which a hypothetical treatment that modulate the biological target to be evaluated would be added.

At block 903, inputs are provided from a simulated population of individuals. The input provides a simulated population of individuals where each individual in the population is associated with individual parameters (X) and the risk factor(s) Y.

At block 904, the number of occurrences of the health outcome of interest (e.g. the frequency of an undesirable health incident) is then computed for the simulated population of individuals of block 903. The number of occurrences will represent the control value which will be used to compare against the number of occurrences under a hypothetical treatment. The computation of the number of occurrences involves inputting the individual parameters (X) and variables and risk factors (Y) for the population and applying the function provided by the physiopathological model that describes the risk of an outcome of interest, and calculating the sum of occurrences, referred to as the number of events. The number of events, referred to as number of events control (NEc) can be computed using the formula: NEc=ΣRci

Optionally, in order to assess the accuracy of the computations, the NEc can be compared to data generated in real individuals. The assessment will generally be in a verification population of individuals for which individual parameters (X) and variables and risk factors (Y) are known. The verification population and simulated population will generally be as close in characteristics as possible, either by selecting data from a verification population that matches the simulated population, or by generating a simulated population that resembles the verification population. Optionally a step of adjusting parameters or structure of the physiopathological model is carried out such that the model's accuracy in predicted health occurrences is improved.

The evaluation of the benefit from altering one or more biological target(s) is initiated by simulating the alteration of one or more targets in the physiopathological model. At block 905, inputs are provided from the physiopathological model representing one or more alteration(s) of the biological network, the alteration(s) represented as a potential treatment T. There can be as many treatments T as there are targets to alter of or combinations of alterations of targets.

The physiopathological model may provide inputs for all or a subset of the biological targets represented in the physiopathological model such that the benefit of an alteration of all targets will be computed, or such that a user may subsequently select targets to be evaluated. Alternatively, a user may at this stage provide an input, via an input device, a selection of one or more targets in the physiopathological model for which an evaluation is to be conducted.

For each target, the physiopathological model provides information that can be used to compute the benefit as a function of risk and variable (X) in a population when the target is altered. Generally, for each alteration of a target, the physiopathological model associates individual parameters (X) and variables and risk factors (Y) that describe the risk of an outcome of interest (e.g. the frequency of a undesirable health incident).

At block 906, inputs are provided from a simulated population of individuals. The inputs comprise a simulated population of individuals, where each individual in the population is associated with individual parameters (X) and the risk factor(s) Rc.

At block 907, the benefit from altering each target is computed for the simulated population of individuals using the Effect Model. In this step, the function associated with each target that describes the benefit of altering the target as a function of risk factor(s) (Y), together with a vector of characteristics of individuals other than those included in Rc (variable X) is used to compute, for each target, the number of occurrences of the outcome of interest (e.g. the frequency of an undesirable health incident) in the simulated population of individuals of block 906. The individual parameters (X) and variables and risk factors (Y) for the simulated population are inputted in the function provided for each target. The output is the risk of event associated with alterating each target. The sum of occurrences are calculated, referred to as the number of events, using the formula NEtarget=IRtarget.

The number of occurrences of a health incident associated with the alteration of a target or the combination of targets is evaluated and compared to the number of occurrences when the target is not altered, here the NEc, thereby providing information as to whether the target has value for the development of treatments that modulated it. The evaluation will generally be carried out by conducting a computation that provides an evaluation of the target, or by outputting or displaying to a user the benefit from treatment in the simulated population (NEA). The function is the effect model associated with the alteration of the target.

At any appropriate stage the benefit as a function of risk and variable (X) can be outputted. Such output may comprise outputting (e.g. outputting and displaying, on a display device) the number of occurrences of a health incident when a target is altered such that a user may evaluate the target based on the number of occurrences of a health incident. In one example, the NEtarget is outputted; in one example the NEAtarget and the NEc are outputted; in one example the number of events averted (NEA) for a alteration of a biological target is outputted. The NEA provides the number of events averted when the target is altered compared to the NEc, according to the formula NEAtarget=Σ(Rc−Rtarget) (Block 908 of FIG. 9).

When evaluating the interest of a target's potential as a therapeutic target for the amelioration of an adverse health event in a disease, a alteration of a target associated with a number of occurrences of the health incident lower than the NEc will indicate that the alteration of the target may be beneficial to health and that the target has value as a target for therapeutic intervention. In one embodiment, the number of events averted (NEA) can be displayed for a target.

Optionally, targets can be selected or ranked based on one or more criteria, for example the number of occurrences of a health incident that are averted when the target is altered. In one example the method can further comprise computing, displaying and/selecting the target and/or combination of targets which maximizes the number of averted events.

Optionally the benefit of altering a target can be compared with the benefit from an existing treatment that modulates the same or a different target. In one example, the NEAtarget is compared with the number of events averted by known marketed treatments. The number of events averted by known and/or marketed treatments can be obtained as described herein, by generating an effect model, e.g. based on clinical data, and applying the effect model to the simulated population of individuals, and computing the number of events averted.

### Target Evaluation in Stroke

A simplified example of a target evaluation study is carried out as follows. More than 300 drugs having activity in animal models of acute cerebrovascular attack have been later found to lack activity or even have negative efficacy or toxic effects in human clinical trials. The model is used to evaluate different biological targets in order to predict whether their modulation would be beneficial in reducing the risk of stroke, and to compare predicted effects in rodents and humans.

A physiopathological model of the main early physiopathological mechanisms of acute cerebrovascular attack was constructed that integrates both phenomenological and mechanistic models and phenomenological models using general scientific knowledge. This model is a two-scale model and relies on a set of ordinary differential equations. We built two versions of this model (for human and rodent brains) differing in their white matter and glial cell proportions. The inputs to the physiopathological model include blood flow (degree of ischemia) and brain characteristics differentiating rats and humans. The outputs of the model was the ratio of Apparent Diffusion Coefficient of water (rADCw), the proportion of dead, penumbra or living cells (neurons and astrocytes), and the ionic concentration of ATP. The model was constructed using physical laws such as the conservation of energy, the electric current, and a broad review of the scientific literature on the mechanisms and consequences of cerebral ischemia. The basic methodology was to generate submodels and variable levels of integration depending on the submodel, the level of integration being determined by the immediate goals and thus subject to change during the process.

Stroke is a dynamic process in which the physiopathology occurs in overlapping stages over time, each stage having its own timescale ranging from microseconds to several weeks. At time 0, an interruption of blood flow occurs, cutting of oxygen supply and nutrients to brain cells and defining the start of ischemia. The overall stroke model was constructed to take into account the principal mechanisms in stroke. The results obtained below relate to the acute phase (3-6 first hours). During this period, ionic phenomena predominate and cells die essentially by necrosis due to the edema caused by the stop or slowing of ionic exchanges which are followed by an inflow of water into cells. The overall model is shown in FIG. 3. Integrated into this model is the submodel of ionic phenomena is shown in FIG. 4. These early processes determine a good part of the anatomical damage observed in brain imaging in humans, as well as acute and subacute mortality. The common pathway leading to cell death and tissue damage is edema, which can be detected by the biomarker rADCw, or coefficient of apparent diffusion of water, which can be observed by MRI. The ionic phenomena submodel therefore included various ion channels and describes ion exchange in cells, giving as output edema, expressed by rADCw.

Exemplary mathematical formulas for computing the ion submodel are as follows.

The variation of the quantity of ion in a compartment (e.g. cell(s) or sub-cellular structure(s)) is equal to the sum of the ionic flow across the membrane of this compartment plus the diffusion of the ions between subunits of the compartment:

$$\frac{\partial }{\partial t} ( {f}_{i} . {C}_{s , i} ) = - \frac{{s}_{i} . {n}_{i}}{{z}_{s} . F . v} \cdot {Σ}_{k} {I}_{s , i , k} - \frac{{α}_{s , i}}{v} . Δ {C}_{s , i}$$

(N_{s,i}: number of ion s in the compartment i; nᵢ: number of cells i in each subunit; J_{s,i,k}: flow of ions s across membranes of the compartment i; α_{s,i}: coefficient of diffusion of ions s in the compartment i between subunits, C_{s,i}: concentration of ions s in the compartment i)
Diffusion is calculated with a Laplacian equation:

$$Δ {C}_{s , i} ( t , x , y ) = \frac{{\partial }^{2} {C}_{s , i} ( t , x , y )}{\partial {x}^{2}} + \frac{{\partial }^{2} {C}_{s , i} ( t , x , y )}{\partial {y}^{2}} with {Σ}_{k} {J}_{s , i , k} = \frac{{s}_{i}}{{z}_{s} . F} \cdot {Σ}_{k} {I}_{s , i , k}$$

(sᵢ: surface of the membrane of compartment i; I_{s,i,k}: currents of ions s across the membrane of cell i; with transporter k by surface unit; zₛ: valence of ion s; F: Faraday constant)

The variation of the number of ions in the extracellular space is obtained by summing the flows of the ion across the neuronal and glial membranes. The equation is obtained from the law of conservation of matter for each ionic species.

$$\frac{\partial }{\partial t} ( ( 1 - {Σ}_{i} {f}_{i} ) . {C}_{s , e} ) = \frac{1}{{z}_{s} . F . v} \cdot {Σ}_{i} ( {s}_{i} . {n}_{i} . {Σ}_{k} {I}_{s , i , k} )$$

Delayed rectifier potassium channel (KDR):

$${I}_{KDR} = {10}^{- 3} {g}_{KDR} . {m}^{2} . h . ( {V}_{m} - {E}_{K} ) and meq = \frac{α ( {V}_{m} - 20 )}{α ( {V}_{m} - 20 ) + β ( {V}_{m} - 20 )} and heq = \frac{1}{1 + {e}^{( {V}_{m} + 25 ) \text{/} 4}} with α ( {V}_{m} ) = \frac{0.0047 . ( {V}_{m} + 12 )}{1 - {e}^{- ( {V}_{m} + 12 ) \text{/} 12}} and β ( {V}_{m} ) = {e}^{- ( {V}_{m} + 147 ) \text{/} 30}$$

High conductance voltage- and calcium-dependent potassium channels (BK):

$${I}_{BK} = {10}^{- 3} {g}_{BK} . m . ( {V}_{m} - {E}_{K} ) and meq = \frac{{250. [ {Ca}^{2 +} ]}_{i} . {e}^{{V}_{m} \text{/} 24}}{{250. [ {Ca}^{2 +} ]}_{i} . {e}^{{V}_{m} \text{/} 24} + 0.1 {e}^{- {V}_{m} \text{/} 24}}$$

Persistent sodium channel (NaP):

$${I}_{NaP} = {10}^{- 3} {g}_{NaP} . m . ( {V}_{m} - {E}_{Na} )$$

$$meq = \frac{α m}{α m + β m} with {α}_{m} = \frac{200}{1 + {e}^{- ( {V}_{m} - 18 ) \text{/} 16}} and {β}_{m} = \frac{25}{1 + {e}^{( {V}_{m} + 58 ) \text{/} 8}}$$

High-threshold calcium activated channel (CaHVA):

$${I}_{CaHVA} = {6.10}^{- 4} F ϕ . {g}_{CaHVA} . m . h . \frac{{[ {Ca}^{2 +} ]}_{i} - {[ {Ca}^{2 +} ]}_{e} . {e}^{( - 2 ϕ )}}{1 - {e}^{( - 2 ϕ )}} with ϕ = \frac{{FV}_{m}}{RT}$$

$$meq = \frac{α m}{α m + β m} with {α}_{m} = \frac{8.5}{1 + {e}^{- ( {V}_{m} - 8 ) \text{/} 12.5}} and {β}_{m} = \frac{35}{1 + {e}^{( {V}_{m} + 74 ) \text{/} 14.5}} et heq = \frac{{α}_{h}}{{α}_{h} + {β}_{h}} with {α}_{h} = \frac{0.0015}{1 + {e}^{( {V}_{m} + 29 ) \text{/} 8}} and {β}_{h} = \frac{0.0055}{1 + {e}^{- ( {V}_{m} + 23 ) \text{/} 8}}$$

Delayed entering current potassium channel (Kir):

$${I}_{Kir} = {10}^{- 3} {g}_{Kir} . m . ( \frac{{[ {K}^{+} ]}_{e}}{{[ {K}^{+} ]}_{e} + 13} ) . ( {V}_{m} - {E}_{K} ) and meq = \frac{1}{2 + {e}^{( 1.62 . ( F \text{/} ( RT ) ) . ( {V}_{m} - {E}_{K} ) )}}$$

The input to the submodel of FIG. 4 is ATP and five currents are simulated thereby representing the functioning of ion channels, pumps or potassium exchangers. Outputs allow the various variables of the model to be observed one at a time. One or more biological targets (i.e. ion channels, pumps or potassium exchangers) can be altered by decreasing their activity.

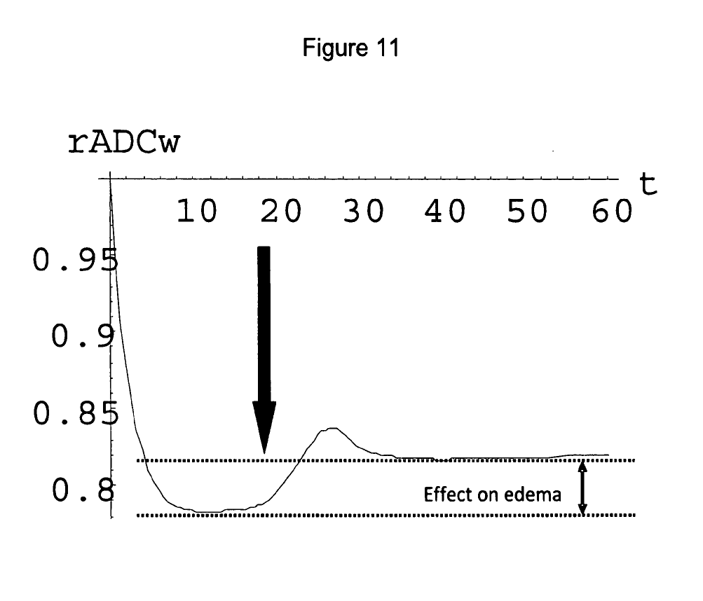

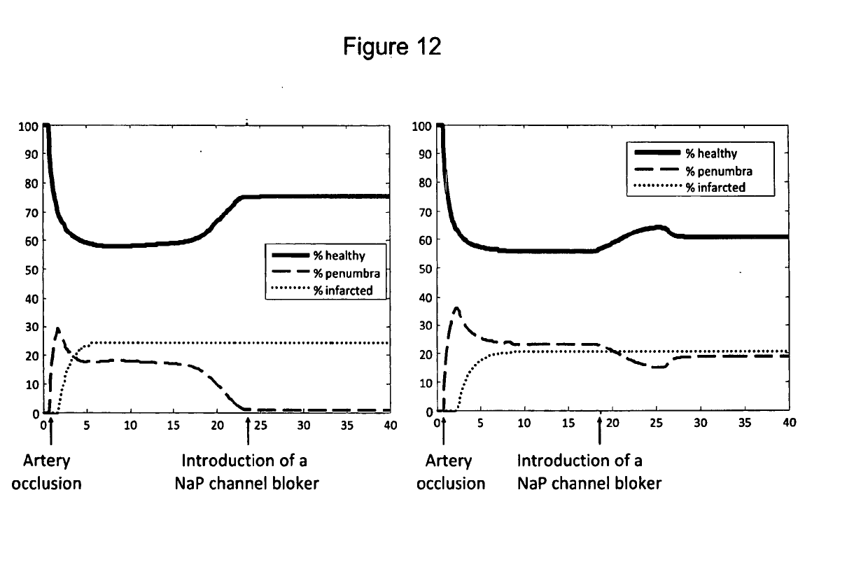

FIG. 11 shows an example where sodium channels (NaP) are blocked in the model; the figure shows the effect on edema (expressed as the rADCw value, typically a biomarker of brain cell death by edema) over time in minutes. It can be seen that blocking sodium channels has only a modest effect on edema and thus cell death. FIG. 12 shows the effect of blocking a sodium channel in humans and rodents, providing a potential explanation for drugs that are effective in rodents but not in humans; the figure shows three zones made up respectively of healthy cells (solid line), penumbra (dashed line) and infracted or dead (dotted line), for a 40 minute period following administration of a NaP blocker in rodents (left panel) and humans (right panel). The brains of rodents and humans differ by various characteristics including proportions of astrocytes and white matter; in rodents, penumbra recovery is about 95% but only 20% in humans.

This submodel can be further integrated into a more extensive physiopathological model that includes complementary submodels (FIG. 3) and cell death or other outcome, or can be used alone where edema is used as an event of interest. The model ran using different parameters for the variables (e.g. here blood flow (degree of ischemia) and brain characteristics differentiating rats and humans) together with the alteration of one or more of the ion channels, e.g. inactivating the channel, selecting an even of interest, and the effect model function is then generated from these data to predict the occurrence of the event of interest (e.g. edema, cell death). A simulated population of individuals is generated having different parameters for the variables blood flow and brain characteristics, i.e. to generate a population that include both humans and rats, and the NEc is determined by running the model with the simulated population of individuals and summing up the occurrences of the event of interest (e.g. meeting an rADCw threshold or infarcted area or volume threshold, or a certain infarcted area, or a clinical event such death or a remaining handicap). Rats are represented simply for purposes of comparison. The benefit from altering each ion channel target or combination thereof is then computed for the simulated population of individuals using the Effect Model, and the sum of occurrences of the event of interest is NEAcalculated (NEA). The NEc and NEA are compared for each alteration of an ion channel (i.e. computing the NEA); if the NEA is significantly lower than the NEc, and thus across individuals having human brain characteristics, it is predicted that a drug that blocks the one or more ion channels may have a benefit in the treatment of humans.

### 3.5 Monitoring Development

Monitoring development can involve any process where pharmacological information is received for a treatment (e.g. a drug) of interest and the user wishes to predict the benefit from such treatment.

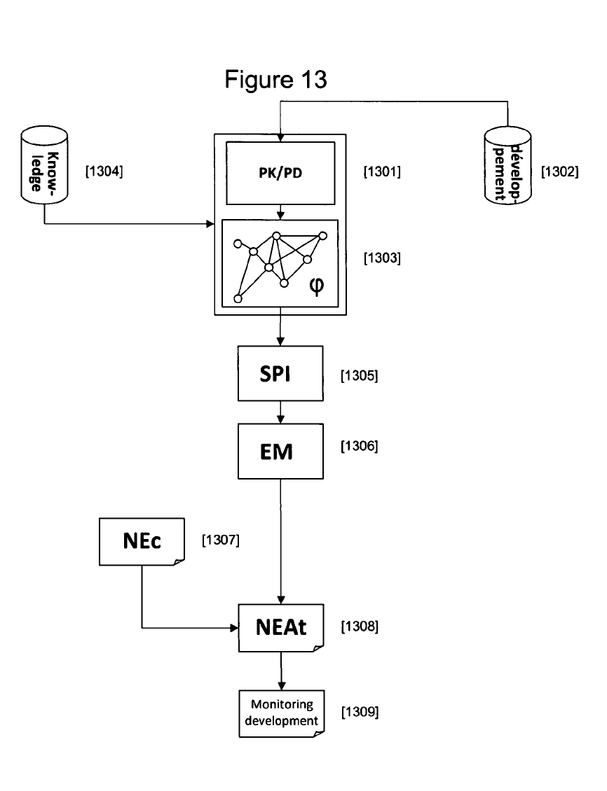

FIG. 13 illustrates a first method of monitoring drug development according to the invention. In this embodiment, the invention makes use of inputs from a physiopathological model and inputs from the development of a drug, e.g. experimental results from a drug candidate, a drug that has been tested in a clinical trial, a marketed treatment (i.e. a Formal Therapeutic Model that is updated with all available data on the treatment). The method involves carrying out, in a first step a simulation of the in vivo pharmacology of the drug and the drug's effect on the physiopathological model to arrive at a function that describes the drug's effect on an endpoint (e.g. number of occurrences of an event). The simulation will yield a function that describes the benefit from treatment (Rc−Rt) with the drug as a function of risk Rc (e.g., risk of occurrence of a health incident) and a variable (X). The benefit of treatment with the drug as a function of risk (e.g. variable Y) and variable X in the virtual population is then computed, yielding a number of events for the population. The number of events can be compared to the number of events that would be observed in the simulated population without treatment using the drug (NEc), and the number of events averted (NEAt) by treatment with the drug is computed. The benefit of modulating a biological target is displayed in any appropriate manner, e.g. displaying the NEAt in alphanumeric or graphical form. The user can also obtain additional information to design experiments; the method may thus comprise a step of identifying or ranking variables (X) or (Y) that induce uncertainty or variability in the NEA. A table or a graphical display paralleling ranges of uncertainty of all parameters in the formal therapeutic model with corresponding ranges of uncertainty of NEAt given by a simulation allows the identification of a parameter or a set of parameters the uncertainty of which brings the highest proportion of uncertainty in NEAt prediction. Another display shows instead of a mere range, prior distributions of formal therapeutic model parameters and corresponding prior distribution of NEEt. These prior distributions are actually posterior distributions following experiments performed at the end of the previous step in the drug development. At the current step, the forthcoming experiments can be designed so as to optimize the decrease in uncertainty in the NEAt prediction.

Inputs are provided to a pharmacology model (block 1301) from the development of a drug (block 1302), e.g. experimental results from a drug candidate, a drug that has been tested in a clinical trial, a marketed treatment. Inputs will typically comprise treatment descriptors such as amount per dosing, timing of dosing, and cumulative amount. Optionally, any available pharmacological or pharmacokinetic information can be inputted additionally.

The pharmacology model (1301) comprises a stepwise computation that describes the effect of the drug on a physiopathological system (e.g. the physiopathological model), as shown in FIG. 5. The final function(s) describing the effect of the drug on the disease mechanism and/or side effects is referred to as z, and is inputted into block (1303), a physiopathological model, which itself has received or been generated using experimental results (1304) such as from scientific publications stored in a database. The inputs from the pharmacological model are processed in the physiopathological model and thereby yield a signal that outputs a probability that the event occurs (e.g., whether or not an event occurs), as a function of parameters (X) and risk factors (Y).

At blocks 1305 inputs are provided from a simulated population of individuals. The inputs comprise a simulated population of individuals, where each individual in the population is associated with individual parameters (X) and the risk factor(s) (Y). The parameters (X) and the risk factor(s) are obtained from the physiopathological model (1303) or may be specified by a user from known information. At block 1306, an Effect Model is generated from the outputs of the model of block 1303

At block 1307, outputs from the physiopathological model of block 1303 are used to compute the base risk in the simulated population in the absence of the drug, expressed as the number of occurrences of events in the simulated population (NEc). Consequently, the physiopathological model will typically be configured to provide inputs for a setting that will be representative of the true population to be treated. For example, the inputs may be representative of individuals that are not undergoing any therapy. In another embodiment, the inputs may be representative of individuals that are undergoing a standard therapy to which the treatment T would be added.

At block 1308, the function generated in block 1306 is used to compute Rt for each individual of the simulated population and the Rt are summed up, expressed as the number of occurrences of events in the simulated population (NEt). The number of averted events with the treatment NEAt is computed either by applying the Effect Model function to sum up the number of occurrences of events using the function(s) from block 1306 that describes the risk of an outcome of interest (e.g. the frequency of a undesirable health incident) as a function of individual parameters (X) and variables and risk factors (Y), applied to the inputs from the simulated population of individuals 1305 or by comparing the (NEAt) to the (NEc).

At block 1309, an indicator of the benefit from treatment with the drug is displayed. Displaying to a user an indicator can comprise displaying, on a display device, the NEAt.

The displayed information can then be used by a user to gather information, e.g, by conducting experiments or to plan experiments that can be used to reduce uncertainty about the number of occurrences of events under treatment with the drug.

### Prediction of Drug Efficacy in Angina

### Methods

A simplified example of a monitoring development study was carried out as follows. The efficacy of a hypothetical cardiotonic drug that reduces heart rate in preventing angina pectoris attacks was predicted in a population of simulated individuals using a physiopathological model of angina pectoris. Angina is chest pain due to ischemia of the heart muscle, generally caused by obstruction or spasm of the coronary arteries. The goal of the example was to help a drug developer choose between once- or twice-daily dosing of the drug, to predict the dose-effect relationship of the drug in this pathology, and to provide an effect model of the drug as a function of the risk of occurrence of an angina pectoris attack.

A PK-PD model was combined with a phenomenological model of angina to provide as output parameter the occurrence of an angina pectoris attack at time t over a 24 hour period. Briefly, a PK-PD model for the drug was constructed using general scientific and medical knowledge for a model drug, e.g., scientific publications, including its biological target, here a potassium channel. PK and PD models were calibrated using data from clinical data from humans for a model drug, with two compartments and a compartment effect for the parent drug and its principal metabolite. The input was either one or several doses of drug, in each case at pharmacokinetic equilibrium. As the drug has a bradycardia-inducing effect, the output parameter of the PK-PD model was chosen to be heart rate (RR interval). The heart rate then served as the input parameter for the phenomenological model.

The phenomenological model was based on a discursive model, modelled using a series of functional equations starting from a published model of cardiac hemodynamics known as the Kappel and Peer model shown in Table 3 below. The coronary reserve (CR) calculated at each time t and compared to angina-genic threshold value for each case. The output was the occurrence of an angina pectoris attack at time t over a 24 hour period.

TABLE 3

| Description | Formula |
|---|---|
| Systolic pressure (SBP) was defined as a function | (HR): SBP(t) = 101.1 + 0.74*HR(t) |
| of the heart rate (HR) | |
| The contractility (S) of the left ventricle is also | S(t) = λ(S)*HR(t) |
| defined as a function of the heart rate | |
| The duration of the diastole in seconds (DD) was | DD(t) = (60/HR(t))^{0.5} *[(60/HR(t))^{0.5} − k] |
| expressed as a function of the heart rate using an | |
| empirical formula. | |
| The ventricular volume in mL (DV) | DV(t) = (Vr − C* PV) exp(DD(t)/C* R) − C* PV, |
| | where |
| | Vr = residual ventricular volume; |
| | C = compliance of the relaxed ventricle; |
| | R = total resistance caused by viscosity; |
| | PV = vein pressure |
| According to Starling's law, the ejected volume | SV(t) = S(t)*(DV(t)/SBP(t)) |
| (SV) at each systole is proportional to the final | |
| diastolic volume and inversely proportional to the | |
| systolic pressure. | |
| The non-pulsatile flow (Q) generated by the | Q(t) = HR(t)*SV(t) |
| ventricle is defined as the product of the heart rate | |
| and ejected volume. | |
| The coronary flow (QCOR) is a fraction of Q | QCOR(t) = a*Q(t) |
| The perfusion pressure (PP) across the coronary | PP(t) = (1.8*QCOR(t)/60*d⁴) + |
| stenosis is given by the formula | 6.1*(QCOR(t)²/3600*d⁴), |
| | where: |
| | d, the diameter in mm of light at the stenosis |
| | (patient descriptor) |
| The coronary reserve (CR) is given by the | CR(t) = 1 − (PP(t)/(SBP(t) − PV)) |
| formula | |

The simulated population of individuals was constructed using information on 1706 subjects for which a continuous heart rate measurement (RR interval) and arterial pressure measurement over 24 hours of a normal day were available in a database. Heart rates thus varied according to circadian rhythm, physical activity, etc. The real subjects were transformed into simulated individuals by associating with each individual a vector comprising new variables representing pharmacokinetic, pharmacodynamic and physiopathological characteristics. For example, variables included the two distribution volumes, the degree of coronary stenosis (d) and the anginogenic threshold (AT). The values obtained from the reconstituted distributions from data in the scientific literature were randomly attributed to the 1706 simulated individuals.

The Effect Model for the drug was generated by the Formal Therapeutic Model integrating the angina attack physiopathological model with for a model drug pharmacology model. The Formal Therapeutic Model applied to each individual of the simulated population. The Effect Model was then computed by applying a regression technique on clinical trial data obtained by simulating hundreds of clinical trials for each explored dose. For each trial, one group of patients was treated with one dose of drug, the other group by a placebo. The population from which simulated patients were randomly drawn was based on data from real subjects.

Compliance was assumed to be maximal although one can vary the compliance as any patient descriptor. The results outputted from the simulated clinical trials were stored and analyzed using standard statistical methods.

### Results

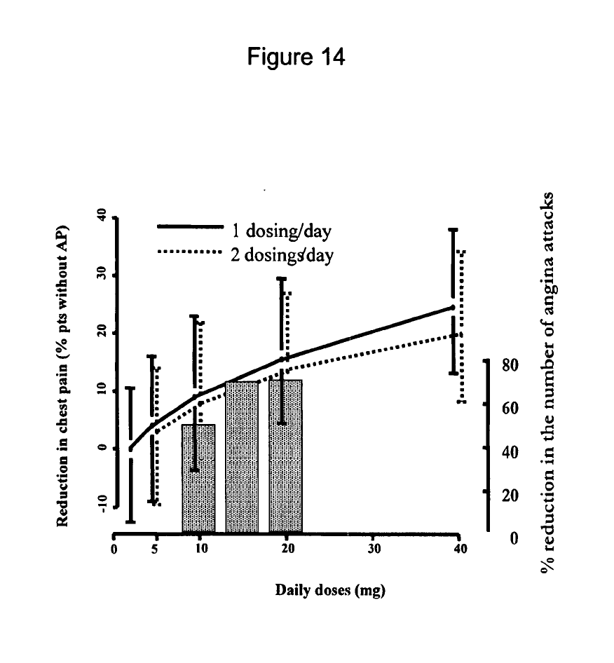

Dose-effect relationship on the number of angina attacks in 24 hours. Results are shown in FIG. 14. In simulating the clinical trials in the simulated population of individuals with different doses of drug according to two schemes (either one or two administrations per day), the dose effect relation (DER) was predicted, as shown in the lines (with confidence intervals) while the results from published the Phase II clinical trials from which clinical data was taken for hypothetical drug are shown in bars.

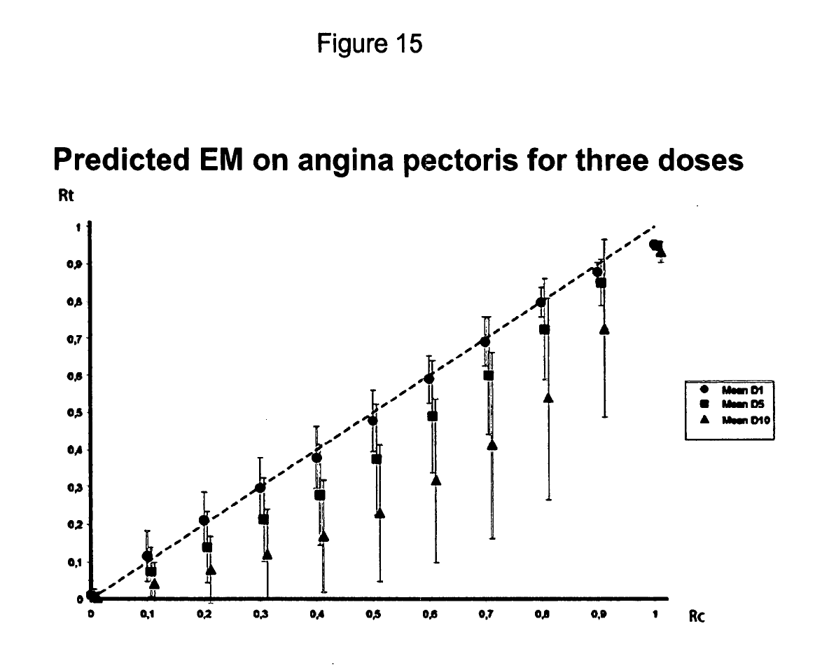

The Effect Model of three doses tested in silico. Results displayed are shown in FIG. 15. Each dose yielded an effect model representing the averages of the trials (ordered) by group of frequency for the subjects having at least one angina attack in the 24 hour period. As above, the confidence intervals are dependent upon the number of simulations. The three doses tested have different effect models. Results show that the benefit for an angina prone individual achieves maximum benefit (for patients of the group having a 60% chance of having an attack in the 24 hour period) and then diminishes until it is essentially absent for severe (high likelihood of an attack) patients.

### 3.6 Personalized Medicine 1

The invention can also be used in personalized medicine. The invention provides a method to predict and/or output whether a treatment will benefit a patient. The display is preferably in a graphic format generated by an effect model function that shows the benefit from treatment in a population of individuals (e.g. as provided by the function Rc−Rt=f(Rc, X)), and which indicates where within the population the patient lies based on his factors Rc and X. Such a display is a format which can be used advantageously to convey information to a user, e.g., a healthcare provider or payer, or patient, about the magnitude of the benefit that the patient is expected to experience from treatment.

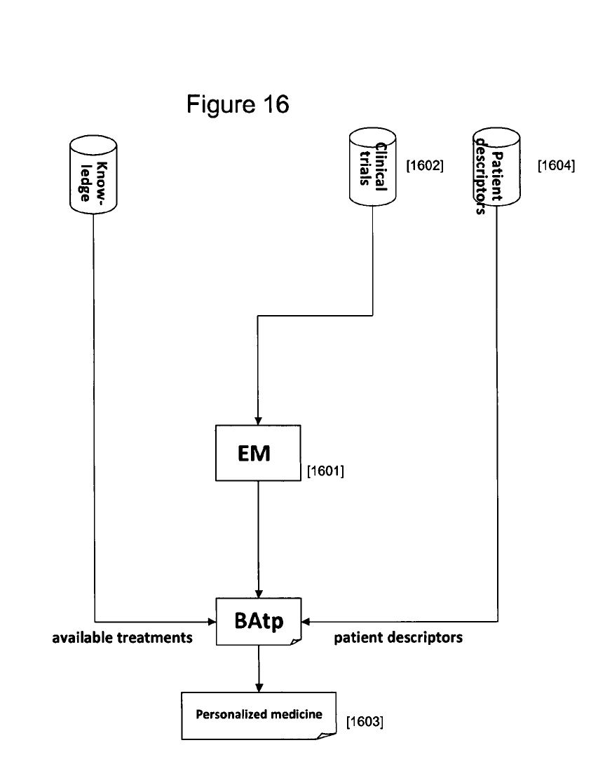

FIG. 16 illustrates a method for predicting the benefit of a treatment for a patient.

At block 1601, clinical results for a treatment of interest are received and stored in a database of clinical results (1602) and a function(s) is generated from the clinical results that describes, in treated and in untreated individuals, the risk of an outcome of interest (e.g. the frequency of a undesirable health incident) as a function of individual parameters (X) and risk factors (Y). The function estimates the Effect Model of the treatment and can be expressed as a function giving the benefit Rc−Rt=f(Rc, X) for each individual.

At block 1603, patient information 1604 is received, for example from a patient database or from an input device, and stored. The patient information will comprise patient descriptors for patients' individual parameters (X) and variables and risk factors (Y). Among X and Y are the biomarkers predicting treatment efficacy.

An indicator of the benefit from treatment for the patient is then outputted, preferably displayed on a display device, e.g. so that a user can visualize whether and/or to what extent the patient will benefit from the treatment. In one example, the display comprises a graphical display where the benefit is shown along with other information helping the user to make a decision. The patient can be located and identified as a point among the population of treated individuals.

In one embodiment, the process is carried out for a plurality of treatments. The method can further comprise selecting and/or displaying the treatment with the highest predicted benefit for the patient, or ranking and/or displaying a ranking of treatments according to their predicted benefit for the patient.

The predicted benefit can also integrate cost and a similar risk of severe unwanted effects; benefits are computed by integrating patient's X values and risk factor values into the effect models. Patients for whom the predicted benefit is over the threshold (or between two thresholds) are said to be responder to the treatment.

### 3.7 Personalized Medicine 2

In another personalized medicine configuration, the invention provides a method to predict and/or display to a user the benefit from treatment for a patient, preferably a real individual, where the treatment is transposed to a virtual realistic population of interest, e.g. the population to which the patient belongs, and where the benefit for a patient of interest is computed and an indicator of such benefit is displayed. The benefit from treatment for a patient is computed by integrating the patient's X values and risk factor values into the effect models. Optionally a threshold for relevant benefit can be computed by constraining the total population expenses and determining for which individuals there is the greatest difference between expense of treatment and benefit from treatment, where the benefit from treatment is computed using the effect model based on clinical trial data and transposed to the simulated population of individuals. Optionally, the method includes a step of determining and/or displaying whether the patient is above or below the threshold, or quantifying within or comparing with the benefit predicted for other members of the population from which the patient is drawn.

This configuration has the advantage that it allows the benefit to be predicted for a patient in the case where the clinical results available for a treatment were generated in a population that is different from the population to which the patient belongs, e.g., from a different geographic region or country, having a different ethnic origin, otherwise genetically different, or smaller in number such that information for certain values of Rc, risk factors Y and/or X is not available.

This configuration also has the advantage that by transposing the benefit from treatment to a population of interest (e.g., the population within a national healthcare system, the population covered by a healthcare payer), the user can take into account the total resources (e.g. financial) available for treatment of the population, or more typically of the particular health condition within the population, or for the particular treatment within the particular population. The user can also take into account risk of severe side effects, for example. By dividing the resources among the population, the user can assess the threshold where the treatment loses its incremental benefit. The user can therefore set a threshold level of benefit (computed using individuals' parameter and variables X and risk factors) where treatment is no longer beneficial, e.g. compared to an alternative such as no treatment or an alternative treatment. The personalized medicine configuration allows information for a patient of interest to be inputted and computes the benefit for a patient of interest; if the benefit is above a threshold that patient will be indicated to be suited for treatment with a particular treatment.

The display is optionally in a graphic format generated by an effect model function that shows the benefit from treatment in a population of individuals, and which indicates where within the population the patient lies based on his factors Rc and X. Such a display is a format which can be used advantageously to convey information to a user, e.g., a healthcare provider or patient, about the magnitude of the benefit that the patient is expected to experience from treatment. Other displays focus on the patient, without situating the patient in a population of individuals, are provided.

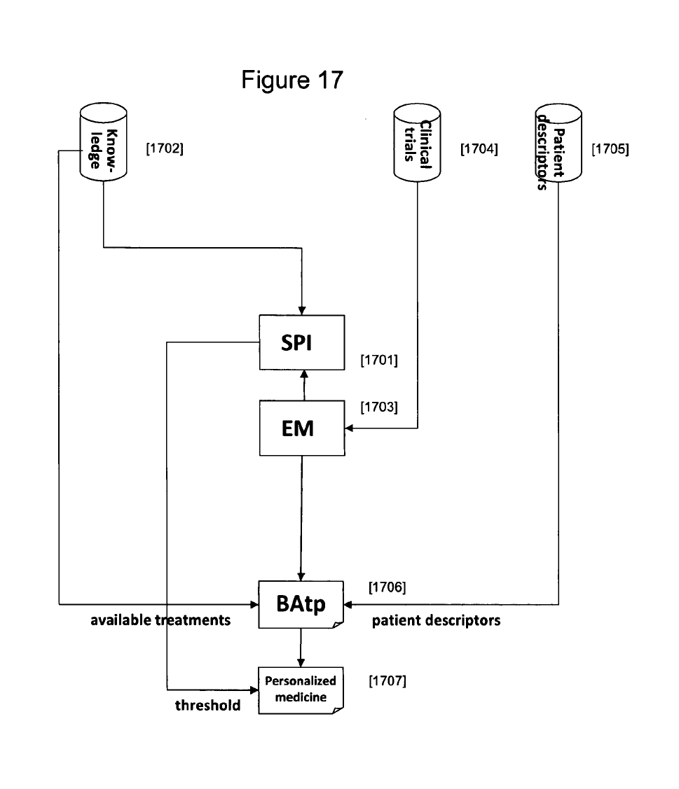

FIG. 17 illustrates a method for predicting the benefit of a treatment for a patient. Block 1701 represents a step of providing or generating a simulated population of individuals. The simulated population of individuals will be used in connection with the function generated in block 1703; consequently it will be appreciated that block 1701 can be placed after block 1703. Each individual in the population is associated with individual parameters (X) and the risk factor(s) Rc. The parameters (X) and the risk factor(s) Rc for the population can be received and obtained from any suitable source, for example from known information about a population of interest 1702, as may be stored in a database or as received from an external source or inputted using an input device. Among X and Y are the biomarkers predictive of treatment efficacy. An external constraint such as the amount of available resources assigned to the disease in a health plan permits to compute a threshold for the benefit in individuals in the population of interest.

At block 1703, clinical results for a treatment of interest are received and stored in a database of clinical results 1704 and an Effect Model is generated from the clinical results that describes, in treated individuals, the risk of an outcome of interest (e.g. the frequency of a undesirable health incident) as a function of individual parameters (X) and variables and risk. The function estimates the effect model the treatment and can be expressed as a function giving the benefit Rc−Rt=f(Rc, X) for each individual.

At block 1705 patient descriptors comprising individual parameters (X) and/or variables and risk factors (Y) is received, and at block 1706, the benefit awaited from treatment for the patient (BAtp) is computed by applying the function generated in block 1702 to the patients' individual parameters (X) and variables and risk factors (Y). An indicator of the benefit from treatment can then be outputted or displayed.

An indicator of the benefit from treatment for the patient is then outputted, preferably displayed on a display device, e.g. so that a user can assess whether and/or to what extent the patient will benefit from the treatment. In one example, the display comprises a graphical display (e.g. as a scatter plot including Rc and Rt) and the patient is located and identified as a point among the population of treated individuals. The threshold value can be displayed along with the sizes of the benefit and Rc for this individual.

In one embodiment, the process is carried out for a plurality of treatments. At block 1707, the benefit from treatment computed in block 1706 can be used in personalized medicine. The method can further comprise steps of selecting and/or displaying the treatment with the highest predicted benefit for the patient, or ranking and/or displaying a ranking of treatments according to their predicted benefit for the patient.

In one embodiment, personalizing medicine comprises selecting the treatment as suitable for the patient if the patient is predicted to have a benefit from treatment, e.g. above a threshold of benefit, or selecting among a plurality of treatments for which the benefit is computed in block 1706 with the best predicted benefit. Additionally, where factors such as cost of treatment and a risk of severe unwanted effects are incorporated, the selection can be made based on a threshold generated by incorporating cost of treatment and risk of severe unwanted effects. Patients for whom the predicted benefit is over the threshold (or between two thresholds) are said to be responder to the treatment.

### 3.8 Personalized Medicine 3

In another personalized medicine configuration, the invention provides a method to predict and/or display to a user the benefit from a treatment for a patient, for which treatment clinical results and pharmacological information are available.

In this embodiment, the method involves carrying out a simulation of the in vivo pharmacology of the treament's effect on the physiopathological model, i.e. in a Formal Therapeutic Model, to arrive at a function that describes the modified treatment's effect on an endpoint (e.g. number of occurrences of an event). The Formal Therapeutic Model (FTM) results in a point estimate of the Effect Model for this patient, i.e. the predicted benefit. Optionally, the effect model can be updated with data from clinical trials with the treatment. Running the FTM will yield a function that describes the benefit from treatment (Rc−Rt) as a function of risk Rc (e.g., risk of occurrence of a health incident), a variable (X) and treatment descriptors. In a second step, clinical results from a referenced treatment are received and a function that describes the referenced treatment's effect on the endpoint is generated. The function for the treatment is applied to a simulated population of individuals to determine the benefit as a function of risk Rc, variables X and treatment descriptors. Patient information is then received and integrated into the physiopathological model, and the benefit for the patient of each treatment is determined and optionally an indicator of benefit is displayed.

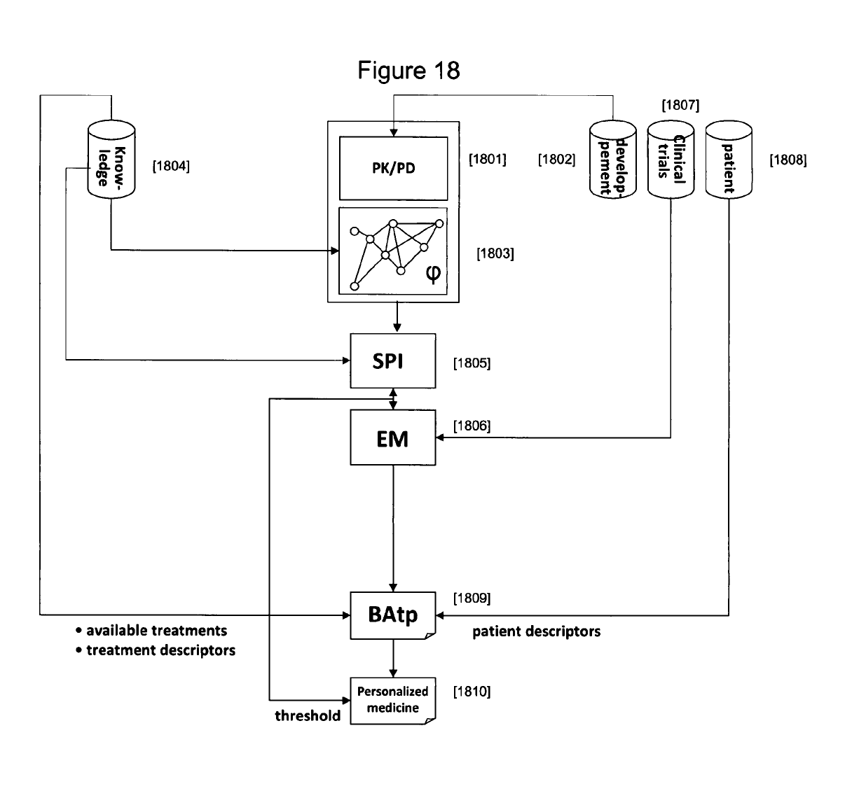

FIG. 18 illustrates a method for predicting the benefit of a treatment for a patient.

Inputs are provided to a pharmacology model (1801) from the development of a treatment (1802), e.g. experimental results from a drug candidate, a drug that has been tested in a clinical trial, a marketed treatment. Inputs will typically comprise information describing the drug administration with amount per dosing, timing of dosing, and cumulative amount. Optionally, any available pharmacological or pharmacokinetic information can be inputted additionally.

The pharmacology model (1801) comprises a stepwise computation that describes the effect of the drug on a physiopathological system as shown in FIG. 5. The final function(s) describing the effect of the drug on the disease mechanism and/or side effects is referred to as z, and is inputted into block (1803), a physiopathological model, which itself has received or been generated using scientific knowledge (1804) such as from scientific publications stored in a database. The inputs from pharmacological model are processed in the physiopathological model and outputs the likelihood of whether or not an event occurs, as a function of parameters (X) and/or variables and risk factors (Y).

Block (1805) represents a step of providing or generating a simulated population of individuals. The simulated population of individuals will be used in connection with the function generated in block (1806); consequently it will be appreciated that block 1805 is placed after or before block 1806. Each individual in the population is associated with individual parameters (X) and the risk factor(s) Rc. The parameters (X) and the risk factor(s) Rc can be specified according to any manner in order to represent a population in which the treatment is to be assessed. Typically, the individual parameters (X) and the risk factor(s) Rc are obtained from data available from scientific knowledge (1804) (e.g. from the scientific and medical literature, as may be provided by databases, experimentation, etc.) about characteristics of a population of interest. Among X and Y are the biomarkers predictive of treatment efficacy.

At block 1806, clinical results are received e.g. from a database of clinical results (1807), and a function(s) is generated that describes the risk of an outcome of interest as a function of individual parameters (X) and variables and risk factors (Y), for individuals in a population. By comparing the effects of the physiopathological model to the effects of the Formal Therapeutic Model (i.e. with the treatment) 1801 and 1803 an Effect Model is generated from which is derived giving the benefit Rc−Rt=f(Rc, X) for each individual. Optionally, this function may be altered, if deemed necessary by the effect model derived from clinical trials and other clinical uses of the treatment. In that case, the final function, adjusted according to the empirical effect model, is used to predict patient benefit.

At block 1809 patient information (1808) comprising individual parameters (X) and/or variables and risk factors (Y) and treatment descriptors is received. The benefit awaited from treatment for the patient (BAtp) is computed by applying the function generated in block 1806 and to the patients' individual parameters (X) and variables and risk factors (Y). An indicator of the benefit from treatment can then be outputted or displayed. Treatment descriptors such as dose, interval between intakes can be changed to find the treatment descriptor set which maximises the benefit and minimizes the risk of unwanted effects.

An indicator of the benefit from treatment for the patient is then outputted, preferably displayed on a display device, e.g. so that a user can visualize whether and/or to what extent the patient will benefit from the treatment. In one example, the display comprises a graphical display where BAtp is shown and the patient is located and identified as a point among the population of treated individuals for various treatments and treatment descriptors. Treatments can be combinations of various medicines.

At block 810, the benefit from treatment computed in block 1809 can be used in personalized medicine. In one embodiment, personalizing medicine comprises selecting the treatment as suitable for the patient if the patient is predicted to have a benefit from treatment, e.g. above a threshold of benefit, or selecting among a plurality of treatments for which the benefit is computed in block 1809 with the best predicted benefit. Additionally, where factors such as cost of treatment and a risk of severe unwanted effects are incorporated, the selection can be made based on a threshold generated by incorporating cost of treatment and risk of severe unwanted effects. Patients for whom the predicted benefit is over the threshold (or between two thresholds) are said to be responder to the treatment.

### 4.0 Implementation Mechanics—Hardware Overview

Aspects of the invention may be described in the general context of computer-executable instructions, such as program modules, being executed by a computer. Generally, program modules include routines, programs, objects, components, data structures, etc., that perform particular tasks or implement particular abstract data types. Such program modules can be implemented with hardware components, software components, or a combination thereof. Moreover, those skilled in the art will appreciate that the invention can be practiced with a variety of computer-system configurations, including multiprocessor systems, microprocessor-based or programmable-consumer electronics, minicomputers, mainframe computers, and the like. Any number of computer-systems and computer networks are acceptable for use with the present invention, including but not limited to smartphones or other handheld devices.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention can be practiced without these specific details. Computer systems, servers, work stations, and other machines can be connected to one another across a communication medium including, for example, a network or networks.

As one skilled in the art will appreciate, embodiments of the present invention can be embodied as, among other things: a method, system, or computer-program product. Accordingly, the embodiments can take the form of a hardware embodiment, a software embodiment, or an embodiment combining software and hardware. In an embodiment, the present invention takes the form of a computer-program product that includes computer-useable instructions embodied on one or more computer-readable media. Methods, data structures, interfaces, and other aspects of the invention described above can be embodied in such acomputer-program product.

Computer-readable media include both volatile and non-volatile media, removable and non-removable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. In an embodiment, non-transitory media are used.

The invention can be practiced in distributed-computing environments where tasks are performed by remote-processing devices that are linked through a communications network or other communication medium. In a distributed-computing environment, program modules can be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention can be practiced in a network environment such as a communications network. Such networks are widely used to connect various types of network elements, such as routers, servers, gateways, and so forth. Further, the invention can be practiced in a multi-network environment having various, connected public and/or private networks.

Communication between network elements can be wireless or wireline (wired). As will be appreciated by those skilled in the art, communication networks can take several different forms and can use several different communication protocols.

Embodiments of the subject invention can be embodied in an outcome processing system. Components of the outcome processing system can be housed on a single computer or distributed across a network as is known in the art. For example, in systems that employ a physiopathological model or a Formal Therapeutic Model, such models can be configured as separate, associated, subsystems or modules, e.g. that can be run independently and/or can be housed on a different computer from the computer that computes benefit from treatment. Similarly, the generation of a simulated population of individuals can be configured as a separate, associated, subsystem. In an embodiment, components of the outcome processing system are distributed on computer-readable media.

In an embodiment, a user can access the outcome processing system via a client device. In an embodiment, some of the functions or the outcome processing system can be stored and/or executed on such a device. Such devices can take any of a variety of forms. By way of example, a client device may be a desktop or laptop computer, a personal digital assistant (PDA), an MP3 player, a communication device such as a telephone, pager, email reader, or text messaging device, or any combination of these or other devices.

In an embodiment, a client device can connect to the outcome processing system via a network. As discussed above, the client device may communicate with the network using various access technologies, both wireless and wireline. Moreover, the client device may include one or more input and output interfaces that support user access to the processing system. Such user interfaces can further include various input and output devices which facilitate entry of information by the user or presentation of information to the user. Such input and output devices can include, but are not limited to, a mouse, touch-pad, touch-screen, or other pointing device, a keyboard, a camera, a monitor, a microphone, a speaker, a printer, a scanner, among other such devices. As further discussed above, the client devices can support various styles and types of client applications.

For example, in systems adapted to personalized medicine methods, a client device may comprise an input interface which allows a user to input patient descriptors. A central processor can receive such patient descriptors and compute benefit from treatment for a patient. The client device may optionally further comprise an output interface (e.g. a display) that allows a user to receive and optionally visualize the benefit from a treatment computed by the outcome processing system.

In systems adapted to transposability study methods, a client device may comprise an input interface which allows a user to input patient descriptors for a population of individuals, to select a population of individuals of interest, to specify a disease, to specify a treatment or type of treatment, and/or to input any additional limitation or other characteristics (e.g. financial resources allotted to a treatment). A central processor can receive such input and generate an output to be returned to the user, e.g. to the client device. The central processor may for example access a memory for storing data in order to return a benefit from treatment for a population of individuals or may compute benefit from treatment for a population of individuals. The client device may optionally further comprise an output device (e.g. a display) that allows a user to receive and optionally visualize benefit from treatment and/or treatments that are responsive to the inputted information (e.g. treatments for a selected disease, benefit for a population of individuals, etc.).

In systems adapted to target evaluation methods, a client device may comprise an input interface which allows a user to input information specifying one or more components or interrelationships between components of a physiopathological model, the alteration of which is to define a treatment (T). A central processor can receive such input and generate an output to be returned to the user, e.g. to the client device. The central processor can compute benefit from treatment (T) for a simulated population of individuals. The client device may optionally further comprise an output device (e.g. a display) that allows a user to receive and optionally visualize benefit from a treatment (T), for example, to visualize treatments that provide a meaningful benefit, or a ranking of a plurality of treatments (T).

In systems adapted to methods for monitoring development methods, a client device may comprise an input interface which allows a user to input treatment descriptors and/or data from use (e.g. clinical, experimental) for a treatment (T). A central processor can receive such input and generate an output to be returned to the user, e.g. to the client device. The central processor can compute benefit from treatment (T) for a simulated population of individuals. The client device may optionally further comprise an output device (e.g. a display) that allows a user to receive and optionally visualize benefit from a treatment (T).

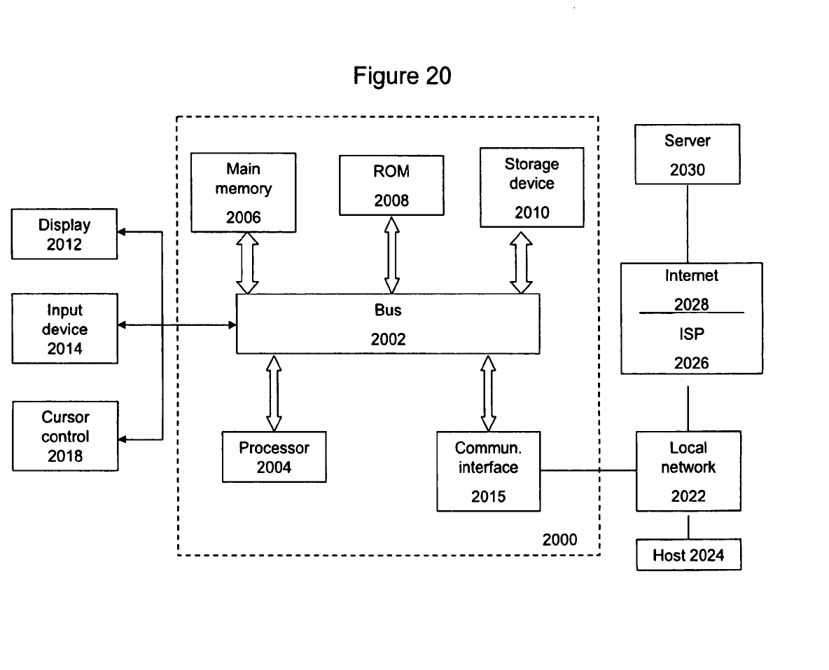

FIG. 20 is a block diagram that illustrates a single computer system 2000 upon which an embodiment of the invention may be implemented in a simple configuration. Computer system 2000 includes a bus 2002 or other communication mechanism for communicating information, and a processor 2004 coupled with bus 2002 for processing information. Computer system 2000 also includes a main memory 2006, such as a random access memory (RAM) or other dynamic storage device, coupled to bus 2002 for storing information and instructions to be executed by processor 2004. Main memory 2006 also may be used for storing temporary variables or other intermediate information during execution of instructions to be executed by processor 2004. Computer system 2000 further includes a read only memory (ROM) 2008 or other static storage device coupled to bus 2002 for storing static information and instructions for processor 2004. A storage device 2010, such as a magnetic disk or optical disk, is provided and coupled to bus 2002 for storing information and instructions.

Computer system 2000 may be coupled via bus 2002 to a display 2012, such as a cathode ray tube (CRT), flat plasma displays (plasma display panel; PDP), liquid crystal display (LCD), surface-conduction electron-emitter display (SED), field emission display (FED), digital light processing (DLP)-based display or organic light-emitting diode (OLED)-based display, for displaying information to a computer user. An input device 2014, including alphanumeric and other keys, is coupled to bus 2002 for communicating information and command selections to processor 2004. Another type of user input device is cursor control 2016, such as a mouse, a touch surface (e.g. multi-touch surface), a trackball, or cursor direction keys for communicating direction information and command selections to processor 2004 and for controlling cursor movement on display 2012. This input device typically has two degrees of freedom in two axes, a first axis (e.g., x) and a second axis (e.g., y), that allows the device to specify positions in a plane.

The invention is related to the use of computer system 2000 for implementing the techniques described herein. According to an embodiment of the invention, those techniques are performed by computer system 2000 in response to processor 2004 executing one or more sequences of one or more instructions contained in main memory 2006. Such instructions may be read into main memory 2006 from another machine-readable medium, such as storage device 2010. Execution of the sequences of instructions contained in main memory 2006 causes processor 2004 to perform the process steps described herein. In alternative embodiments, hard-wired circuitry may be used in place of or in combination with software instructions to implement the invention. Thus, embodiments of the invention are not limited to any specific combination of hardware circuitry and software.

In an embodiment implemented using computer system 2000, various computer-readable media are involved, for example, in providing instructions to processor 2004 for execution, for example, optical or magnetic disks, such as storage device 2010 or dynamic memory, such as main memory 2006. Transmission media includes coaxial cables, copper wire and fiber optics, including the wires that comprise bus 2002. Transmission media can also take the form of acoustic or light waves, such as those generated during radio-wave and infra-red data communications. All such media must be tangible to enable the instructions carried by the media to be detected by a physical mechanism that reads the instructions into a machine.

Various forms of computer-readable media may be involved in carrying one or more sequences of one or more instructions to processor 2004 for execution. For example, the instructions may initially be carried on a magnetic disk of a remote computer. The remote computer can load the instructions into its dynamic memory and send the instructions over a telephone line using a modem. A modem local to computer system 2000 can receive the data on the telephone line and use an infra-red transmitter to convert the data to an infra-red signal. An infra-red detector can receive the data carried in the infra-red signal and appropriate circuitry can place the data on bus 2002. Bus 2002 carries the data to main memory 2006, from which processor 2004 retrieves and executes the instructions. The instructions received by main memory 2006 may optionally be stored on storage device 2010 either before or after execution by processor 2004.

Optionally the computer system 2000 also includes a communication interface 2015 coupled to bus 2002. Communication interface 2015 provides a two-way data communication coupling to a network link 2020 that is connected to a local network 2022. For example, communication interface 2015 may be an integrated services digital network (ISDN) card or a modem to provide a data communication connection to a corresponding type of telephone line. As another example, communication interface 2015 may be a local area network (LAN) card to provide a data communication connection to a compatible LAN. Wireless links may also be implemented. In any such implementation, communication interface 2015 sends and receives electrical, electromagnetic or optical signals that carry digital data streams representing various types of information. Network link 2020 typically provides data communication through one or more networks to other data devices. For example, network link 2020 may provide a connection through local network 2022 to a host computer 2024 or to data equipment operated by an Internet Service Provider (ISP) 2026. ISP 2026 in turn provides data communication services through the world wide packet data communication network now commonly referred to as the “Internet” 2028. Local network 2022 and Internet 2028 both use electrical, electromagnetic or optical signals that carry digital data streams. The signals through the various networks and the signals on network link 2020 and through communication interface 2015, which carry the digital data to and from computer system 2000, are exemplary forms of carrier waves transporting the information. Computer system 2000 can send messages and receive data, including program code, through the network(s), network link 2020 and communication interface 2015. In the Internet example, a server 530 might transmit a requested code for an application program through Internet 2028, ISP 2026, local network 2022 and communication interface 2015. The received code may be executed by processor 2004 as it is received, and/or stored in storage device 2010, or other non-volatile storage for later execution. In this manner, computer system 2000 may obtain application code in the form of a carrier wave.

All publications and patent applications cited in this specification are herein incorporated by reference in their entireties as if each individual publication or patent application were specifically and individually indicated to be incorporated by reference.

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the appended claims.

1-53. (canceled)

54. A computer-implemented method comprising calculating by an outcome processing system a benefit of treatment (Rc−Rt) or the rate of outcome on treatment (Rt) for one or more individuals, wherein said calculating comprises computing the benefit of a treatment (T) that is associated with a function that describes, for a population, the benefit from treatment (Rc−Rt) as a function of the risk without treatment (Rc), preferably wherein said function is a function that describes the benefit from treatment (Rc−Rt) as a function of:
i) risk without treatment (Rc) depending on a first variable (Y), and
ii) a second variable (X), wherein the second variable (X) is a vector of characteristics of individuals other than the characteristics included in the risk without treatment (Rc) and the first variable (Y) is a vector of characteristics of individuals included in the risk without treatment (Rc), and where said variables (X) and (Y) may be environment-, phenotype- or genotype-derived variable(s);
receiving patient descriptors describing said one or more individuals, wherein each individual is associated with risk (Rc) and a second variable (X); and
outputting an indicator of the benefit from treatment (Rc−Rt) or the rate of outcome on treatment (Rt) for said individual(s).

55. The method of claim 54, comprising computing the benefit of a plurality of treatments (T), wherein each treatment (T) is associated with a function that describes, for a population, the benefit from treatment as a function of the risk without treatment.

56. The method of claim 54, wherein said individual(s) is one or a plurality of real human patient(s).

57. The method of claim 54, wherein said one or more individuals is a simulated individual or simulated population of individuals.

58. The method of claim 54, wherein said step of receiving patient descriptors comprises generating a simulated individual or simulated population of individuals.

59. The method of claim 54, wherein Rt is calculated using information or data that is input by a user, generated by the outcome processing system or received from a data source.

60. The method of claim 59, wherein said information or data comprises an output from a physiopathological model of treatment.

61. The method of claim 60, wherein a treatment (T) is associated with an alteration of a component or an interrelationship in the physiopathological model.

62. The method of claim 59, wherein said information comprises a function that describes, for a population, the benefit from a treatment as a function of the risk without treatment.

63. The method of claim 54, further comprising assessing variables for their effect on benefit from treatment.

64. A computer-implemented method comprising:
calculating by an outcome processing system a benefit of treatment (Rt) for a patient, wherein said calculating comprises computing the benefit for a patient of a plurality of treatments (T) that are each associated with a function that describes, for a population, the benefit from treatment (Rt) as a function of the risk without treatment (Rc), preferably wherein said function is a function that describes the benefit from treatment (Rt) as a function of risk without treatment (Rc) depending on a first variable (Y) and a second variable (X), wherein the second variable (X) is a vector of characteristics of individuals other than the characteristics included in the risk without treatment (Rc), and where said variables (X) and (Y) may be environment-, phenotype- or genotype-derived variable(s);
receiving patient descriptors for said variables (X) and (Y) for a patient; and
outputting an indicator of the benefit from treatment (Rt) for a treatment(s) T for said patient.

65. The method of claim 64, wherein said outputting an indicator of the benefit from treatment further comprises displaying whether said treatment is suitable for said patient.

66. The method of claim 64, wherein said outputting an indicator of the benefit from treatment (Rt) comprises outputting the benefit predicted for a simulated population of individuals from said treatment and outputting the benefit for said patient.

67. The method of claim 66, wherein said output indicates how the benefit for the said patient compares with the benefit for said population.

68. A computer-implemented method comprising:
calculating by an outcome processing system a benefit of treatment (Rt) for a simulated population of individuals, wherein said calculating comprises: computing the benefit of a treatment (T) associated with (i) an alteration of a component or an interrelationship between components of a physiopathological model, and (ii) a function that describes, for a population, the benefit from treatment (Rt) as a function of the risk without treatment (Rc), preferably wherein said function is a function that describes the benefit from treatment (Rt) as a function of risk without treatment (Rc) depending on a first variable (Y) and a second variable (X), wherein the second variable (X) is a vector of characteristics of individuals other than the characteristics included in the risk without treatment (Rc), and where said variables (X) and (Y) may be environment-, phenotype- or genotype-derived variable(s);
receiving patient descriptors for a simulated population of individuals, where each individual in the population is associated with a risk (Rc) and a second variable (X); and
outputting, an indicator of the benefit from treatment (Rt) in the simulated population.

69. The method of claim 64, wherein said function that describes, for a population, the benefit from treatment (Rt) as a function of the risk without treatment (Rc) is obtained by (a) running a physiopathological model comprising an alteration of a component or an interrelationship between components of the physiopathological model that defines a treatment (T), wherein the physiopathological model generates a likelihood of an event of interest; and (b) deriving said function from said likelihood of an event of interest.

70. A method for assessing biomarkers, the method comprising:
(a) carrying out a computer-implemented method comprising:
calculating by an outcome processing system a benefit of treatment (Rc−Rt) for an individual or population of individuals, wherein said calculating comprises computing the benefit of a treatment (T) that is associated with a function that describes, for a population, the benefit from treatment (Rc-Rt) as a function of the risk without treatment (Rc), preferably wherein said function is a function that describes the benefit from treatment (Rc−Rt) as a function of
i) risk without treatment (Rc) depending on a first variable (Y), and
ii) a second variable (X), wherein the second variable (X) is a vector of characteristics of individuals other than the characteristics included in the risk without treatment (Rc) and the first variable (Y) is a vector of characteristics of individuals included in the risk without treatment (Rc), and where said variables (X) and (Y) may be environment-, phenotype- or genotype-derived variable(s);
receiving patient descriptors describing said one or more individuals, wherein each individual is associated with risk (Rc) and a second variable (X); and
optionally, outputting an indicator of the benefit from treatment (Rc−Rt) for said individual(s); and
(b) assessing variables for their effect on benefit from treatment (Rc−Rt) for said one or more individuals.

71. The method of claim 70, wherein the step of receiving patient descriptors describing said one or more individuals comprises receiving at least one of said patient descriptor from a physiopathological model.

72. An apparatus for predicting the benefit from one or a plurality of treatments, said apparatus comprising one or more computers for executing computer-executable instructions, wherein the computer comprises computer-executable instructions for carrying out a method of claim 54.

73. A computer-readable medium that stores a computer program for predicting the benefit from one or a plurality of treatments, wherein the computer program comprises instructions for carrying out a method of claim 54.
